(19) United States
(12) Patent Application Publication
(10) Pub. No.: US 2017/0211604 A1
(43) Pub. Date: Jul. 27, 2017

(54) Shelving Apparatus

(71) Applicant: Frank Tsai, Shenzhen (CN)

(72) Inventor: Frank Tsai, Shenzhen (CN)

(21) Appl. No.: 15/338,293

(22) Filed: Oct. 28, 2016

Related U.S. Application Data
(63) Continuation-in-part of application No. 15/004,986, filed on Jan. 24, 2016.
Application No. 15/004,986 is a continuation-in-part of application No. 15/004,987, filed on Jan. 24, 2016.
Application No. 15/004,987 is a continuation-in-part of application No. 15/047,648, filed on Feb. 19, 2016, now Pat. No. 9,474,369.
Application No. 15/047,648 is a continuation-in-part of application No. 15/004,989, filed on Jan. 24, 2016.

(51) Int. Cl. F16B 12/34; A47B 47/02; A47B 47/00; A47B 96/14; A47B 57/34; A47B 96/02

(52) U.S. Cl. CPC F16B 12/34; A47B 57/34; A47B 96/021; A47B 47/0083; A47B 96/145; A47B 96/1441; A47B 47/021

(57) ABSTRACT

A shelving apparatus includes a supporting frame and a plurality of posts for coupling with the supporting frame. Each post includes an upper post member, a lower post member and a post joint, wherein each of the upper and lower post members has a first post wall and a second post wall extended from the first wall at an angle. The post joint includes an engaging tongue extended into interiors of an end portion of the upper post member and an end portion of the lower post member, such that the upper and lower post members are interlocked and coupled with each other end-to-end.

### CROSS REFERENCE OF RELATED APPLICATION

This is a Continuation-In-Part application that claims the benefit of priority under 35 U.S.C.§119 to a first non-provisional application, application Ser. No. 15/004,986, filed Jan. 24, 2016, a second non-provisional application, application Ser. No. 15/004,987, filed Jan. 24, 2016, a third non-provisional application, application Ser. No. 15/004,989, filed Jan. 24, 2016, and a fourth non-provisional application, application Ser. No. 15/047,648, filed Feb. 19, 2016.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

Field of Invention

The present invention relates to a shelf structure, and more particularly to a shelving apparatus, wherein a plurality of post members of a foldable post can be easily assembled to rigidly support a plurality of supporting frames, and can be easily disassembled without detaching the post members.

Description of Related Arts

A conventional shelf structure comprises four vertical posts vertically extended from four corners of the shelf structure and a plurality of supporting panels horizontally and spacedly coupled at the vertical posts to form a shelving unit for supporting objects. As shown in FIG. 1, each vertical post comprises a plurality of tubular post members A1 arranged to align end-to-end. Each of the supporting panels comprises a panel body A2 and four tubular connectors A3 provided at four corners of the panel body A2, wherein the end of the post member A1 is inserted into the tubular connector A3 in order to connect the supporting panel at the vertical post. Accordingly, the configuration of the panel body A2 is fixed such that the size of the panel body A2 cannot be adjusted. In particular, each of the tubular connectors A3 has an upper tapered slot at an upper portion of the tubular connector A3 and a lower tapered slot at a lower portion of the tubular connector A3. Therefore, the end portions of two post members A1 are respectively inserted into the upper and lower tapered slots to securely connect the panel body A2 with the vertical posts while the vertical post are aligned end-to-end. Such tubular detachable connecting structure provides a quick assembling operation to allow the user to set up the shelving unit easily. However, after the objects are loaded and supported by the shelving unit, the overall weight of the objects will exerted to the vertical posts via the supporting panel. In other words, the end portions of two post members A1 are secured at the upper and lower tapered slots of the tubular connector A3, such that the user may require relatively larger pulling force to detach the post members A1 from the tubular connectors A3. In addition, when one of the tubular connectors A3 is broken or damaged, the supporting panels cannot be securely coupled to the vertical posts any more. In fact, in order to enhance the rigidity of the shelving unit, the structure of tubular connectors A3 must be enhanced by using rigid material such a metal or by thickening the walls of the upper and lower tapered slots of the tubular connector A3. Therefore, the material cost of the shelving unit will be substantially high and the size of the shelving unit will be enlarged. Therefore, most users will not use this conventional shelf structure in shopping centers or in the booths because the shelf structure is required to assemble and disassemble and is required to move from places to places.

An improved shelf structure is provided to enhance the storage space by reducing the size of the post connection, as shown in FIG. 2, wherein the shelf structure comprises four vertical posts each comprising a plurality of L-shaped post members B1 and a plurality of couplers B2 for coupling the post members B1 end-to-end. Each of the couplers B2 has a corresponding L-shaped coupler flange B21 and two reverse bend flanges B22 extended along two edges of the coupler flange B21, wherein a gap is formed between the reverse bend flange B22 and the coupler flange B21, such that the end portions of two post members B1 are inserted into the gap of the coupler B2 to couple the post members B1 end-to-end. In other words, two post members B1 in an abutting are secured by the coupler B2 by downwardly inserting the end portion of the upper post member B1 into the gap of the coupler B2 and by upwardly inserting the end portion of the lower post member B1 into the gap of the coupler B2. In addition, each of the couplers B2 has a detent B23 on each of the reverse bend flanges B22 to frictionally engage with the post member B1 so as to retain the coupler B2 in position. Since the cross section of the coupler B2 matches with the cross section of the post member B1, the connection between the ends of the post members B1 can be substantially reduced its size. The L-shaped detachable connecting structure provides a quick assembling operation to allow the user to set up the shelving unit easily. However, due to the frictional engagement between the end portion of the post member B1 and the coupler B2, the user may not able to correctly insert the end portion of the post member B1 into the gap of the coupler B2. It is unstable for the shelf structure when the end portion of the post member B1 cannot be fully inserted into the gap of the coupler B2. The excessive inserting force of the end portion of the post member B1 will damage the structure of the coupler B2 and will enlarge the size of the gap thereof. After the shelving unit is set up, the reverse bend flanges B22 are located at the outer surface of post member B1, such that the user may get cut or scratched by the reverse bend flanges B22 when placing the objects. Furthermore, such shaped detachable connecting structure cannot solve the same problem of how to easily disassemble the shelving unit. In other words, after the objects are loaded and supported by the shelving unit, the overall weight of the objects will exerted to the vertical posts via the couplers B2. In other words, the end portions of two post members B1 are secured at the gaps of the couplers B2, such that the user may require relatively larger pulling force to detach the post members B1 from the couplers B2. Once the gap is enlarged by the excessive detaching force, the end portions of the post members B1 cannot be securely engaged with the coupler B2 by means of frictional force. The overall structure of the shelving unit become wobble and unstable. In addition, when one of the couplers B2 is lost or damaged, the post members B1 cannot be coupled end-to-end any more.

### SUMMARY OF THE PRESENT INVENTION

The invention is advantageous in that it provides a shelving apparatus, wherein a plurality of post members of a post can be easily assembled to rigidly support a plurality of supporting frames, and can be easily disassembled without detaching the post members.

Another advantage of the invention is to provide a shelving apparatus, wherein the post members of the post are detachably coupled with each other end-to-end to enhance the assembling/disassembling operation of the post.

Another advantage of the invention is to a shelving apparatus, wherein a height of the shelving apparatus can be selectively adjusted by detachably coupling the posts end-to-end via the post locker.

Another advantage of the invention is to a shelving apparatus, wherein the post locker has a built-in reinforcing structure to prevent any twisting movement of the post locker and the post so as to provide a rigid structure to connect two post members with each other end-to-end and to distribute the weight of the object to the post members.

Another advantage of the invention is to a shelving apparatus, which provides different supporting orientations to selectively form the multiple shelving apparatus.

Another advantage of the invention is to a shelving apparatus, wherein a longitudinal size of the shelving apparatus can be selectively expanded by coupling two shelf supporting beam configurations to two sides of one single post respectively.

Another advantage of the invention is to provide a shelving apparatus, wherein the post members of the foldable post are pivotally coupled with each other end-to-end to enhance the assembling/disassembling operation of the foldable post.

Another advantage of the invention is to provide a shelving apparatus, wherein the post members are coupled with each other via tongue-and-groove engagement to ensure the rigidity of the foldable post.

Another advantage of the invention is to provide a shelving apparatus, wherein the post locker is provided for locking up a pivot connection between the post members to ensure the post members being locked in an end-to-end manner.

Another advantage of the invention is to provide a shelving apparatus, wherein the shelf platform is reversibly supported by the foldable posts to selectively adjust a depth of the supporting frame. In other words, the user is able to selectively adjust the depth of supporting frame without disassembling the foldable posts.

Another advantage of the invention is to provide a shelving apparatus, wherein the shelf retaining members are reversibly supported by the foldable posts to selectively adjust a depth of the supporting frame. In other words, the user is able to selectively adjust the depth of supporting frame without disassembling the foldable posts.

Another advantage of the invention is to provide a shelving apparatus, which does not require altering the original structural design of the shelf structure, so as to minimize the manufacturing cost of the shelving apparatus.

Another advantage of the invention is to provide a shelving apparatus, wherein no expensive or complicated structure is required to employ in the present invention in order to achieve the above mentioned objects. Therefore, the present invention successfully provides an economic and efficient solution for providing a rigid configuration for the shelving apparatus.

Additional advantages and features of the invention will become apparent from the description which follows, and may be realized by means of the instrumentalities and combinations particular point out in the appended claims.

According to the present invention, the foregoing and other objects and advantages are attained by a shelving apparatus, which comprises a supporting frame, a plurality of foldable posts for detachably coupling with the supporting frame, and a post joint.

Each of the foldable posts comprises an upper post member and a lower post member, wherein each of the upper and lower post members has a first post wall and a second post wall extended from the first wall at an angle.

The post joint is arranged for connecting the upper and lower post members end-to-end, wherein said post joint comprises an engaging tongue extended from an end portion of the first post wall of the upper post member, an engaging groove provided at an end portion of the first post wall of the lower post member, and a pivot hinge pivotally coupled the second post walls of the upper and lower post members, such that when the upper and lower post members are pivotally moved to engage the engaging tongue with the engaging groove, the upper and lower post members are coupled with each other end-to-end.

In accordance with another aspect of the invention, the present invention comprises a post structure of a shelving apparatus, which comprises a plurality of posts for detachably coupling a supporting frame to form the shelving apparatus.

Each of the posts comprises at least an upper post member, at least a lower post member, and at least a post joint connecting the upper and lower post members to form the respective post such that the upper and lower post members are extended rigidly in an end-to-end and vertically oriented manner. Each of the upper and lower post members has a first post wall and a second post wall extended from the first wall at an angle. The post joint provides an engaging tongue extended into interiors of an end portion of the upper post member and an end portion of the lower post member, such that the upper and lower post members are interlocked and coupled with each other end-to-end. Accordingly, the post can have a L-shaped configuration or a T-shaped configuration.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 illustrates a first conventional shelf structure.

FIG. 2 illustrates a second conventional shelf structure.

FIG. 3 is a perspective view of a shelving apparatus according to a preferred embodiment of the present invention.

FIG. 4 is an exploded perspective view of the shelving apparatus according to the above preferred embodiment of the present invention.

FIG. 5 is an exploded perspective view of a post joint of the shelving apparatus according to the above preferred embodiment of the present invention.

FIG. 6A is a perspective view of the post joint of shelving apparatus according to the above preferred embodiment of the present invention, illustrating the post members being interlocked end-to-end.

FIG. 6B is a perspective view of the post joint of shelving apparatus according to the above preferred embodiment of the present invention, illustrating the folded post members.

FIG. 7 is a perspective view of a supporting frame of the shelving apparatus according to the above preferred embodiment of the present invention.

FIG. 8A illustrates the shelf platform supported at the first position according to the above preferred embodiment of the present invention.

FIG. 8B illustrates the shelf platform supported at second first position according to the above preferred embodiment of the present invention.

FIG. 9 illustrates a first alternative mode of the supporting frame of the shelving apparatus according to the above preferred embodiment of the present invention, showing the shelf retaining member at the first position.

FIG. 9A illustrates the first alternative mode of the supporting frame of the shelving apparatus according to the above preferred embodiment of the present invention, showing the shelf retaining member at the second position.

FIG. 10 illustrates a second alternative mode of the supporting frame of the shelving apparatus according to the above preferred embodiment of the present invention.

FIGS. 11A and 11B illustrate an alternative mode of the shelf platform of the shelving apparatus according to the above preferred embodiment of the present invention.

FIGS. 12A and 12B illustrate an alternative mode of the post joint of the shelving apparatus according to the above preferred embodiment of the present invention.

FIG. 13 a perspective view of a shelving apparatus according to a second preferred embodiment of the present invention.

FIG. 14 is a perspective view of the foldable post of the shelving apparatus according to the above second embodiment of the present invention.

FIG. 14A is a sectional view illustrating the engagement between the fastener and keyhole of the foldable post of the shelving apparatus according to the above second embodiment of the present invention.

FIG. 15 is a perspective view of the shelf retaining member of the shelving apparatus according to the above second embodiment of the present invention.

FIG. 16 is a partially perspective view of the shelving apparatus according to the above preferred embodiment of the present invention to illustrate the structural configuration of the shelving apparatus.

FIG. 17 is a perspective view of a shelving apparatus according to a third embodiment of the present invention.

FIG. 17A is a perspective view of the shelf platform of the shelving apparatus according to the third preferred embodiment of the present invention.

FIG. 18 is a partially perspective view of the shelving apparatus according to the third preferred embodiment of the present invention, illustrating the structural configuration of the shelving apparatus.

FIG. 19 is an exploded perspective view of the post of the shelving apparatus according to the third preferred embodiment of the present invention.

FIG. 19A illustrates the engagement between the keyhole guider and the guiding slot when the post joint is inserted into the lower post member according to the third preferred embodiment of the present invention.

FIG. 20 is a sectional view of the post of the shelving apparatus according to the third preferred embodiment of the present invention.

FIG. 20A illustrates a first alternative mode of the upper and lower post members according to the third preferred embodiment of the present invention.

FIG. 20B illustrates a second alternative mode of the upper and lower post members according to the third preferred embodiment of the present invention.

FIG. 20C illustrates a third alternative mode of the upper and lower post members according to the third preferred embodiment of the present invention.

FIG. 21 is a perspective view of the shelving apparatus according to the third preferred embodiment of the present invention, illustrating the cavity facing downward.

FIG. 21A illustrates a hanging element hung at the boundary loops of the upper shelf platform within the lower shelving space of the shelving apparatus according to the third preferred embodiment of the present invention.

FIG. 22 is a perspective view of the shelving apparatus according to the third preferred embodiment of the present invention, illustrating the cavity facing upward.

FIG. 23 is a perspective view of the shelving apparatus according to a fourth preferred embodiment of the present invention.

FIG. 24 is an exploded perspective view of the post of the shelving apparatus of the alternative mode according to the fourth preferred embodiment of the present invention.

FIG. 24A illustrates an alternative mode of the post joint of the shelving apparatus according to the fourth preferred embodiment of the present invention.

FIG. 25 is a sectional view of the upper and lower post members of the post of the shelving apparatus according to the fourth preferred embodiment of the present invention.

FIG. 26 is a sectional view of the upper and lower post members of the post of the shelving apparatus according to the fourth preferred embodiment of the present invention.

FIG. 26A illustrates a first alternative mode of the upper and lower post members according to the fourth preferred embodiment of the present invention.

FIG. 26B illustrates a second alternative mode of the upper and lower post members according to the fourth preferred embodiment of the present invention.

FIG. 26C illustrates a third alternative mode of the upper and lower post members according to the fourth preferred embodiment of the present invention.

FIG. 26D illustrates a fourth alternative mode of the upper and lower post members according to the fourth preferred embodiment of the present invention.

FIG. 27 is a partially perspective view of the shelving apparatus according to the fourth preferred embodiment of the present invention, illustrating the structural configuration of the shelving apparatus.

FIG. 28 is a perspective view of the shelving apparatus according to a fifth preferred embodiment of the present invention.

FIG. 29 is a sectional view of the post of the shelving apparatus according to the fifth preferred embodiment of the present invention.

FIG. 30 illustrates the connection between the post joint and the post member of the shelving apparatus according to the fourth preferred embodiment of the present invention.

FIG. 31 illustrates a multiple shelving apparatus according to the fourth preferred embodiment of the present invention.

FIG. 32A illustrates a single shelving apparatus formed by L-shaped posts according to the third preferred embodiment of the present invention.

FIG. 32B illustrates a single shelving apparatus formed by T-shaped posts according to the fourth preferred embodiment of the present invention.

FIG. 32C illustrates a multiple shelving apparatus formed by L-shaped posts and

T-shaped post according to the third and fourth embodiments of the present invention.

FIG. 33 illustrates the metal sheet being fed to the folding machine to form the post according to the third and fourth embodiments of the present invention.

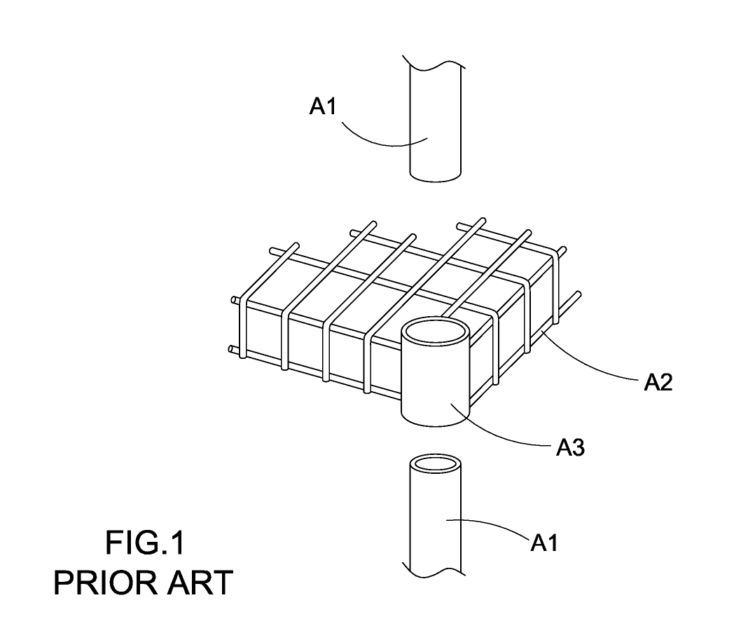

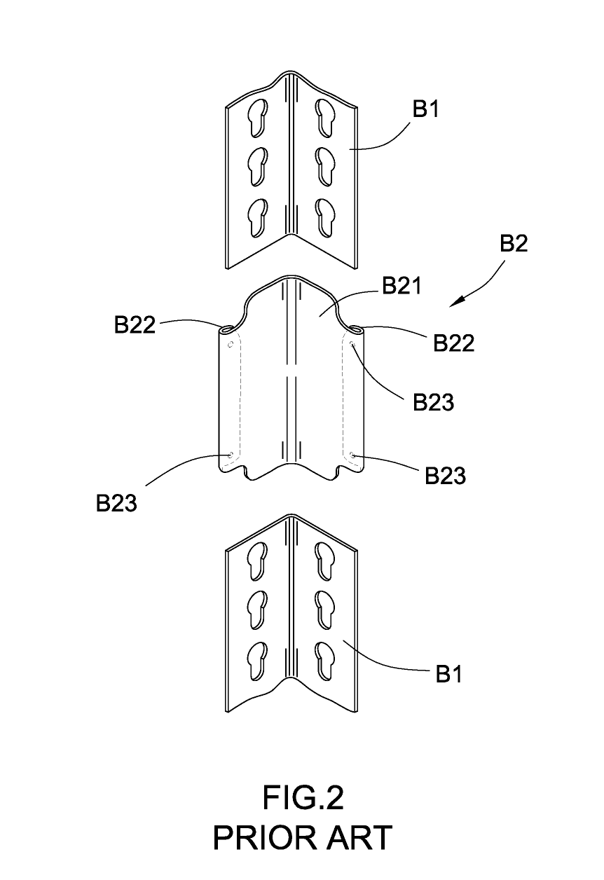

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

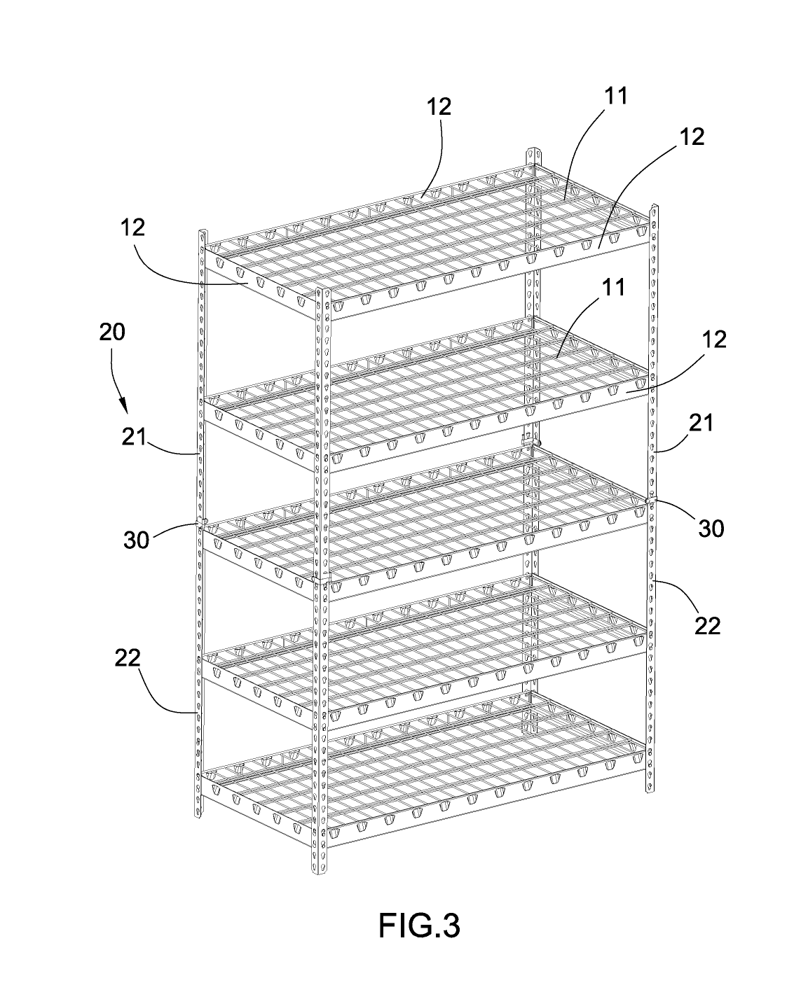

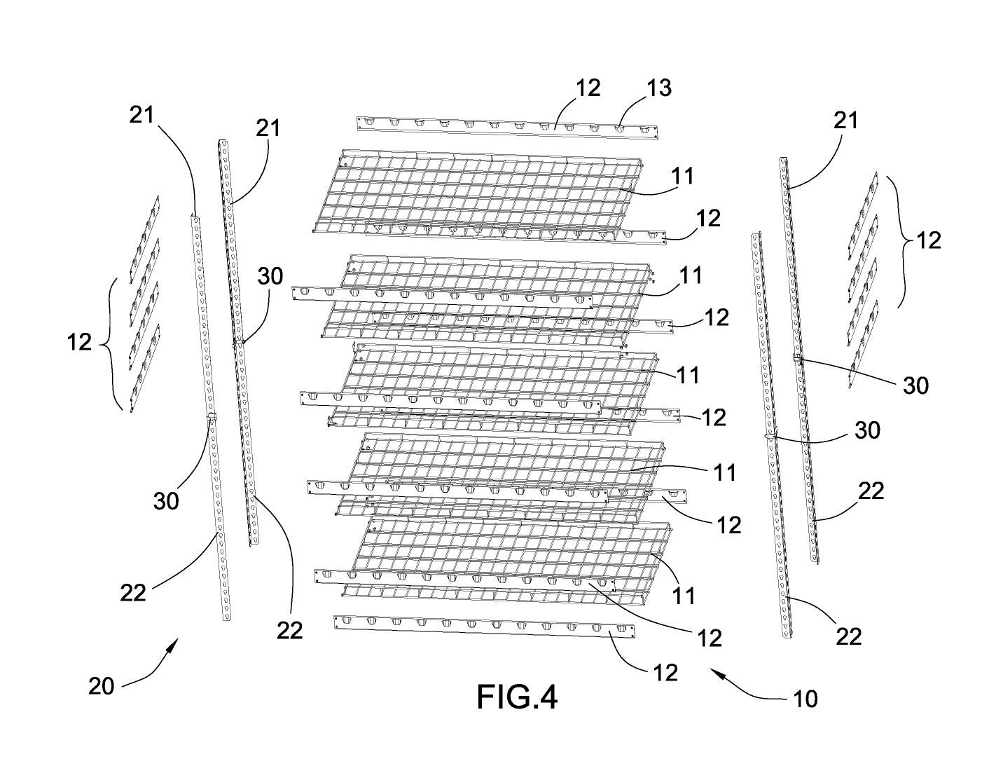

Referring to FIGS. 3 to 7, a shelving apparatus according to a preferred embodiment of the present invention is illustrated, wherein the shelving apparatus comprises a supporting frame 10 and a plurality of foldable posts 20 for detachably coupling with the supporting frames 10.

According to the preferred embodiment, the supporting frame 10 is incorporated with one or more shelf supporting beam configurations and is supported by the foldable posts 20 in a horizontally oriented manner for supporting one or more objects on the supporting frame 10.

Each of the foldable posts 20 is supported in a vertically oriented manner to serve as a corner post of the shelving apparatus. In one embodiment, at least four foldable posts 20 are provided that four corners of the supporting frame 10 are coupled at the foldable posts 20 respectively. Each of the foldable posts 20 comprises at least an upper post member 21, at least a lower post member 22 and at least a post joint 30, wherein each of the upper and lower post members 21, 22 has a first post wall 211, 221 and a second post wall 212, 222 extended from the first wall 211, 221 at an angle. Preferably, the first post walls 211, 221 of the upper and lower post members 21, 22 are perpendicularly extended from the second post walls 212, 222 thereof. In addition, the upper post member 21 is identical to the lower post member 22. It is appreciated that the length of the upper post member 21 can be different from that of the lower post member 22. A width of the first post wall 211, 221 equals to a width of the second post wall 212, 222, such that each of the upper and lower post members 21, 22 has a L-shaped cross section. Each of the foldable posts 20 further has a plurality of keyholes 23 alignedly formed on the first post wall 211, 221 and the second post wall 212, 222 of each of the upper and lower post members 21, 22. Each of the keyholes 23 has an upper hole portion 231 and a lower hole portion 232, wherein a size of the upper hole portion 231 is larger than a size of the lower hole portion 232.

The post joint 30 is arranged for connecting the upper and lower post members 21, 22 in an end-to-end manner to form the foldable post 20, such that the upper and lower post members 21, 22 are capable of being unfolded and extended rigidly in a vertically oriented manner when the foldable post 20 is in an unfolded condition. Accordingly, the post joint 30 comprises a first means provided at the upper post member 21 and a second means provided at the lower post member 22 to interlock the upper and lower post members 21, 22 with each other. In particular, the post joint 30 comprises an engaging tongue 31 extended from an end portion of the first post wall 211 of the upper post member 21, an engaging groove 32 provided at an end portion of the first post wall 221 of the lower post member 22, and a pivot hinge 33 pivotally coupled the second post walls 212, 222 of the upper and lower post members 21, 22, such that when the upper and lower post members 21, 22 are pivotally moved to engage the engaging tongue 31 with the engaging groove 32, the upper and lower post members 21, 22 are interlocked and coupled with each other end-to-end. In other words, the first and second means are the engaging tongue 31 and the engaging groove 32 to form the interlocking unit to interlock the upper and lower post members 21, 22 with each other.

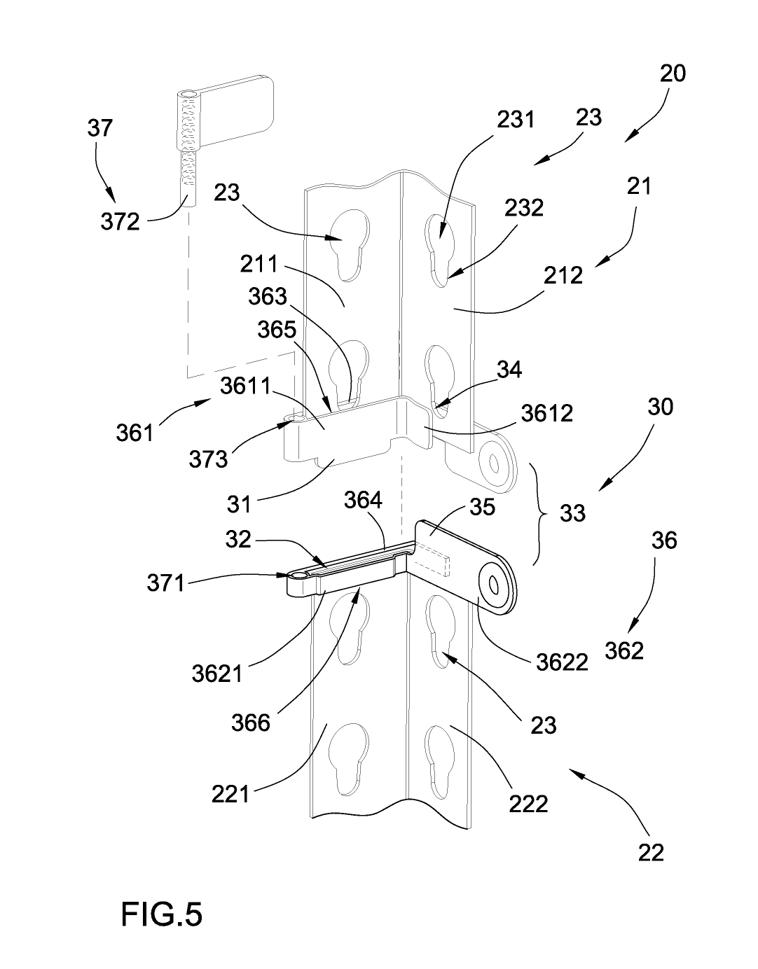

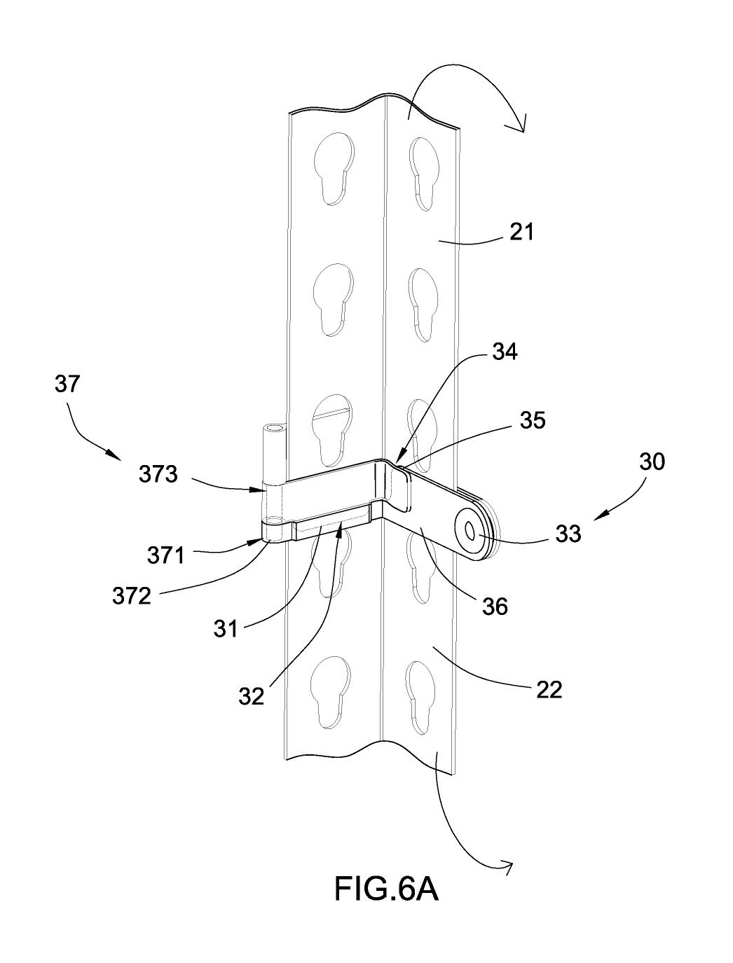

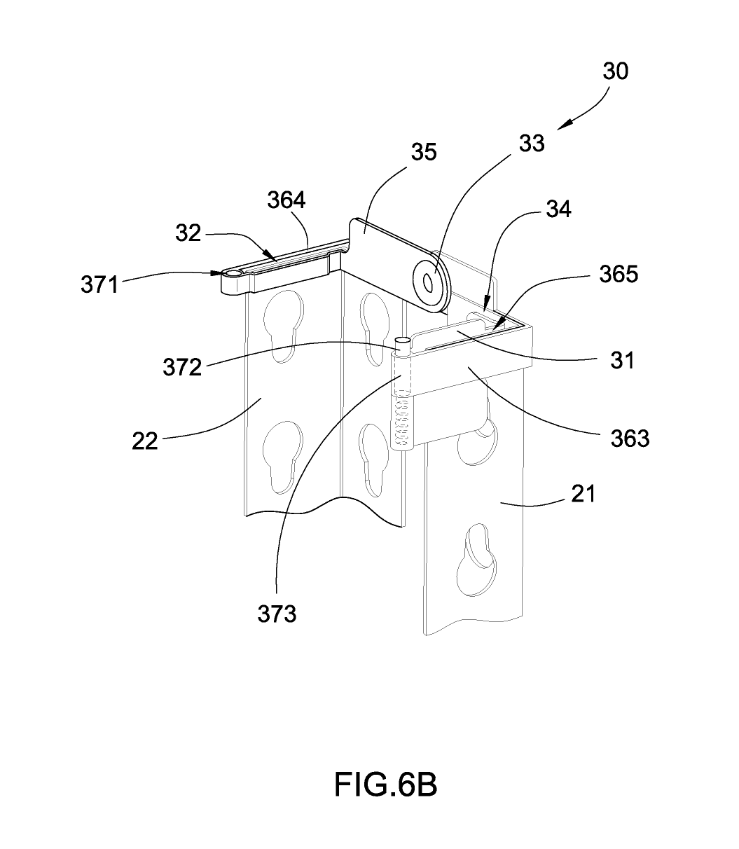

As shown in FIGS. 5, 6A and 6B, the post joint 30 further comprises an additional engaging groove 34 extended from an end portion of the second post wall 212 of the upper post member 21 adjacent to the engaging tongue 31 thereof, and an additional engaging tongue 35 provided at an end portion of the second post wall 222 of the lower post member 22 adjacent to the engaging groove 32 thereof.

In other words, the engaging tongue 31 and the additional engaging groove 35 are provided at the first post wall 211 and the second post wall 212 of the upper post member 21 respectively while the engaging groove 32 and the additional engaging tongue 34 are provided at the first post wall 221 and the second post wall 222 of the lower post member 22 respectively. Therefore, when the upper and lower post members 21, 22 are pivotally moved toward each other, the engaging tongue 31 at the first post wall 211 of the upper post member 21 will engage with the engaging groove 32 at the first post wall 221 of the lower post member 22 while the additional engaging tongue 34 at the second post wall 222 of the lower post member 22 will engage with the additional engaging groove 35 at the second post wall 212 of the upper post member 22, so as to interlock the upper and lower post members 21, 22 with each other end-to-end coaxially.

Preferably, the engaging tongue 31 is extended from an inner side of the first post wall 211 of the upper post member 21 and the engaging groove 32 is formed at an inner side of the first post wall 221 of the lower post member 22. Likewise, the additional engaging tongue 34 is extended from an inner side of the second post wall 222 of the lower post member 22 and the additional engaging groove 35 is formed at an inner side of the second post wall 212 of the upper post member 21.

As shown in FIGS. 5, 6A and 6B, the post joint 30 further comprises two coupling sleeves 36 coupling with the end portions of the upper and lower post members 21, 22 respectively, wherein the pivot hinge 33 is formed between the coupling sleeves 36 to pivotally couple the upper and lower post members 21, 22. Each of the coupling sleeves 36 comprises a first inner sleeve member 361 coupled at the inner side of the upper post member 21 and a second inner sleeve member 362 coupled at the inner side of the lower post member 22. In particular, the first inner sleeve member 361 has two first inner sleeve portions 3611, 3612 coupled at the inner sides of the first and second post walls 211, 212 of the upper post member 21 respectively, wherein one of the first inner sleeve portions 3611 is extended from the end portion of the first post wall 211 of the upper post member 21 to form the engaging tongue 31 while another first inner sleeve portion 3612 is spaced apart from the inner side of the end portion of the second post wall 212 of the upper post member 21 to form the additional engaging groove 35. The second inner sleeve member 362 has two second inner sleeve portions 3621, 3622 coupled at the inner sides of the first and second post walls 221, 222 of the lower post member 22 respectively, wherein one of the second inner sleeve portions 3621 is spaced apart from the inner side of the end portion of the first post wall 221 of the lower post member 21 to form the engaging groove 32 while another second inner sleeve portion 3622 is extended from the end portion of the second post wall 222 of the lower post member 21 to form the additional engaging tongue 34. The pivot hinge 33 is pivotally coupled between two corresponding side edges of the first and second inner sleeve members 361, 362 in order to pivotally couple the upper and lower post members 21, 22 with each other.

According to the preferred embodiment, each of the coupling sleeves 36 further comprises a first outer sleeve member 363 coupled with the first inner sleeve member 361 to define a first sleeve cavity 365 to receive the end portion of the upper post member 21, and a second inner sleeve member 364 coupled with the second inner sleeve member 362 to define a second sleeve cavity 366 to receive the end portion of the lower post member 22. Preferably, the coupling sleeves 36 are securely affixed to the end portions of the upper and lower post members 21, 22 by welding to ensure the secure engagement of the post joint 30 to the upper and lower post members 21, 22, as shown in FIG. 5.

It is appreciated that at least one of the engaging tongue 31 and the additional engaging groove 35 can be formed at the first outer sleeve member 363 and one of the engaging groove 32 and the additional engaging tongue 34 can be formed at the second outer sleeve member 364. In other words, the post joint 30 provides a tongue-and-groove engagement, especially the interlock tongue-and-groove engagement, to ensure the upper and lower post members 21, 22 with each other end-to-end.

As shown in FIGS. 5, 6A and 6B, the post joint 30 further comprises a post locker 37 for releasebly locking the end-to-end interlocking of the upper and lower post members 21, 22. In particular, the post locker 37 is arranged to lock up the pivotal movement between the upper and lower post members 21, 22. Accordingly, the post locker 37 comprises a locking slot 371 provided at the lower post member 22 and a locking latch 372 provided at the upper post member 21, such that when the upper and lower post members 21, 22 are pivotally moved to engage the engaging tongue 31 with the engaging groove 32, i.e. the additional engaging tongue 34 engaged with the additional engaging groove 35 at the same time, the locking latch 372 is actuated to engage with the locking slot 371 to retain the upper and lower post members 21, 22 to be coupled with each other end-to-end. In addition, the post joint 30 further comprises a guiding slot 373 provided at the upper post member 21 to align with the locking slot 371, wherein the locking latch 372 is guided by the guiding slot 373 to slidably actuate to selectively lock up with the locking slot 371. Preferably, the locking latch 372 is a spring-loaded device to push the locking latch 372 to the locking slot 317. In other word, when the locking latch 372 is slidably pulled along the guiding slot 373 until a free end of the locking latch 372 is disengaged with the locking slot 371, the upper and lower post members 21, 22 are capable of being pivotally moved via the pivot hinge 33. Once the upper and lower post members 21, 22 are pivotally moved to engage the engaging tongue 31 with the engaging groove 32, the locking latch 372 is slidably pushed until the free end of the locking latch 372 is engaged with the locking slot 371 to lock up the pivotal movement between the upper and lower post members 21, 22. Accordingly, the guiding slot 373 and the locking slot 371 are formed at the coupling sleeves 36 respectively. In addition, the pivot hinge 33 is formed one side edge of the coupling sleeve 36 and the post locker 37 is formed at an opposed side edge of the coupling sleeve 36.

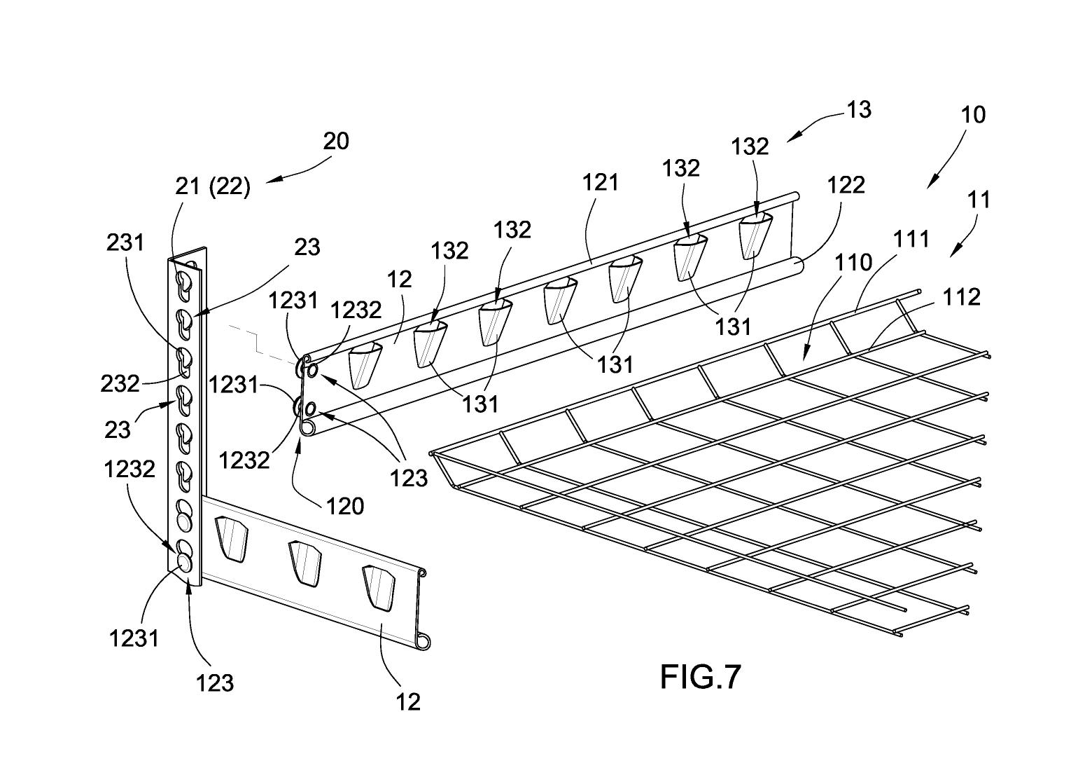

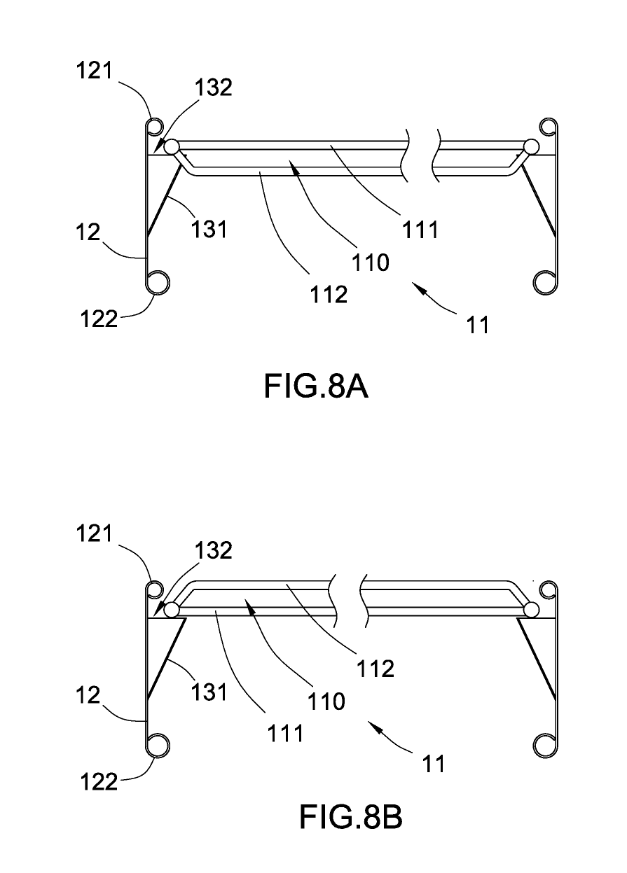

According to the preferred embodiment, each of the shelf supporting beam configurations of the supporting frame 10 comprises a shelf platform 11, a plurality of shelf retaining members 12, and a shelf supporting arrangement 13, further referring to FIGS. 7, 8A and 8B.

Each of the shelf retaining members 12 is detachably coupled with two of the foldable posts 20, such that the shelf retaining members 12 form a boundary frame to support the shelf platform 11 therewithin. In particular, each of the shelf retaining members 12 has two coupling ends 120 arranged for detachably coupling with two of the foldable posts 20, and first and second longitudinal edges 121, 122 extended between the two coupling ends 120 to form the boundary frame. Accordingly, two of the shelf retaining members 12 serve as a front boundary and a rear boundary respectively, and the other two shelf retaining members 12 serve as two side boundaries respectively, such that the boundary frame is formed by the front boundary, the rear boundary, and the side boundary. Preferably, a length of the front boundary matches with a length of the rear boundary and the side boundaries are preferred identical in length.

As shown in FIG. 7, each of the shelf retaining members 12 has a planar structure to have the first and second longitudinal edges 121, 122 extended parallel with each other, wherein two ends of each of the shelf retaining members 12 are detachably engaged with keyholes 23 of the two foldable posts 20. Accordingly, two fasteners 123 are provided at each coupling end 120 of the shelf retaining member 12 to engage with two keyholes 23 of the corresponding foldable post 20. In particular, two fastener holes are formed at each coupling end of the shelf retaining member 12, wherein the two fasteners 123 are affixed to the shelf retaining member 12 via the fastener holes respectively. According to the preferred embodiment, each of the fasteners 123 is riveted to the respective coupling end 120 of the shelf retaining member 12 and has a head 1231 having a size larger than the lower hole portion 232 and slightly smaller than the upper hole portion 231 so as to be fittingly inserted through the upper hole portion 231 of the corresponding keyhole 23 with a neck 1232, protruded between the head 1231 and the shelf retaining member 12, having a size smaller than the head 1231 while fittingly sliding into the lower hole portion 232 of the corresponding keyhole 23 from the upper hole portion 231, so as to securely couple the shelf retaining member 12 at the foldable post 20.

The first and second longitudinal edges 121, 122 of the shelf retaining member 12 are two folded edges respectively, wherein two longitudinal edge portions of the shelf retaining members 12 are inwardly folded on an inner side thereof to form the longitudinal edges 121, 122 respectively to reinforce the planar configuration of the shelf retaining member 12.

According to the preferred embodiment, the shelf supporting arrangement 13 is integrally extended from each of the shelf retaining members 12 between the first and second longitudinal edges 121, 122 to rigidly support the shelf platform 10 within the boundary frame.

The shelf supporting arrangement 13 comprises a plurality of supporting tabs 131 horizontally aligned with each other and integrally protruded from the inner side of the shelf retaining member 12 between the first and second longitudinal edges 121, 122 thereof, and defines a plurality of discrete supporting surfaces 132 on the supporting tabs 131 to support the shelf platform 11 thereon. As shown in FIGS. 7, 8A, and 8B, each of the supporting tabs 131 is integrally bent from the inner side of the shelf retaining member 12 to define the supporting surface 132 close to the first longitudinal edge 121 of the shelf retaining member 12. Preferably, each of the supporting tabs 131 has a triangular shape defining a peak pointing toward the second longitudinal edge 122 of the shelf retaining member 12 and a flat surface as the supporting surface 132 facing toward the first longitudinal edge 121 of the shelf retaining member 12. It is worth mentioning that the discrete supporting surfaces 132 are aligned with each other at the same planar direction to form a flat support for supporting the shelf platform 11.

According to the preferred embodiment, the shelf platform 11 is a wire shelf made by a plurality of longitudinal and transverse wires intersecting with each other. It should be appreciated that the shelf platform 11 can be made of other configurations such as solid panel, laminated panel, or other materials such as wood or plastic.

The shelf platform 11 is reversibly supported by the boundary frame at a first position and a reversibly second position to selectively adjust a depth of the shelf platform 11. In particular, the shelf platform 11 has a surrounding edge 111 and a base panel 112 located at different horizontal levels of the surrounding edge 111. Accordingly, a circumferential size of the surrounding edge 111 is larger than a circumferential size of the base panel 112. At the first position, as shown in FIG. 8A, the surrounding edge 111 of the shelf platform 11 is supported by the boundary frame via the discrete supporting surfaces 132 at a position that the surrounding edge 111 is located below the base panel 112, such that the base panel 112 is aligned with the first longitudinal edge 121 of the shelf retaining member 12 to minimize the depth of the shelf platform 11. At the second position, as shown in FIG. 8B, the surrounding edge 111 of the shelf platform 11 is supported by the boundary frame via the discrete supporting surfaces 132 at a position that the surrounding edge 111 is located above the base panel 112 to maximize the depth of the shelf platform 11. Accordingly, the shelf platform 11 has a basket configuration to define a cavity 110 within the surrounding edge 111 and the base panel 112, wherein an opening of the cavity 110 is formed within the surrounding edge 111. When the shelf platform 11 is supported at the first position, as shown in FIG. 8A, the cavity 110 is orientated up-side-down that the opening of the cavity 110 faces downward, such that the object can be supported on the base panel 112 above the cavity 110 (not within the cavity 110). When the shelf platform 11 is supported at the second position, as shown in FIG. 8B, the opening of the cavity 110 faces upward, such that the object can be supported on the base panel 112 within the cavity 110.

It is worth mentioning that when the shelf platform 11 is supported at the first position, the base panel 112 is aligned with the first longitudinal edge 121 of the shelf retaining member 12, such that the base panel 112 provides a boundary-less supporting surface for the user to load or unload the object thereon without any obstruction. When the shelf platform 11 is supported at the second position, the boundary frame forms an obstruction wall of the cavity 110. In addition, the user is able to selectively adjust the depth of supporting frame 10 by simply removing the shelf platform 11 from the shelf retaining members 12 and reversibly resting the shelf platform 11 back on the shelf retaining members 12 without disassembling the foldable posts 20. In particular, the user does not require disassembling the shelf retaining members 12 from the foldable posts 20.

It is worth mentioning that since the supporting tabs 131 are integrally protruded from the inner side of the shelf retaining member 12 to the support the shelf platform 11 via the supporting surfaces 132, the downward weighting force of the object will be evenly distributed along the shelf retaining member 12 between the two coupling ends 120 thereof to minimize stress created at the shelf retaining member 12. In addition, the first and second longitudinal edges 121, 122 of the shelf retaining member 12 are two folded edges respectively to reinforce the planar configuration of the shelf retaining member 12 so as to prevent any twisting force created by the downward weighting force of the object.

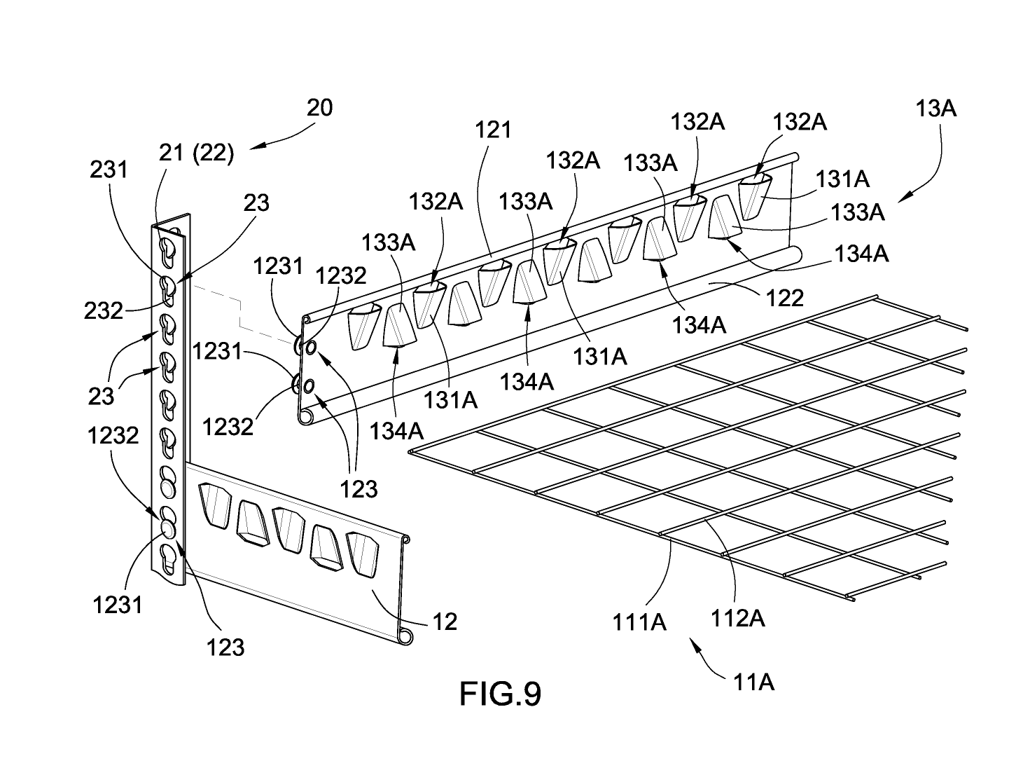

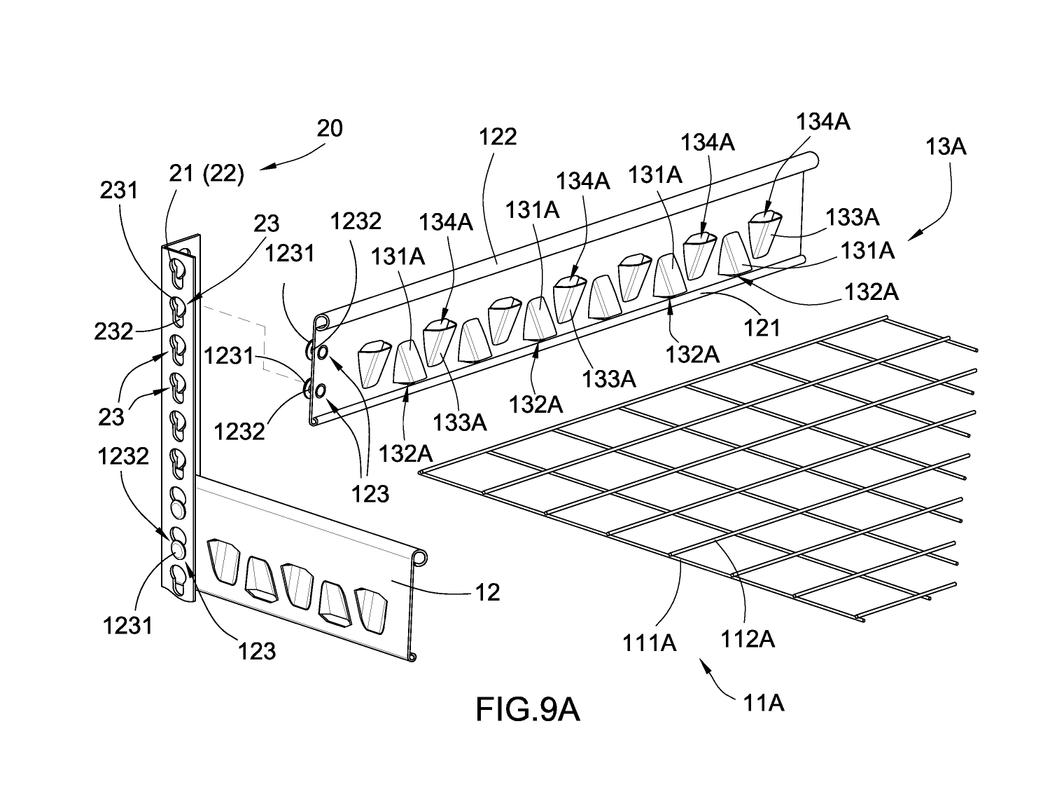

FIGS. 9 and 9A illustrate a first alternative mode of the shelf supporting arrangement 13A. Accordingly, the shelf supporting arrangement 13A comprises a plurality of supporting tabs 131A horizontally aligned with each other and integrally protruded from the inner side of the shelf retaining member 12 between the first and second longitudinal edges 121, 122 thereof, and defines a plurality of discrete supporting surfaces 132A on the supporting tabs 131A to support the shelf platform 11A thereon. As shown in FIG. 9, each of the supporting tabs 131A is integrally bent from the inner side of the shelf retaining member 12 to define the supporting surface 132A close to the first longitudinal edge 121 of the shelf retaining member 12. Preferably, each of the supporting tabs 131A has a triangular shape defining a peak pointing toward the second longitudinal edge 122 of the shelf retaining member 12 and a flat surface as the supporting surface 132A facing toward the first longitudinal edge 121 of the shelf retaining member 12. It is worth mentioning that the discrete supporting surfaces 132A are aligned with each other at the same planar direction to form a flat support for supporting the shelf platform 11A.

The shelf supporting arrangement 13A comprises a plurality of second supporting tabs 133A horizontally aligned with each other and integrally protruded from the inner side of the shelf retaining member 12 between the first and second longitudinal edges 121, 122 thereof, and defines a plurality of second discrete supporting surfaces 134A on the second supporting tabs 133A to support the shelf platform 11A thereon. As shown in FIGS. 9 and 9A, the supporting tabs 131A are alternated with the second supporting tabs 133A. Accordingly, the second supporting tabs 133A are additional supporting tabs of the first supporting tabs 131A. Preferably, the supporting tabs 131A are identical to the second supporting tabs 126A, wherein an orientation of each of the supporting tabs 131A is opposite to an orientation of each of the second supporting tabs 133A. Each of the second supporting tabs 133A is integrally bent from the inner side of the shelf retaining member 12 to define the second supporting surface 134A. Preferably, each of the second supporting tabs 133A has a triangular shape defining a peak pointing toward the first longitudinal edge 121 of the shelf retaining member 12 and a flat surface as the second supporting surface 134A facing toward the second longitudinal edge 122 of the shelf retaining member 12. It is worth mentioning that the second discrete supporting surfaces 134A are aligned with each other at the same planar direction to form a flat support for supporting the shelf platform 11A. In addition, a distance between the first longitudinal edge 121 and the first supporting surface 132A of the shelf supporting arrangement 13A is smaller than a distance between the second longitudinal edge 122 of the shelf retaining member 12 and the second supporting surface 134A of the shelf supporting arrangement 13A.

Accordingly, the shelf platform 11A has a planar configuration for being supported by the boundary frame. In particular, the shelf platform 11A is reversibly supported by the bounding frame at a first position and a reversibly second position to selectively adjust a depth of the shelf platform 11A. Accordingly, the shelf platform 11A has a surrounding edge 111A and a base panel 112A located at same horizontal level of the surrounding edge 111A. At the first position, as shown in FIG. 9, the surrounding edge 111A of the shelf platform 11A is supported by the first supporting surfaces 132A of the first supporting tabs 131A, such that the base panel 112A is aligned with the first longitudinal edge 121A of the shelf retaining member 12A to minimize the depth of the shelf platform 11A. At the second position, as shown in FIG. 9A, the surrounding edge 111A of the shelf platform 11A is supported by the second supporting surfaces 134A of the second supporting tabs 133A to maximize the depth of the shelf platform 11A.

Accordingly, the shelf platform 11A has a panel configuration to be selectively supported at different horizontal levels between the first and second longitudinal edges 121, 122 of the shelf retaining member 12. Accordingly, the shelf platform 11A has a surrounding edge 111A and a base panel 112A located at same horizontal level of the surrounding edge 111A.

When the surrounding edge 111A of the shelf platform 11A is supported at the first position that the first longitudinal edge 121 of the shelf retaining member 12 is orientated above the second longitudinal edge 122 thereof, the shelf platform 11A is supported by the first supporting surfaces 132A of the first supporting tabs 131A to raise the horizontal level of the shelf platform 11A close to the first longitudinal edge 121 of the shelf retaining member 12. It is worth mentioning that when the first longitudinal edge 121 of the shelf retaining member 12 is orientated above the second longitudinal edge 122 thereof, the first supporting surfaces 132A of the first supporting tabs 131A are positioned above the second supporting surfaces 134A of the second supporting tabs 133A.

The shelf retaining member 12 is reversibly coupled to the foldable posts 20 for supporting the shelf platform 11A at the second position, as shown in FIG. 9A, wherein the second longitudinal edge 122 of the shelf retaining member 12 is orientated above the first longitudinal edge 121 thereof. When the surrounding edge 111A of the shelf platform 11A is supported at the second position, the shelf platform 11A is supported by the second supporting surfaces 134A of the second supporting tabs 133A to drop the horizontal level of the shelf platform 11A away from the second longitudinal edge 122 of the shelf retaining member 12. It is worth mentioning that when the second longitudinal edge 122 of the shelf retaining member 12 is orientated above the first longitudinal edge 121 thereof, the second supporting surfaces 134A of the second supporting tabs 133A are positioned above the first supporting surfaces 132A of the first supporting tabs 131A.

It is worth mentioning that when the shelf platform 11A is supported at the first position, the base panel 112A is aligned with the first longitudinal edge 121 of the shelf retaining member 12, such that the base panel 112A provides a boundary-less supporting surface for the user to load or unload the object thereon without any obstruction. When the shelf platform 11A is supported at the second position, the boundary frame forms an obstruction wall. In addition, the user is able to selectively adjust the depth of supporting frame 10 by reversibly mounting the shelf retaining members 12 to the foldable posts 20 and resting the shelf platform 11A on the shelf retaining members 12 without disassembling the foldable posts 20.

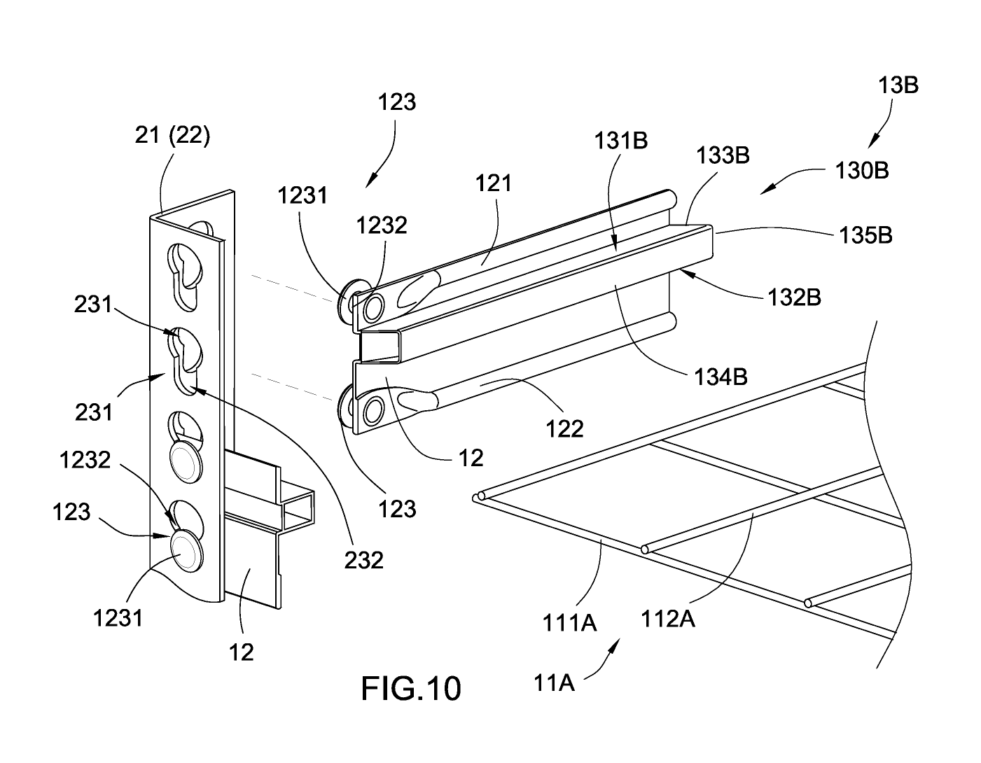

FIG. 10 illustrates a second alternative mode of the shelf supporting arrangement 13B. Accordingly, the shelf supporting arrangement 13B comprises a supporting bar 130B horizontally protruded from the inner side of the shelf retaining member 12 to define a first supporting surface 131B and an opposed second supporting surface 132B to selectively support the shelf platform 11A. Accordingly, the first supporting surface 131B is extended parallel to the second supporting surface 132B. In addition, a distance between the first longitudinal edge 121 of the shelf retaining member 12 and the first supporting surface 131B is smaller than a distance between the second longitudinal edge 122 of the shelf retaining member 12 and the second supporting surface 132B.

Accordingly, the supporting bar 130B, having a rectangular cross section, has a first bar panel 133B defining the first supporting surface 131B thereon, a second bar panel 134B defining the second supporting surface 132B thereon, and a reinforcing panel 135B extended between the first and second bar panels 133B, 134B to reinforce a rigidity of each of the first and second bar panels 133B, 134B.

Accordingly to the preferred embodiment, the shelf platform 11A has a planar configuration for being supported by the boundary frame. In particular, the shelf platform 11A is reversibly supported by the bounding frame at a first position and a reversibly second position to selectively adjust a depth of the shelf platform 11A. Accordingly, the shelf platform 11A has a surrounding edge 111A and a base panel 112A located at same horizontal level of the surrounding edge 111A. At the first position, the surrounding edge 111A of the shelf platform 11A is supported by the first supporting surfaces 131B of the supporting bar 130B, such that the base panel 112A is aligned with close to the first longitudinal edge 121 of the shelf retaining member 12 to minimize the depth of the shelf platform 11A. At the second position, the surrounding edge 111A of the shelf platform 11A is supported by the second supporting surfaces 132B of the supporting bar 120B to maximize the depth of the shelf platform 11A.

Accordingly, the shelf platform 11A has a panel configuration to be selectively supported at different horizontal levels between the first and second longitudinal edges 121, 122 of the shelf retaining member 12. When the shelf platform 11A is supported at the first position that the first longitudinal edge 121 of the shelf retaining member 12 is orientated above the second longitudinal edge 122 thereof, the shelf platform 11A is supported by the first supporting surface 131B of the supporting bar 130B to raise the horizontal level of the shelf platform 11A close to the first longitudinal edge 121 of the shelf retaining member 12. It is worth mentioning that when the first longitudinal edge 121 of the shelf retaining member 12 is orientated above the second longitudinal edge 122 thereof, the first supporting surface 131B of the supporting bar 130B are positioned above the second supporting surface 132B of the supporting bar 130B.

The shelf retaining member 12 is reversibly coupled to the foldable posts 20 for supporting the shelf platform 11A at the second position, wherein the second longitudinal edge 122 of the shelf retaining member 12 is orientated above the first longitudinal edge 121 thereof. When the shelf platform 11B is supported at the second position, the shelf platform 11B is supported by the second supporting surface 132B of the supporting bar 130B to drop the horizontal level of the shelf platform 11A away from the second longitudinal edge 122 of the shelf retaining member 12. It is worth mentioning that when the second longitudinal edge 122 of the shelf retaining member 12 is orientated above the first longitudinal edge 121 thereof, the second supporting surface 132B of the supporting bar 130B are positioned above the first supporting surface 131B of the supporting bar 130B.

It is worth mentioning that when the shelf platform 11A is supported at the first position, the base panel 112A is aligned with the first longitudinal edge 121 of the shelf retaining member 12, such that the base panel 112A provides a boundary-less supporting surface for the user to load or unload the object thereon without any obstruction. When the shelf platform 11A is supported at the second position, the boundary frame forms an obstruction wall. In addition, the user is able to selectively adjust the depth of supporting frame 10 by reversibly mounting the shelf retaining members 12 to the foldable posts 20 and resting the shelf platform 11A on the shelf retaining members 12 without disassembling the foldable posts 20.

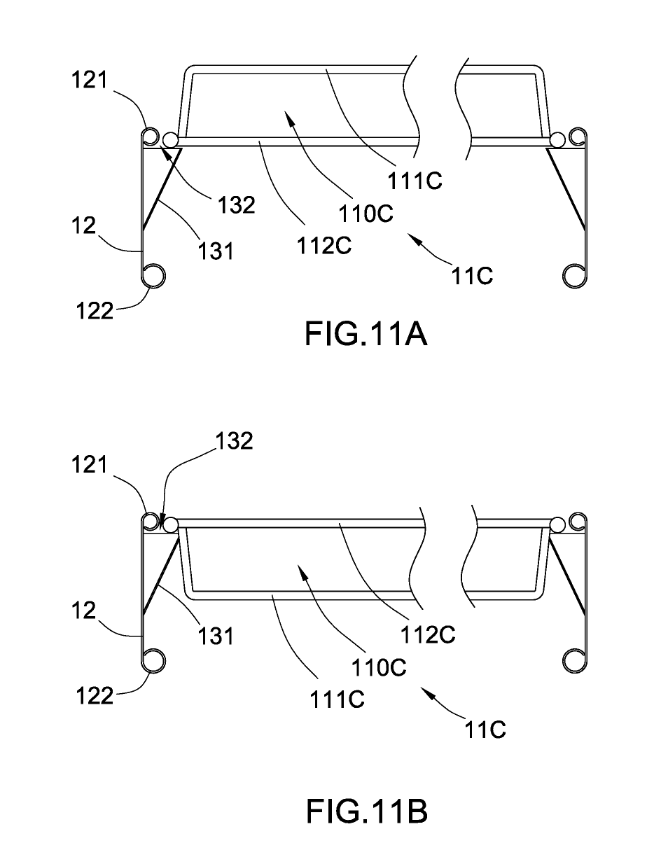

FIGS. 11A and 11B illustrate an alternative mode of the shelf platform 11C which is reversibly supported by the boundary frame at a first position and a reversibly second position to selectively adjust a depth of the shelf platform 11C. In particular, the shelf platform 11C has a surrounding edge 111C and a base panel 112C located at different horizontal levels of the surrounding edge 111C. Accordingly, a circumferential size of the surrounding edge 111C is smaller than a circumferential size of the base panel 112C. At the first position, as shown in FIG. 11A, the base panel 112C of the shelf platform 11C is supported by the boundary frame via the discrete supporting surfaces 132 at a position that the surrounding edge 111C of the shelf platform 11C is located above the base panel 112C thereof to maximize the depth of the shelf platform 11C. At the second position, as shown in FIG. 11B, the base panel 112C of the shelf platform 11C is supported by the boundary frame via the discrete supporting surfaces 132 at a position that the surrounding edge 111C of the shelf platform 11C is located below the base panel 112C thereof to minimize the depth of the shelf platform 11C. Accordingly, the shelf platform 11C has a basket configuration to define a cavity 110C within the surrounding edge 111C and the base panel 112C, wherein an opening of the cavity 110C is formed within the surrounding edge 111C. When the shelf platform 11C is supported at the first position, as shown in FIG. 11A, the opening of the cavity 110C faces upward, such that the object can be supported on the base panel 112C within the cavity 110C. When the shelf platform 11C is supported at the second position, as shown in FIG. 11B, the cavity 110C is orientated up-side-down that the opening of the cavity 110C faces downward, such that the object can be supported on the base panel 112C above the cavity 110C (not within the cavity 110C).

It is worth mentioning that when the shelf platform 11C is supported at the first position, the surrounding edge 111C of the shelf platform 11C forms an obstruction wall of the cavity 110C. When the shelf platform 11C is supported at the second position, the base panel 112C is aligned with the first longitudinal edge 121 of the shelf retaining member 12, such that the base panel 112 provides a boundary-less supporting surface for the user to load or unload the object thereon without any obstruction.

It is worth mentioning that the base panel 112C is aligned with the first longitudinal edge 121 of the shelf retaining member 12 at the first and second positions. At the first position, the surrounding edge 111C of the shelf platform 11C is located above the first longitudinal edge 121 of the shelf retaining member 12. At the second position, the surrounding edge 111C of the shelf platform 11C is located below the first longitudinal edge 121 of the shelf retaining member 12.

In addition, the user is able to selectively adjust the depth of supporting frame 10 by simply removing the shelf platform 11C from the shelf retaining members 12 and reversibly resting the shelf platform 11C back on the shelf retaining members 12 without disassembling the foldable posts 20. In particular, the user does not require disassembling the shelf retaining members 12 from the foldable posts 20.

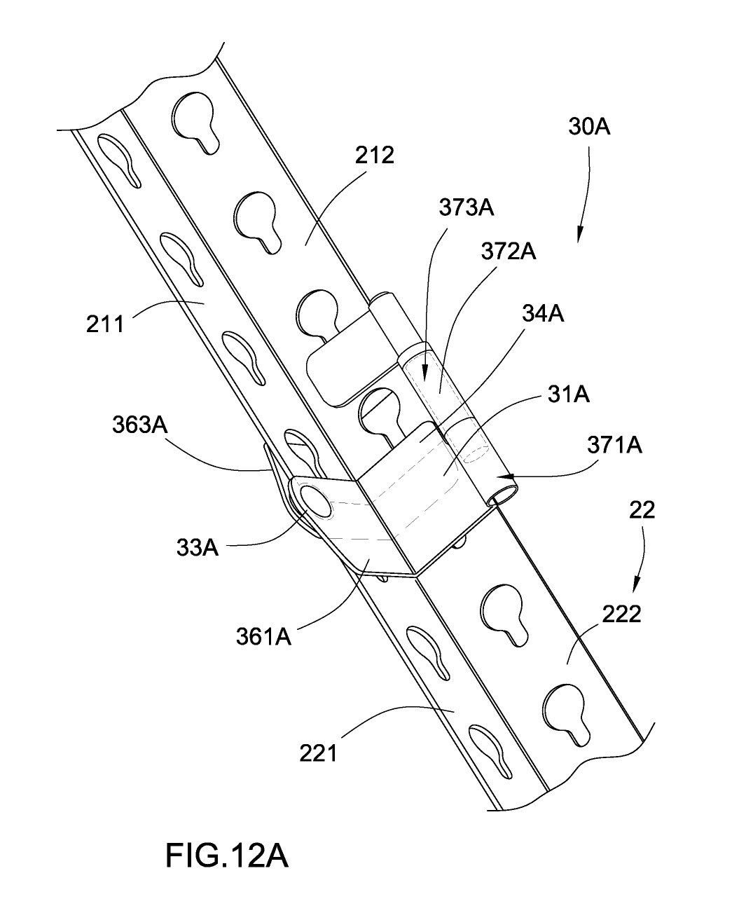

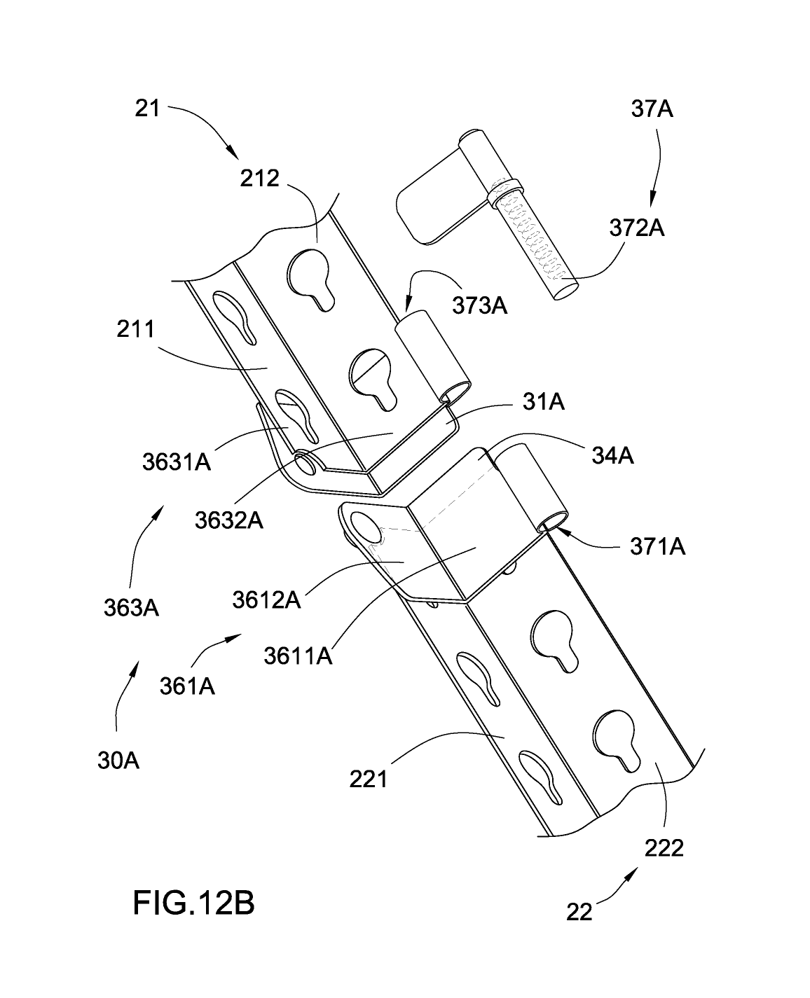

FIGS. 12A and 12B illustrate an alternative mode of the post joint 30A which comprises a first means provided at the upper post member 21 and a second means provided at the lower post member 22 to interlock the upper and lower post members 21, 22 with each other. In particular, the post joint 30A comprises a first engaging tongue 31A extended from the end portion of the upper post member 21, a second engaging tongue 34A extended from the end position of the lower post member 22, and a pivot hinge 33A pivotally coupled the upper and lower post members 21, 22, such that when the upper and lower post members 21, 22 are pivotally moved to engage the first engaging tongue 31A with the lower post member 22 and to engage the second engaging tongue 34A with the upper post member 21, as shown in FIG. 12A, the upper and lower post members 21, 22 are interlocked and coupled with each other end-to-end to form the foldable post 20. The upper and lower post members 21, 22 are pivotally folded via the pivot hinge 33A, as shown in FIG. 12B, the upper and lower post members 21, 22 can be pivotally folded side-by-side. In other words, the first and second means are the first and second engaging tongues 31A, 34A to form the interlocking unit to interlock the upper and lower post members 21, 22 with each other.

Accordingly, the first engaging tongue 31A is extended from one of the first and second post walls 211, 212 of the upper post member 21 and the second engaging tongue 34A is extended from one of the first and second post walls 221, 222 of the lower post member 22. Preferably, the first and second engaging tongue 31A, 34A are extended from the second post walls 212, 222 of the upper and lower post members 21, 22 respectively. In addition, the first engaging tongue 31A is extended from the outer side of the upper post member 21 and the second engaging tongue 34A is extended from the inner side of the lower post member 22, such that when the upper and lower post members 21, 22 are pivotally moved end-to-end, as shown in FIG. 12A, the first engaging tongue 31A is engaged with the outer side of the lower post member 22 while the second engaging tongue 34A is engaged with the inner side of the upper post member 21, so as to interlock the upper and lower post members 21, 22 with each other. It is worth mentioning that the first and second engaging tongues 31A, 34A form a slot therebetween to receive the end portions of the upper and lower post members 21, 22 when the upper and lower post members 21, 22 are pivotally moved end-to-end.

As shown in FIGS. 12A and 12B, the post joint 30A further comprises two coupling sleeves 36A coupling with the end portions of the upper and lower post members respectively, wherein the pivot hinge 33A is formed between the coupling sleeves 36A to pivotally couple the upper and lower post members 21, 22. Accordingly, one of the coupling sleeves 36A is coupled at the outer side of the upper post member 21, wherein a portion of the coupling sleeve 36A is upwardly extended out of the end portion of the upper post member 21 to form the first engaging tongue 31A. The other coupling sleeve 36A is coupled at the inner side of the lower post member 22, wherein a portion of the coupling sleeve 36A is downwardly extended out of the end portion of the lower post member 22 to form the second engaging tongue 34A.

According to the preferred embodiment, one of the coupling sleeve 36A comprises an outer sleeve 363A coupled at the outer side of the upper post member 21. The outer sleeve 363A has two outer sleeve portions 3631A, 3632A coupled at the outer sides of the first and second post walls 211, 212 of the upper post member 21 respectively. The other coupling sleeve 36A comprises an inner sleeve 361A coupled at the inner side of the lower post member 22. The inner sleeve 361A has two inner sleeve portions 3611A, 3612A coupled at the inner sides of the first and second post walls 221, 222 of the lower post member 21 respectively. Preferably, the coupling sleeves 36A are securely affixed to the end portions of the upper and lower post members 21, 22 by welding to ensure the secure engagement of the post joint 30A to the upper and lower post members 21.

The pivot hinge 33A is pivotally coupled one of the outer sleeve portions 3631A with one of the inner sleeve portions 3611A at the edges thereof. In particular, the first and second engaging tongues 31A, 34A are extended from the other outer sleeve portions 3632A and the inner sleeve portion 3612A respectively.

As shown in FIG. 12A, the post joint 30A further comprises a post locker 37A for releasebly locking the end-to-end interlocking of the upper and lower post members 21, 22. In particular, the post locker 37A is arranged to lock up the pivotal movement between the upper and lower post members 21A, 22A. Accordingly, the post locker 37A comprises a locking slot 371A provided at the lower post member 22 and a locking latch 372A provided at the upper post member 21, such that when the upper and lower post members 21, 22 are pivotally moved to interlock with each other via the first and second engaging tongues 31A, 34A, the locking latch 372A is actuated to engage with the locking slot 371A to retain the upper and lower post members 21, 22 to be coupled with each other end-to-end.

In addition, the post joint 30A further comprises a guiding slot 373A provided at the upper post member 21 to align with the locking slot 371A, wherein the locking latch 372A is guided by the guiding slot 373A to slidably actuate to selectively lock up with the locking slot 371A. Preferably, the locking latch 372A is a spring-loaded device to push the locking latch 372A to the locking slot 317A. In other word, when the locking latch 372A is slidably pulled along the guiding slot 373A until a free end of the locking latch 372A is disengaged with the locking slot 371A, the upper and lower post members 21, 22 are capable of being pivotally moved via the pivot hinge 33A. Once the upper and lower post members 21, 22 are pivotally moved to interlock with each other via the first and second engaging tongues 31A, 34A, the locking latch 372A is slidably pushed until the free end of the locking latch 372A is engaged with the locking slot 371A to lock up the pivotal movement between the upper and lower post members 21, 22. Accordingly, the guiding slot 373A and the locking slot 371A are formed at the coupling sleeves 36A respectively. In addition, the pivot hinge 33A is formed one side edge of the coupling sleeve 36A and the post locker 37A is formed at an opposed side edge of the coupling sleeve 36A. It is worth mentioning that the guiding slot 373A and the locking slot 371A are formed at the outer sleeve portions 3632A and the inner sleeve portion 3612A at the edges thereof respectively.

It is worth mentioning that the post joint 30 and the supporting frame 10 of their alternative modes are interchangeable that the supporting frame 10 can be incorporated with any one the alternative modes of the post joint 30 and the post joint 30 can be incorporated with any one of the alternative modes of the supporting frame 10.

It is worth mentioning that the shelving apparatus of the instant invention can be easily set up by pivotally folding the post members 21, 22 via the post joint 30 end-to-end, as shown in FIG. 6A, to form the foldable posts 20 and by coupling the supporting frame 10, 10A, 10B to the foldable posts 20 to form a completed shelving unit. Once the post members 21, 22 are pivotally folded end-to-end, the tongue-and-groove engagement provided by the post joint 30 will ensure the post members 21, 22 to be coupled with each other end-to-end so as to ensure the rigidity of the foldable post 20. For disassembling the shelving apparatus of the instant invention, the user is able to easily detach the supporting frame 10, 10A, 10B from the foldable posts 20, and is able to pivotally fold the post members 21, 22 side-by-side via the post joint 30 as shown in FIG. 6B, to minimize the overall length of each of the foldable posts 20. It is worth mentioning that the post joint 30 is remained attached to two end portions of the upper and lower post members 21, 22 when the upper and lower post members 21, 22 of the foldable post are folded side-by-side in a folded manner so as to prevent any misplacement of the component or missing thereof when the shelving apparatus is dissembled. When the post members 21, 22 are folded side-by-side to form a folded post, a length of the folded post is equal or lesser than a length of the shelf retaining member 12 which forms the front or rear boundary for minimizing the packaging size of the shelving apparatus.

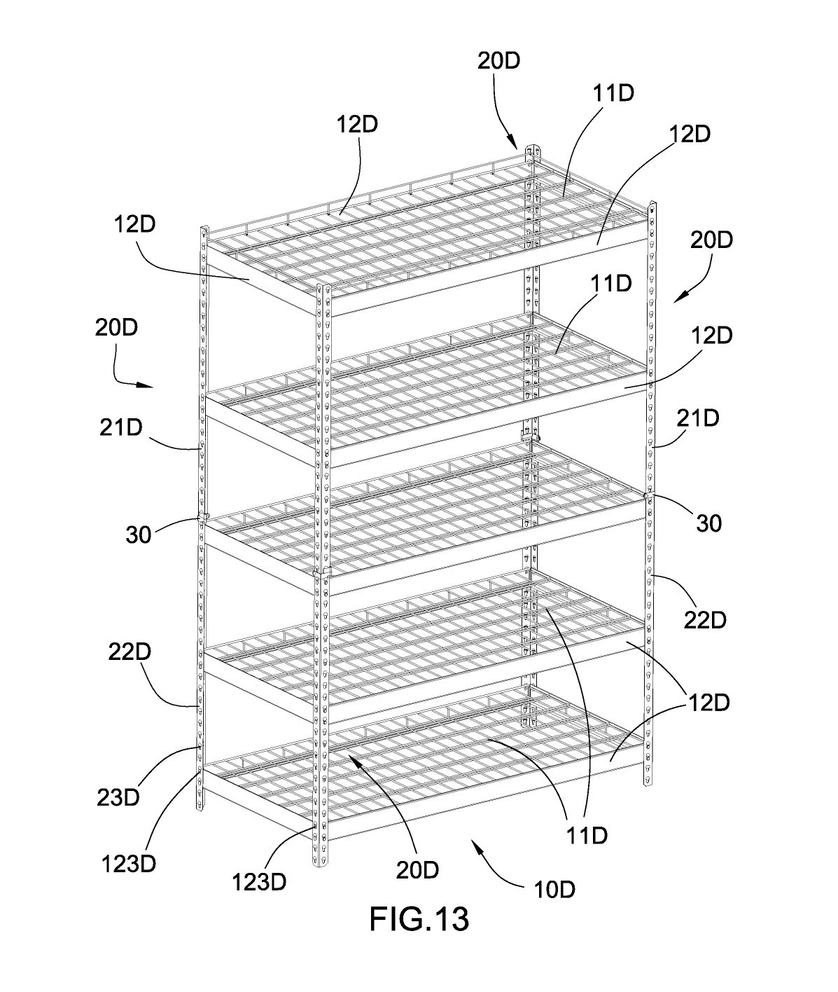

As shown in FIG. 13, a shelving apparatus according to a second embodiment illustrates an alternative mode of the first embodiment, wherein the structural configuration of the shelving apparatus of the second embodiment is the modification of the first embodiment. Accordingly, the upper and lower post members 21D, 22D of the foldable post 20D of the second embodiment are modifications of the upper and lower post members 21, 22 of the foldable post 20 of the first embodiment, wherein the upper and lower post members 21D, 22D are pivotally coupled via the pivot hinge 33.

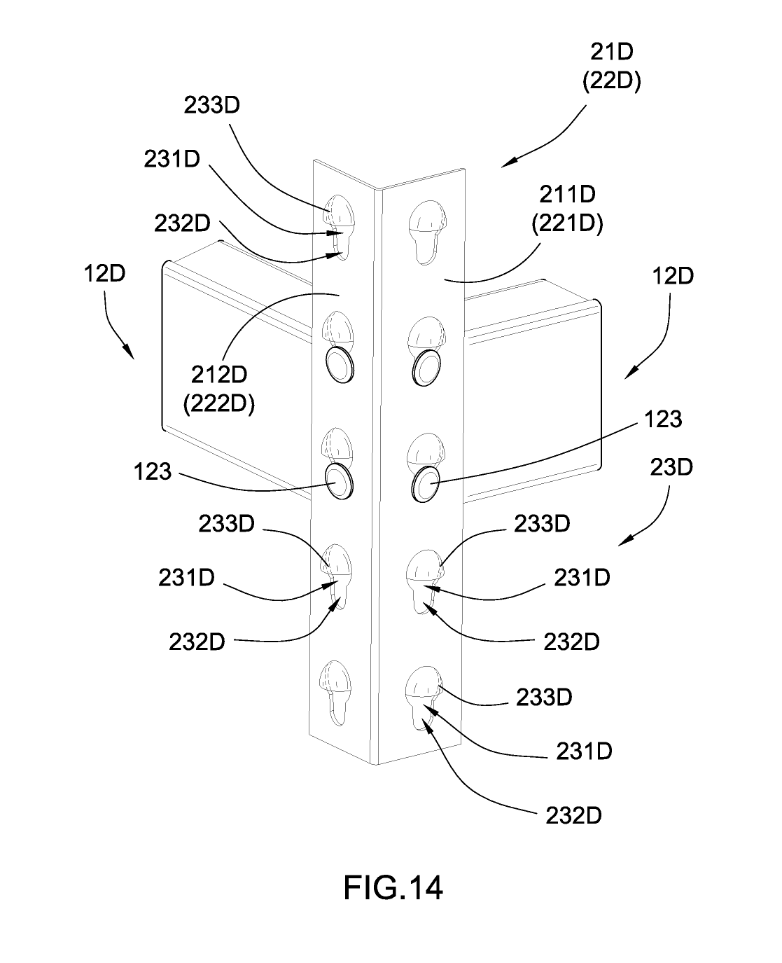

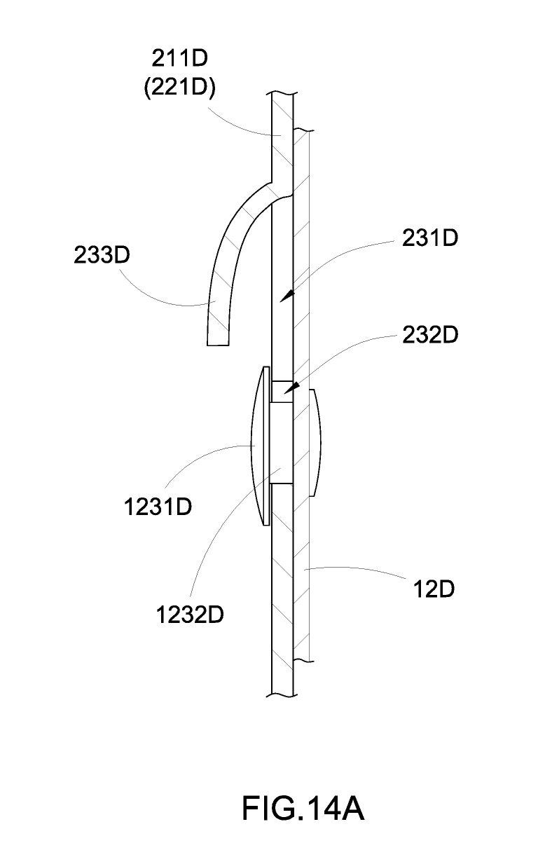

As shown in FIGS. 13 and 14, a plurality of keyholes 23D are alignedly formed on the first post wall 211D, 221D and the second post wall 212D, 222D of each of the upper and lower post members 21D, 22D. Each of the keyholes 23D has an upper hole portion 231D and a lower hole portion 232D, wherein a size of the upper hole portion 231D is larger than a size of the lower hole portion 232D. Each of the upper and lower post members 21D, 22D further comprises a plurality of keyhole covers 233D integrally and outwardly protruded from the outer side of each of the first post wall 211D, 221D and the second post wall 212D, 222D. In particular, each of the keyhole covers 233D is integrally extended to partially cover the upper hole portion 231D of each of the keyholes 23D at the outer side of the post members 21D, 22D while the lower hole portion 232D of each of the keyholes 23D is uncovered. The shape and size of the keyhole cover 233D is configured according to the shape and size of the upper hole portion 231D of the keyhole 23D. In order to form the keyhole covers 233D, each of the upper and lower post members 21D, 22D is punched at the inner side thereof via a punching machine to bend the keyhole covers 233D out from the outer side of each of the upper and the lower post members 21D, 22D.

As shown in FIGS. 13 to 16, each of the shelf retaining members 12D has a planar structure to have the first and second longitudinal edges 121D, 122D extended parallel with each other, wherein two ends of each of the shelf retaining members 12D are detachably engaged with keyholes 23D of the two foldable posts 20D. Accordingly, two fasteners 123D are provided at each coupling end 120D of the shelf retaining member 12D to engage with two keyholes 23D of the corresponding foldable post 20D. In particular, two fastener holes are formed at each coupling end of the shelf retaining member 12D, wherein the two fasteners 123D are affixed to the shelf retaining member 12D via the fastener holes respectively. According to the preferred embodiment, each of the fasteners 123D is riveted to the respective coupling end 120D of the shelf retaining member 12D and has a head 1231D having a size larger than the lower hold portion 232D and slightly smaller than the upper hole portion 231D so as to fittingly inserted through the upper hole portion 231D while guiding by the keyhole cover 233D not to prevent the head 1231D from over inserting and to guide a neck 1232D, protruded between the head 1231D and the shelf retaining member 12D and having a size smaller than the head 1231D, to slide into the lower hole portion 232D of the corresponding keyhole 23D from the upper hole portion 231D, so as to securely couple the shelf retaining member 12D at the post member 21D of the foldable post 20D.

It is worth mentioning that when the fastener 123D is inserted into the upper hole portion 231D of the keyhole 23D, as shown in FIG. 14A, the fastener 123D is blocked by the respective keyhole cover 233D to ensure the engagement between the fastener 123D and the keyhole 23D. Therefore, the fastener 123D can be correctly slid to the lower hole portion 232D from the upper hole portion 231D, so as to securely couple the shelf retaining member 12D at the foldable post 20D. In addition, since the fastener 123D is slid at the lower hole portion 232D of the keyhole 23D, a portion of the fastener 123D, such as the head 1231D, can be covered and protected by the keyhole cover 233D to protect the fastener 123D from being damaged by any external force at the outer side of each of the upper and the lower post members 21D, 22D.

It is worth mentioning that the shelf platform 11D or the shelf retaining members 12D is reversibly supported at a first position and a reversibly second position to selectively adjust a depth of the shelf platform 11D. The structural configuration of the shelf platform 11D and the shelf retaining members 12D are the same as the above mentioned embodiments. As shown in FIG. 13, the top level of the shelf apparatus is shown that the shelf retaining members 12D form a boundary frame for the shelf platform 11D while the second to bottom levels of the shelf apparatus are shown that the shelf retaining members 12D form a boundary-less frame for the shelf platform 11D.

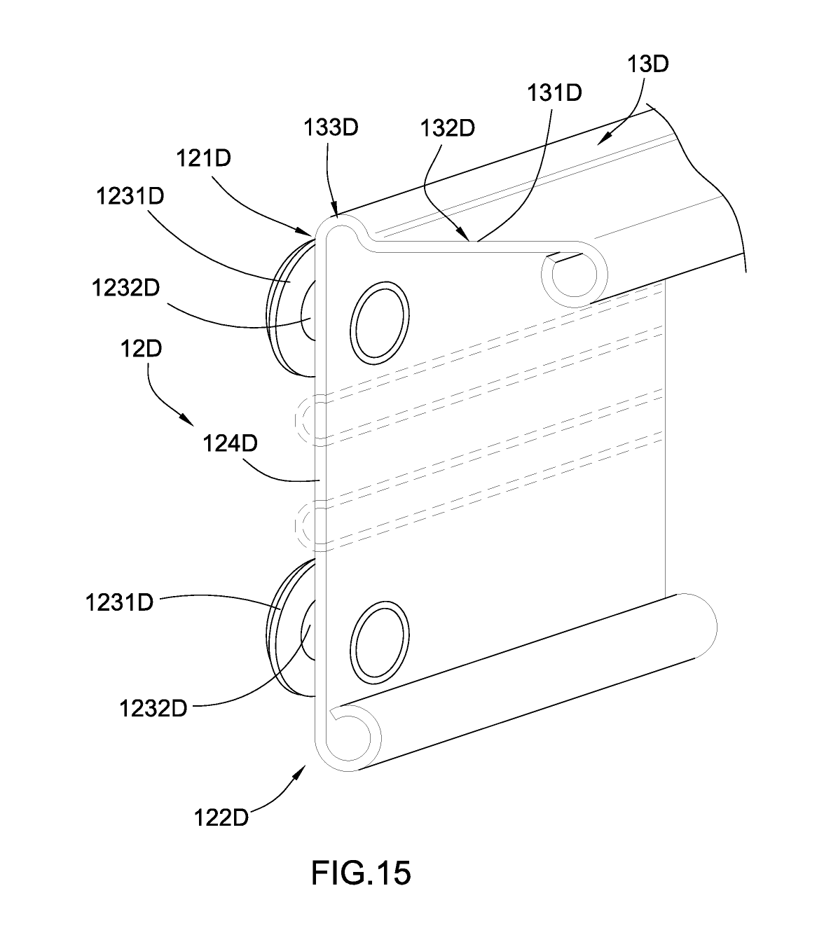

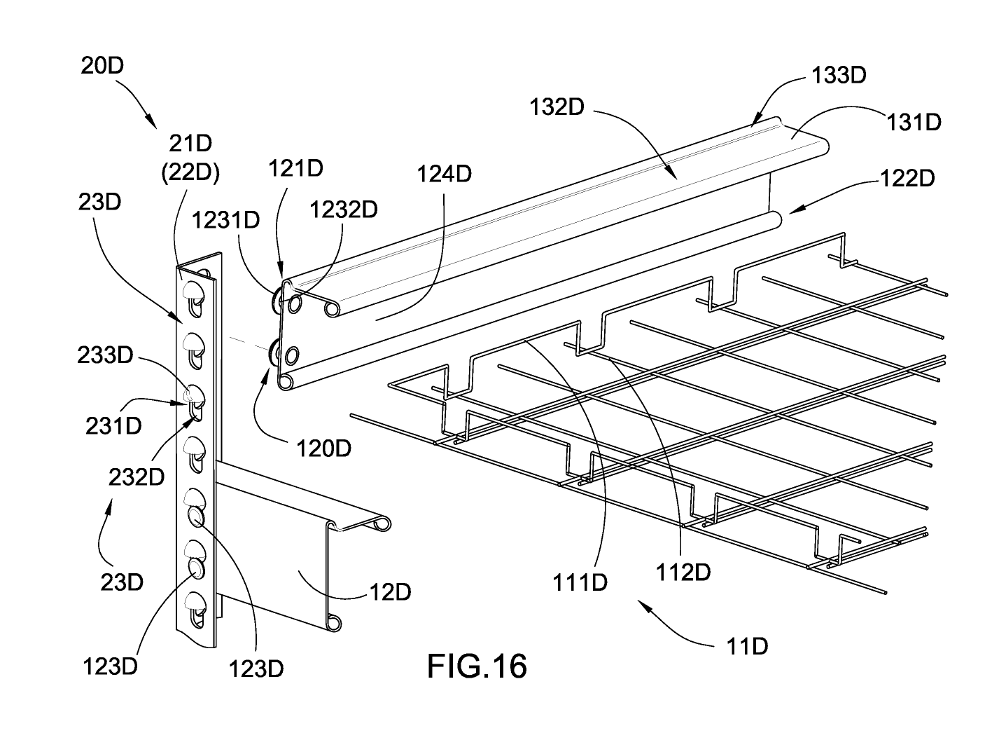

As shown in FIGS. 15 and 16, each of the shelf retaining members 12D comprises a vertical beam wall 124D defining the first and second longitudinal edges 121D, 122D at the upper and bottom edges of the vertical beam wall 124D. In particular, the second longitudinal edge 122D of each of the shelf retaining members 12D is a folded edge that the bottom edge of the vertical beam wall 124D is inwardly folded on an inner side of the vertical beam wall 124D. Accordingly, the second longitudinal edge 122D of each of the shelf retaining members 12D has a circular cross sectional configuration.

The shelf supporting arrangement 13D comprises a top beam wall 131D integrally and horizontally extended from the upper edge of the vertical beam wall 124D to define a supporting surface 132D on the top beam wall 131D close to the first longitudinal edge 121D of the shelf retaining member 12D. The supporting surface 132D is an elongated flat surface to support the shelf platform 11D. Furthermore, a free edge of the top beam wall 131D is also a folded edge that the free edge of the top beam wall 131D is downwardly folded on a bottom side of the top beam wall 131D. Accordingly, the free edge of the top beam wall 131D has a circular cross sectional configuration.

The shelf supporting arrangement 13D further has a longitudinal reinforcing rib 133D integrally extended between the first longitudinal edge 121D of the shelf retaining member 12D and the top beam wall 131D. Accordingly, the longitudinal reinforcing rib 133D has a curved or arc-shaped cross sectional configuration that the longitudinal reinforcing rib 133D is extended between the upper edge of the vertical beam wall 124D and the top beam wall 131D. It is worth mentioning that the second longitudinal edge 122D of the shelf retaining member 12D, the free end of the top beam wall 131D, and the longitudinal reinforcing rib 133D is formed in curved cross sectional configuration to reinforce the structure of the shelf retaining member 12D to prevent any twisting movement or torque created thereat. In other words, when the downward loading force is applied on the supporting surface 132D of the top beam wall 131D, the longitudinal reinforcing rib 133D will prevent any twisting movement of the top beam wall 131D and will evenly transfer the downward loading force to the vertical beam wall 124D. Since the vertical beam wall 124D is coupled between two posts 20, the downward loading force will then transfer to the posts 20 via the vertical beam wall 124D so as to prevent any twisting movement of the vertical beam wall 124D.

As shown in FIG. 15, one or more of additional longitudinal reinforcing rib can be integrally and outwardly formed at the vertical beam wall 124D. Preferably, two additional longitudinal reinforcing ribs are extended in parallel, wherein each of the additional longitudinal reinforcing ribs has a curved cross section integrally bent at a mid-portion of the vertical beam wall 124D to reinforce the structure of the vertical beam wall 124D to prevent any twisting movement or torque created thereat.

It is appreciated that, as shown in FIGS. 15 to 16, when the shelf platform 11D sits on the supporting surface 132D, the downward force applied on the supporting surface 132D is supported and held by the top beam wall 131D which is further reinforced by the reinforcing ribs 133D and the additional reinforcing ribs that not only prevent the beam wall from being bent and deformed, but also provide better supporting ability to the top beam wall 131D and the supporting surface 132D. It is worth mentioning that two ends of the shelf retaining member 12D are coupled at two of the foldable posts 20D respectively, such that the longitudinal reinforcing ribs 133D will generate an anti-twist reinforcing force to reinforce the planar structure of the vertical beam wall 124D so as to prevent any twisting force created thereat. In addition, when the downward force is applied on the supporting surface 132D, the downward force will transfer to the vertical beam wall 124D. Therefore, the reinforcing force from the reinforcing rib 133D will withstand the downward force at the vertical beam wall 124D. In other words, the reinforcing ribs 133D will also reinforce the downward force applied on the supporting surface 132D.

Furthermore, by configuring the longitudinal reinforcing rib 133D to have a curved cross section outwardly extended from the vertical beam wall 124D, the longitudinal reinforcing rib 133D will also generate a resilient force at the curved portion thereof. The direction of the resilient force of the longitudinal reinforcing rib 133D is opposite to the downward force applied on the supporting surface 132D, such that the longitudinal reinforcing rib 133D will also enhance the supporting ability of the supporting surface 132D to support a heavier load thereon.

It is worth mentioning that the shelf platform 11D of the supporting frame 10D is reversibly supported by the supporting surface 132D at a first position and a reversibly second position to selectively adjust a depth of the shelf platform 11D. At the first position, the base panel 112D of the shelf platform 11D is supported by the supporting surface 132D at a position that the surrounding edge 111D of the shelf platform 11D is located above the base panel 112D thereof to maximize the depth of the shelf platform 11D. At the second position, the base panel 112D of the shelf platform 11D is supported by the supporting surface 132D at a position that the surrounding edge 111D of the shelf platform 11D is located below the base panel 112D thereof to minimize the depth of the shelf platform 11D.

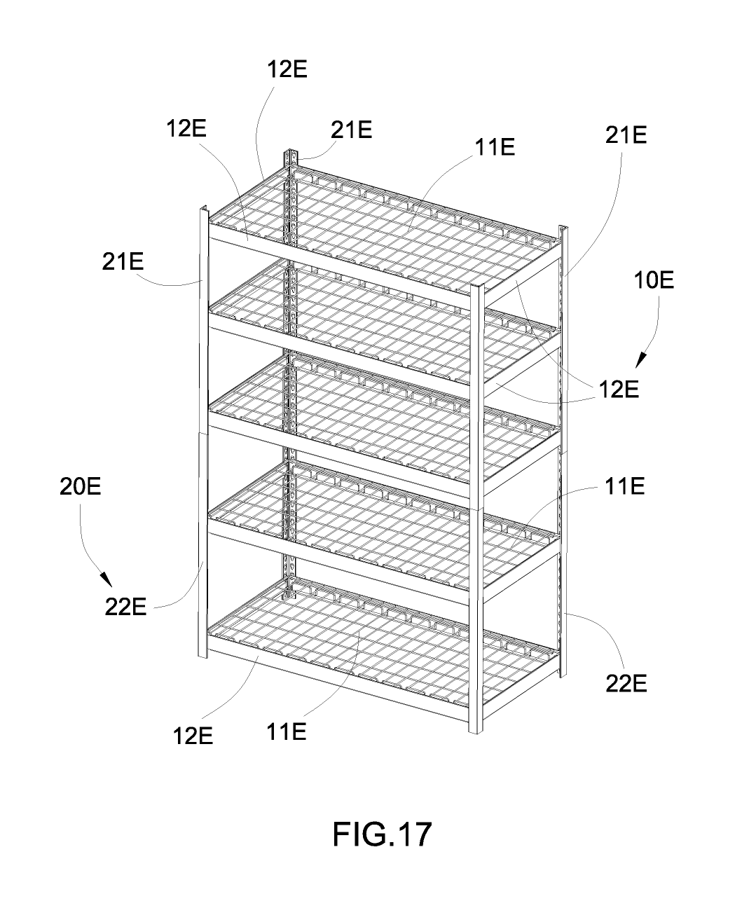

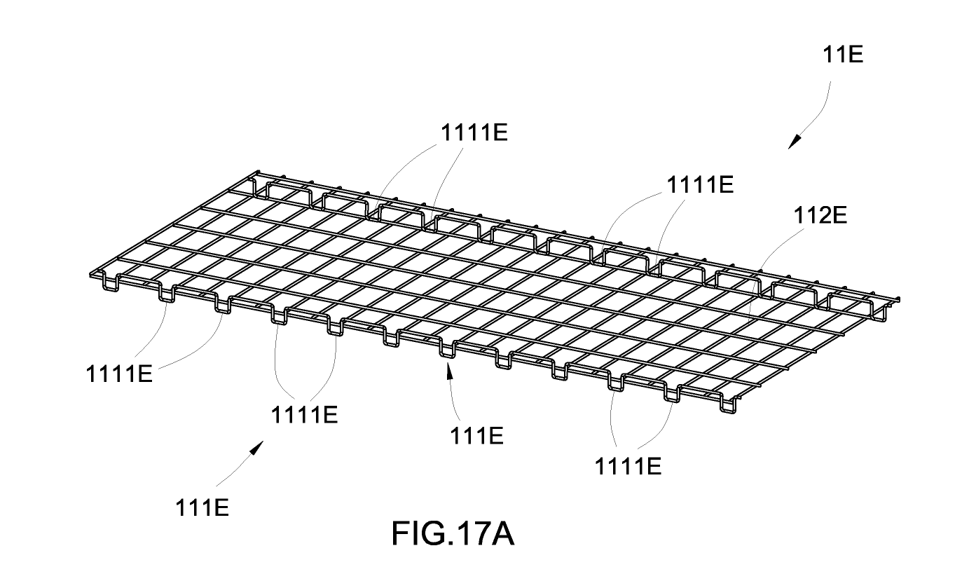

As shown in FIG. 17, a shelving apparatus according to a third embodiment illustrates an alternative mode of the first and second embodiments, wherein the structural configuration of the shelving apparatus of the third embodiment is the modification of the first and second embodiments. Accordingly, the shelving apparatus comprises a plurality of posts 20E and a supporting frame 10E.

Each of the posts 20E, having a L-shaped configuration, comprising at least an upper post member 21E, at least a lower post member 22E, and at least a post joint 30E connecting the upper and lower post members 21E, 22E to form the respective post such that the upper and lower post members 21E, 22E are capable of being coupled and extended rigidly in an end-to-end and vertically oriented manner and being detached with each other.

Each of the upper and lower post members 21E, 22E has a first post wall 211E, 221E and a second post wall 212E, 222E extended from the first post wall 211E, 221E at an angle, preferably right angle. In particular, each of the upper and lower post members 21E, 22E comprises an outer wall shell 213E and an inner wall shell 214E spacedly overlapped on the outer wall shell 213E to define a post cavity 210E between the outer wall shell 213E and the inner wall shell 214E. Therefore, the first post wall 211E, 221E forms a double wall structure to have an outer first post wall 2111E, 2211E and an inner first post wall 2112E, 2212E, and the second post wall 212E, 222E also forms a double wall structure to have an outer second post wall 2121E, 2221E and an inner second post wall 2122E, 2222E. In other words, the outer wall shell 213E of the upper post member 21E is constructed to have the outer first post wall 2111E and the outer second post wall 2121E. The inner wall shell 214E of the upper post member 21E is constructed to have the inner first post wall 2112E and the inner second post wall 2122E. The outer wall shell 213E of the lower post member 22E is constructed to have the outer first post wall 2211E and the outer second post wall 2221E. The inner wall shell 214E of the lower post member 22E is constructed to have the inner first post wall 2212E and the inner second post wall 2222E. It is worth mentioning that the post cavity 210E is divided into a first post cavity 2101E between the outer first post wall 2111E, 2211E and the inner first post wall 2112E, 2212E and a second post cavity 2102E between the outer second post wall 2121E, 2221E and the inner second post wall 2122E, 2222E. The first and second post cavities 2101E, 2012E are communicated with each other.

It is worth mentioning that each of the upper and lower post members 21E, 22E is made of metal sheet, wherein the metal sheet is divided into four transverse portions, i.e. two outer transverse portions and two inner transverse portions. The two inner transverse portions of the metal sheet are inwardly folded on the outer transverse portions, and the outer transverse portions are bent at an angle. In other words, the two outer transverse portions of the upper post member 21E form the outer first post wall 2111E and the outer second post wall 2121E respectively. The two inner transverse portions of the upper post member 21E form the inner first post wall 2112E and the inner second post wall 2122E respectively. The two outer transverse portions of the lower post member 22E form the outer first post wall 2211E and the outer second post wall 2221E respectively. The two inner transverse portions of the lower post member 22E form the inner first post wall 2212E and the inner second post wall 2222E respectively.

It is worth mentioning that two outer edges of the metal sheet are outwardly folded to form two folding edges thereof, wherein a longitudinal gap 2103E is formed between the two folding edges of the metal sheet. In other words, the longitudinal gap 2103E is formed between two inner edges of the inner first post wall 2112E and the inner second post wall 2122E to communicate with the post cavity 201E of the upper post member 21E. The longitudinal gap 2103E is also formed between two inner edges of the inner first post wall 2212E and the inner second post wall 2222E to communicate with the post cavity 201E of the lower post member 22E. Accordingly, the folding edges of the metal sheet forms the reinforcing ribs to reinforce the structure of the upper and lower post members 21E, 22E to prevent any twisting movement of torque created thereat.

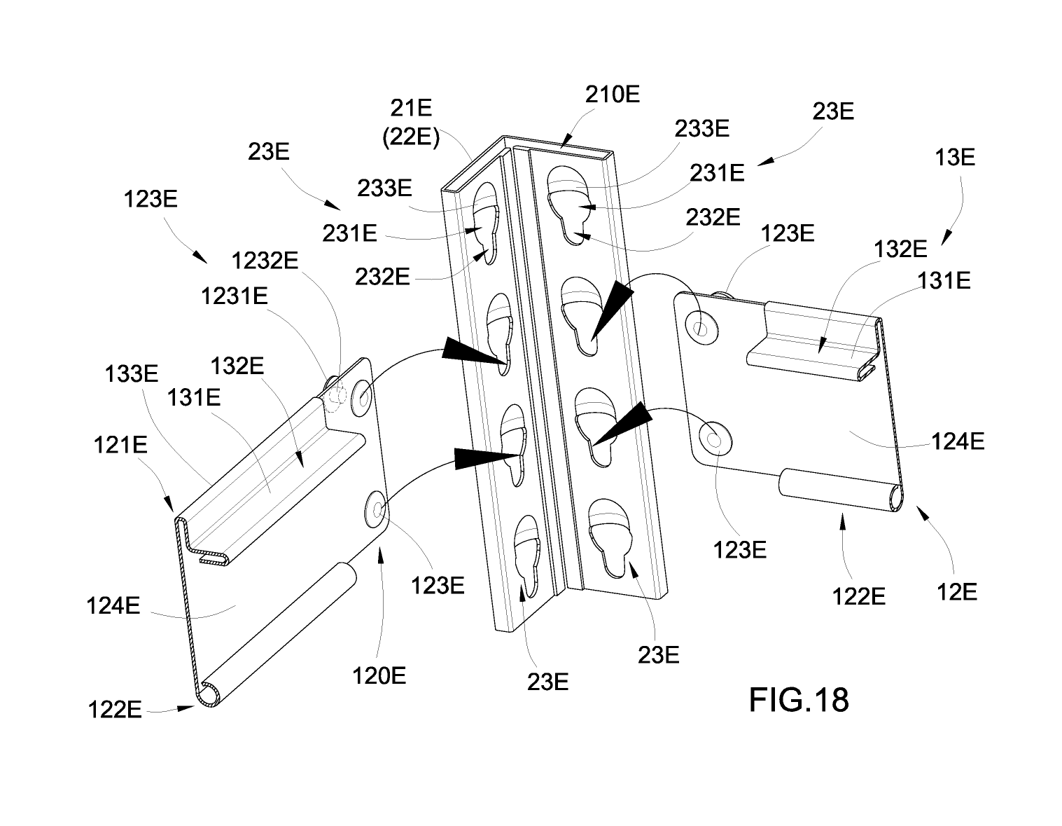

As shown in FIG. 18, a plurality of keyholes 23E are alignedly formed on the first post wall 211E, 221E and the second post wall 212E, 222E of each of the upper and lower post members 21E, 22E. Each of the keyholes 23E has an upper hole portion 231E and a lower hole portion 232E, wherein a size of the upper hole portion 231E is larger than a size of the lower hole portion 232E.

In particular, the keyholes 23E are alignedly formed on the inner first post wall 2112E and the inner second post wall 2122E of the upper post member 21E and on the inner first post wall 2212E and the inner second post wall 2222E of the lower post member 22E, wherein each of the keyholes 23E is a through hole that communicates with the post cavity 210. It is worth mentioning that the outer first post walls 2111E, 2211E and the outer second post walls 2121E, 2221E of the upper and lower post members 21E, 22E are flat and smooth surfaces, wherein no hole is formed thereon. Therefore, the keyholes 23E are protected and hidden by outer first post walls 2111E, 2211E and the outer second post walls 2121E, 2221E of the upper and lower post members 21E, 22E.

Each of the upper and lower post members 21E, 22E further comprises a plurality of keyhole guiders 233E integrally and inwardly protruded from the upper hole portions 231E of the keyholes 23E respectively. In particular, each of the keyhole guiders 233E has two side ends integrally extended from two side edges of the upper hole portion 231E of the keyhole 23E to partially cover the upper hole portion 231E of each of the keyholes 23E at the post members 21E, 22E while the lower hole portion 232E of each of the keyholes 23E is uncovered. In order to form the keyhole guider 233E, each of the upper and lower post members 21E, 22E is punched at the inner side thereof via a punching machine to bend the keyhole guiders 233E into the post cavity 210E of each of the upper and the lower post members 21E, 22E.

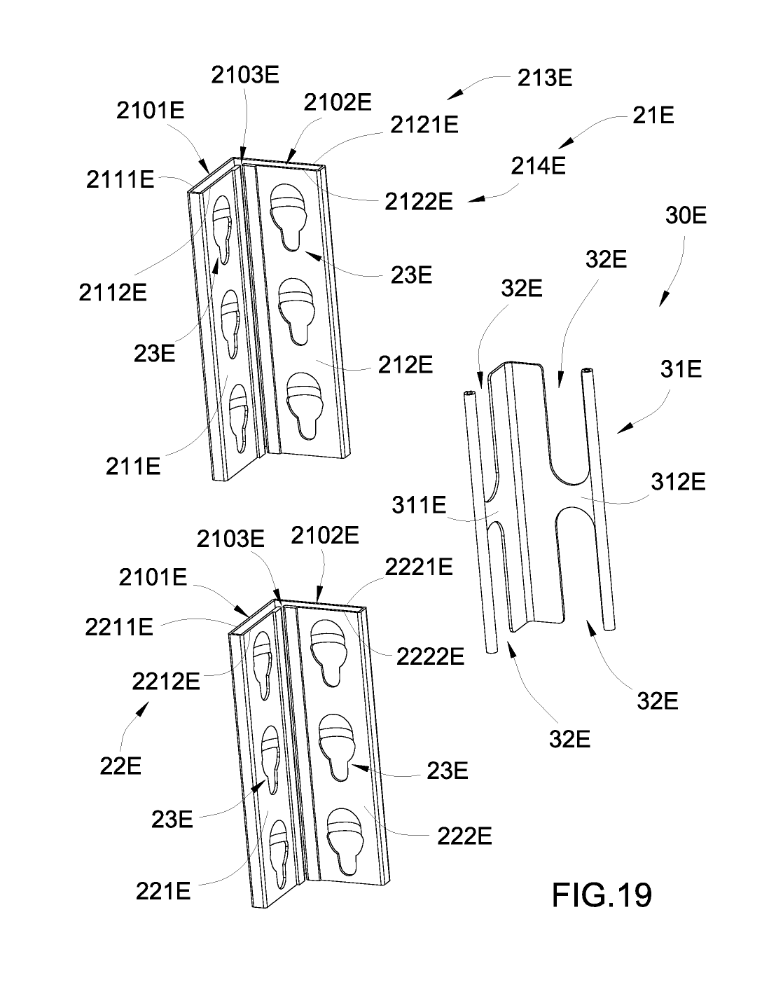

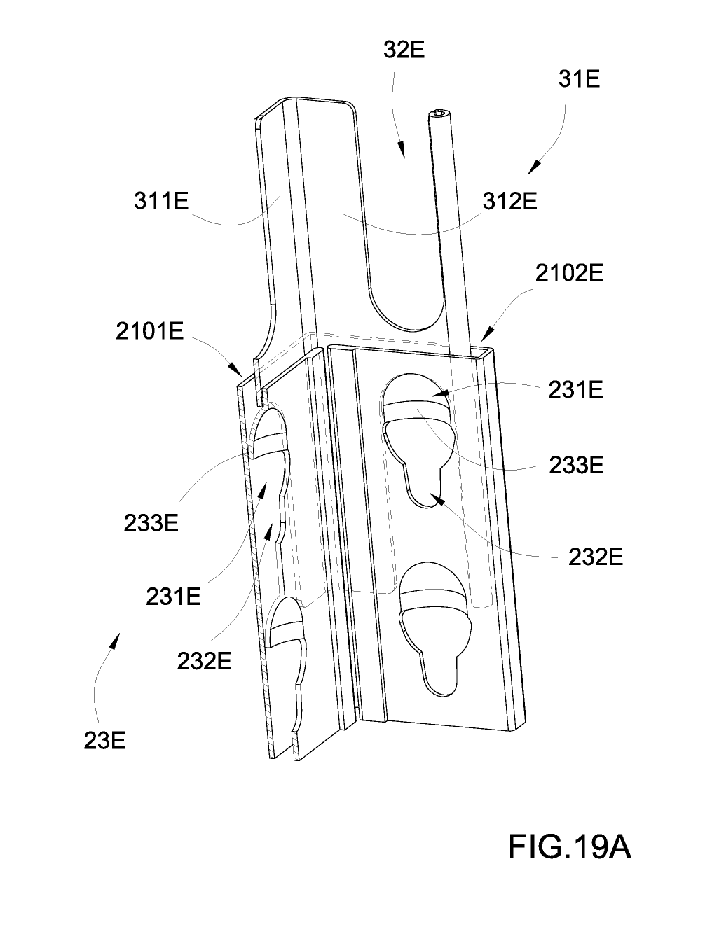

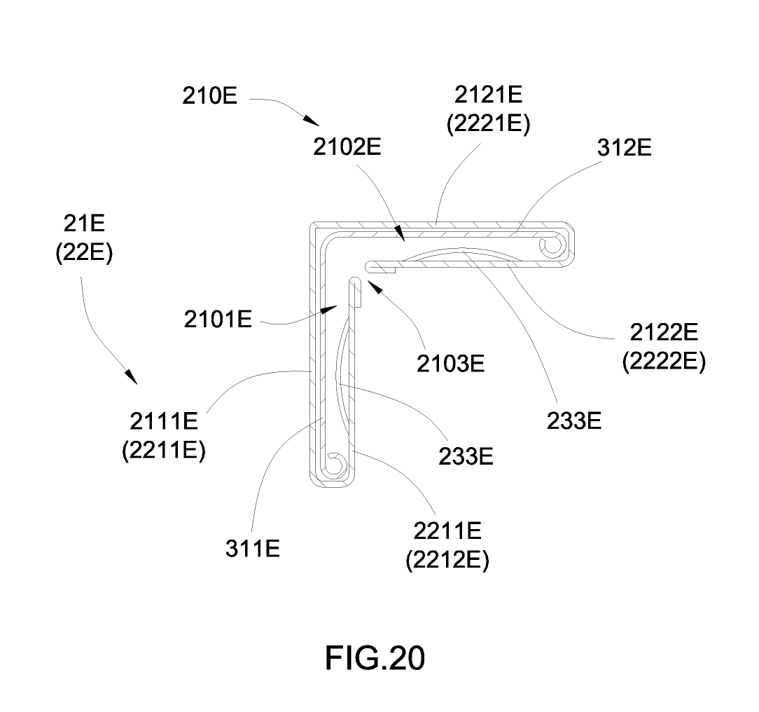

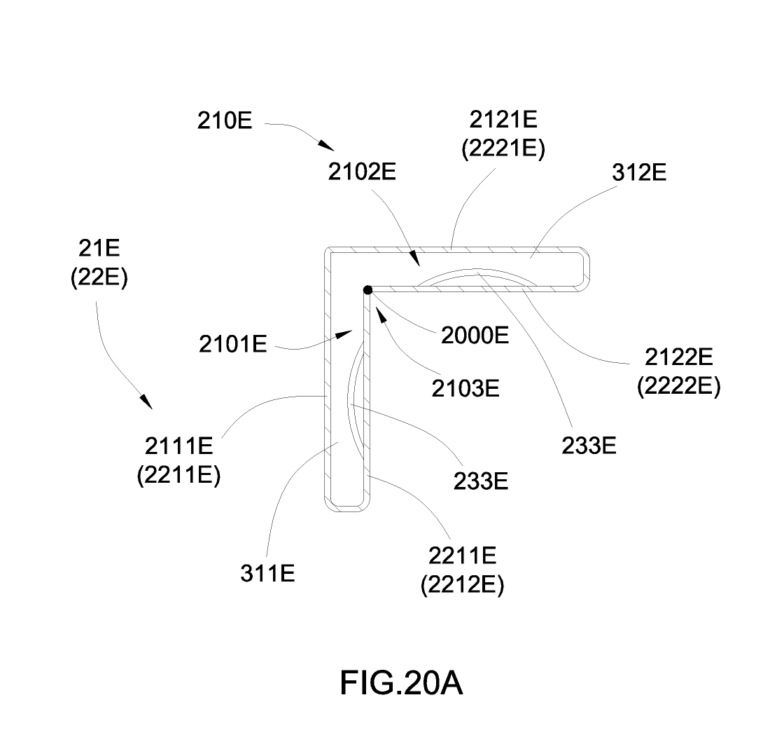

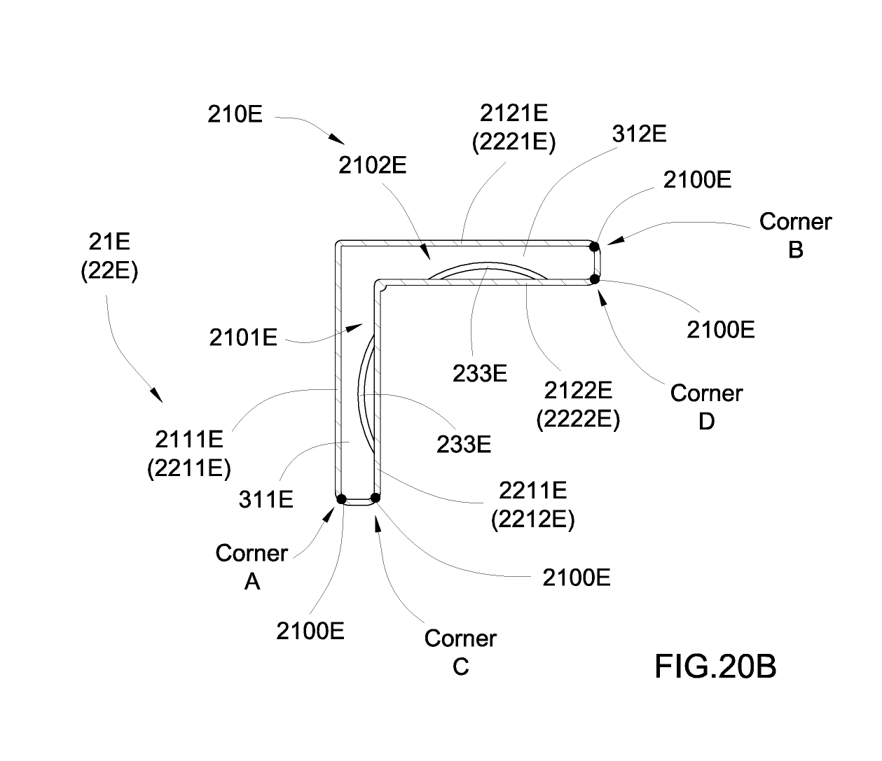

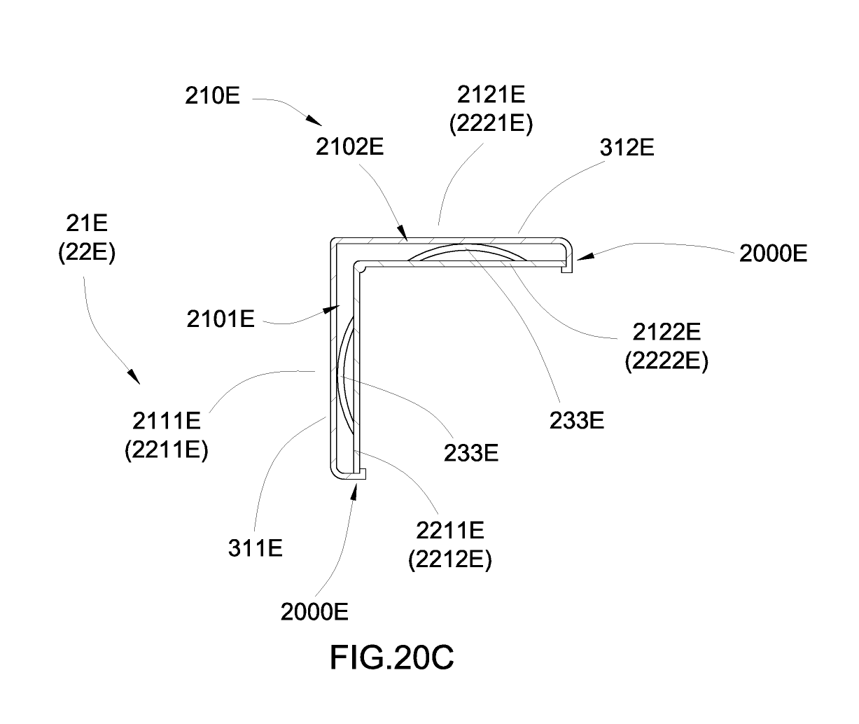

As shown in FIGS. 19 and 20, the post joint 30E comprises an engaging tongue 31E extended into interiors of the end portion of the upper post member 21E and the end portion of the lower post member 22E. In particular, the engaging tongue 31E is slidably extended into the post cavities 210E of the upper and lower post members 21E, 22E to interlock and couple the upper and lower members 21E, 22E with each other end-to-end. An upper portion of the engaging tongue 31E is slidably inserted into the post cavity 210E of the upper post member 21E and a lower portion of the engaging tongue 31E is slidably inserted into the post cavity 210E of the lower post member 22E.

In particular, the engaging tongue 31E comprises a first tongue member 311E and a second tongue member 312E extended from the first tongue member 311E at an angle matching with the angle between the first post wall 211E, 221E and the second post wall 212E, 222E. The engaging tongue 31E is made by a metal sheet defining two portions being bent at an angle matching with the angle between the first post wall 211E, 221E and the second post wall 212E, 222E. In other words, the first and second tongue members 311E, 312E are slidably inserted into the interiors of the first and second post walls 211E, 221E, 212E, 222E of each of the upper and lower post members 21E, 22E.

The first tongue member 311E is slidably inserted into the first post cavities 2101E of the upper and lower post members 21E, 22E and the second tongue member 312E is sldiably inserted into the second post cavities 2102E of the upper and lower post members 21E, 22E. In other words, the upper portions of the first and second tongue members 311E, 312E are slidably inserted into the first and second post cavities 2101E, 2102E of the upper post member 21E respectively. The lower portions of the first and second tongue members 311E, 312E are slidably inserted into the first and second post cavities 2101E, 2102E of the lower post member 22E respectively. Two outer edges of the engaging tongue 31E are two folding edges that form the reinforcing ribs to reinforce the structure of the engaging tongue 31E to prevent any twisting movement of torque created thereat. It is worth mentioning that the longitudinal gap 2103E enables the slightly expansion of the post cavity 210E. In addition, the folding edges of the engaging tongue 31E will increase the thickness of the post joint 30E to match with the post cavity 210E. Preferably, the thickness of the folding edge of the engaging tongue 31E is smaller than a width of the post cavity 210E. Since the keyhole guiders 233E into the post cavity 210E, the folding edges of the engaging tongue 31E will ensure the engaging tongue 31E not being blocked by the keyhole guiders 233E when the engaging tongue 31E is inserted into the post cavity 210E.

The post joint 30E further has a plurality of guiding slots 32E formed at the engaging tongue 31E to align with the keyholes 23E when the engaging tongue 31E is slidably inserted into the upper and lower post members 21E, 22E. In one embodiment, four guiding slots 32E are formed at the engaging tongue 31E, as shown in FIG. 19. Two of the guiding slots 32E are formed at the first tongue member 311E and two of the guiding slots 32E are formed at the second tongue member 312E. One of the guiding slots 32E is extended from an upper edge of the first tongue member 311E and the other guiding slot 32E is extended from a bottom edge of the first tongue member 311E. Likewise, one of the guiding slots 32E is extended from an upper edge of the second tongue member 312E and the other guiding slot 32E is extended from a bottom edge of the second tongue member 312E. It is worth mentioning that a width of each of the guiding slots 32E is equal to or larger than a diameter size of the upper hole portion 231E of the keyhole 23E.

Therefore, when the upper portions of the first and second tongue members 311E, 312E are slidably inserted into the first and second post cavities 2101E, 2102E of the upper post member 21E respectively, the guiding slots 32E at the first and second tongue members 311E, 312E will align with the keyholes 23E at the bottommost position of the upper post member 21E respectively. When the lower portions of the first and second tongue members 311E, 312E are slidably inserted into the first and second post cavities 2101E, 2102E of the lower post member 22E respectively, the guiding slots 32E at the lower portions of the first and second tongue members 311E, 312E will align with the keyholes 23E at the uppermost position of the lower post member 21E respectively.

It is worth mentioning when the first and second tongue members 311E, 312E are slidably inserted into the upper post member 21E and the lower post member 22E, the guiding slots 32E at the first and second tongue members 311E, 312E can align with two or more keyholes 23E at each of the upper post member 21E and the lower post member 22E. As shown in FIG. 19A, when the lower portions of the first and second tongue members 311E, 312E are slidably inserted into the first and second post cavities 2101E, 2102E of the lower post member 22E respectively, the guiding slots 32E at the lower portions of the first and second tongue members 311E, 312E will align with two of the keyholes 23E at the uppermost position of the lower post member 21E respectively. In particular, the top edge of the guiding slot 32E will rest on the keyhole guider 233E at the uppermost position of the lower post member 21E. Likewise, when the upper portions of the first and second tongue members 311E, 312E are slidably inserted into the first and second post cavities 2101E, 2102E of the upper post member 21E respectively, the keyhole guiders 233E at the bottommost position of the upper post member 21E respectively will rest on the bottom edges of the guiding slots 32E at the upper portions of the first and second tongue members 311E, 312E.

It is appreciated that three post members are detachably coupled with each other end-to-end via two post joints 30E. In other words, the height of post 20E the shelving apparatus can be selectively adjusted by adding an additional post member on the upper post member 21E via the post joint 30E to increase the height of the shelving apparatus or by detaching the additional post member from the upper post member 21E to reduce the height of the shelving apparatus.

FIG. 20A illustrates an alternative mode of each of the first and second post members 21E, 22E. As it is mentioned above, the longitudinal gaps 2103E are formed between two inner edges of the inner first post wall 2112E, 2212E and the inner second post wall 2122E, 2222E to communicate with the post cavity 201E of the upper post member 21E and the lower post member 22E. It is appreciated that the longitudinal gaps 2103E of the upper and lower post members 21E, 22E can be sealed and closed. As shown in FIG. 20A, the longitudinal gaps 2103E of the upper and lower post members 21E, 22E are sealed and closed by welding, such that a welding line 2100E is formed between the inner edges of the inner first post wall 2112E, 2212E and the inner second post wall 2122E, 2222E.

It is appreciated that the longitudinal gap 2103E can be selectively formed at any corner of the upper and lower post members 21E, 22E depending the folding process of the upper and lower post members 21E, 22E, such that the welding line 2100E can be formed to seal and close the longitudinal gap 2103E. In one embodiment, the welding line 2100E can be formed at any one of the corner A, corner B, corner C, and/or corner D as shown in FIG. 20B. For example, when two welding lines 2100E are formed at the corner A and corner B respectively, the outer first post wall 2111E, 2211E and the outer second post wall 2121E, 2221E will coupled to the inner first post wall 2112E, 2212E and the inner second post wall 2122E, 2222E respectively. Likewise, when two welding lines 2100E are formed at the corner C and corner D respectively, the outer first post wall 2111E, 2211E and the outer second post wall 2121E, 2221E will also coupled to the inner first post wall 2112E, 2212E and the inner second post wall 2122E, 2222E respectively.

FIG. 20C illustrates another alternative mode of each of the first and second post members 21E, 22E, wherein the outer first post wall 2111E, 2211E and the outer second post wall 2121E, 2221E are detachably coupled to the inner first post wall 2112E, 2212E and the inner second post wall 2122E, 2222E respectively. In particular, the outer first post wall 2111E, 2211E and the outer second post wall 2121E, 2221E serves as a post cover to cover the inner first post wall 2112E, 2212E and the inner second post wall 2122E, 2222E respectively. For example, each of the outer first post wall 2111E, 2211E and the outer second post wall 2121E, 2221E has an edge connector 2000E to engage with an outer edge of each of the inner first post wall 2112E, 2212E and the inner second post wall 2122E, 2222E. It is worth mentioning that the outer first post wall 2111E, 2211E and the outer second post wall 2121E, 2221E can be made of different materials from the inner first post wall 2112E, 2212E and the inner second post wall 2122E, 2222E. For example the outer first post wall 2111E, 2211E and the outer second post wall 2121E, 2221E can be made of plastic and the inner first post wall 2112E, 2212E and the inner second post wall 2122E, 2222E can be made of metal.

The supporting frame 10E has the same structure of the above second embodiment, wherein the supporting frame 10E is detachably coupling with the posts 20E to form the shelving apparatus, wherein the supporting frame 10E comprises one or more shelf supporting beam configurations.

Each of the shelf supporting beam configurations comprises a shelf platform 11E, a plurality of shelf retaining members 12E and a shelf supporting arrangement 13E, wherein the shelf retaining members 12E are each detachably coupled with two of the posts 20E to form a boundary frame to support the shelf platform 11E therewithin.

Each of the shelf retaining members 12E has two coupling ends 120E arranged detachably coupling with two of the posts 20E in the unfolded condition, and first and second longitudinal edges 121E, 122E extended between the two coupling ends 120E, wherein the shelf supporting arrangement 13E is integrally extended from each of the shelf retaining members 12E between the first and second longitudinal edges 121E, 122E to support the shelf platform 11E within the boundary frame.

Having the same structural configuration of the second embodiment, two fasteners 123E are provided at each coupling end 120E of the shelf retaining member 12E to engage with two keyholes 23E of the corresponding post 20E. In particular, two fastener holes are formed at each coupling end of the shelf retaining member 12E, wherein the two fasteners 123E are affixed to the shelf retaining member 12E via the fastener holes respectively. Accordingly, each of the fasteners 123E is riveted to the respective coupling end 120E of the shelf retaining member 12E and has a neck 1232E and a head 1231E having a size larger than the lower hold portion 232E and slightly smaller than the upper hole portion 231E so as to fittingly inserted through the upper hole portion 231E and to slide into the lower hole portion 232E of the corresponding keyhole 23E from the upper hole portion 231E, so as to securely couple the shelf retaining member 12E at the upper or lower post member 21E, 22E of the post 20E.

It is worth mentioning that the shelf retaining member 12E can be configured to have the same structural configuration of the first embodiment. It is worth mentioning that the head 1231E of the fastener 123E is inserted through the upper hole portion 231E of the keyhole 23E, the keyhole guider 233E will guide the head 1231E of the fastener 123E to prevent the head 1231E of the fastener 123E not to over insert into post cavity 210E, so as to ensure the head 1231E of the fastener 123E to slide into the lower hole portion 232E of the corresponding keyhole 23E from the upper hole portion 231E.

It is worth mentioning that when the engaging tongue 31E is inserted into the upper and lower post members 21E, 22E to couple the upper and lower post members 21E, 22E end-to-end, the fastener 123E is inserted into the post cavity 210E through the keyhole 23E and is also inserted through the guiding slot 32E of the post joint 30E.

The shelf platform 11E also has the similar structural configuration of the second embodiment, wherein the shelf platform 11E has a base panel 112E and a surrounding edge 111E defining a cavity within the surrounding edge 111E and the base panel 112E, as shown in FIG. 17A. Accordingly, the surrounding edge 111E comprises a plurality of boundary loops 1111E, each having a U-shaped configuration, extended from the base panel 112E. In one embodiment, the boundary loops 1111E are spacedly extended from two longitudinal edge portions of the base panel 112E respectively.

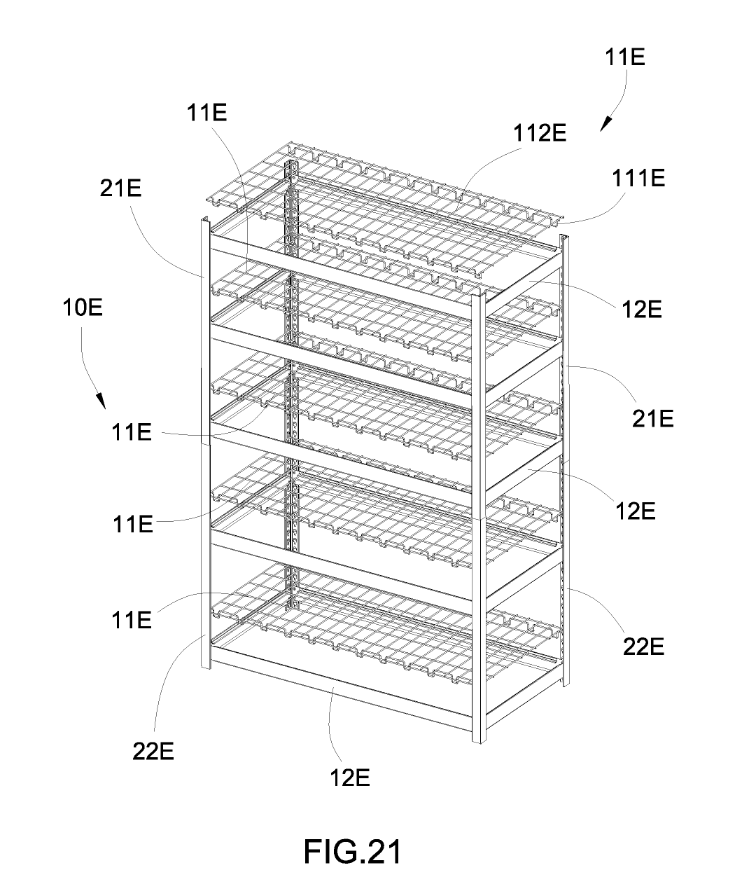

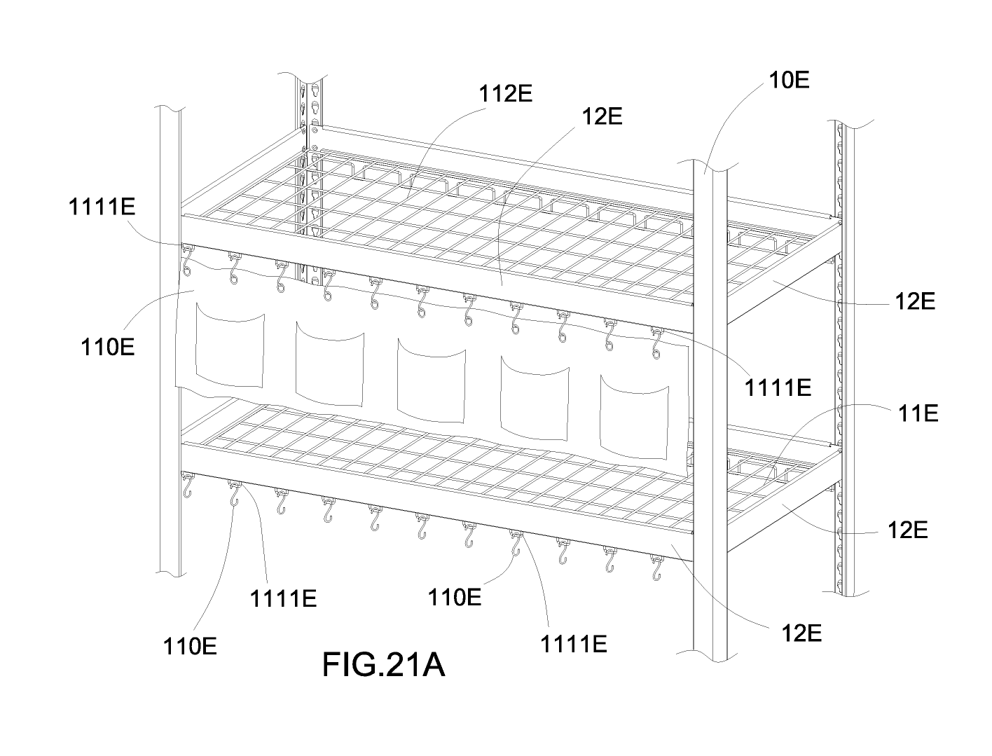

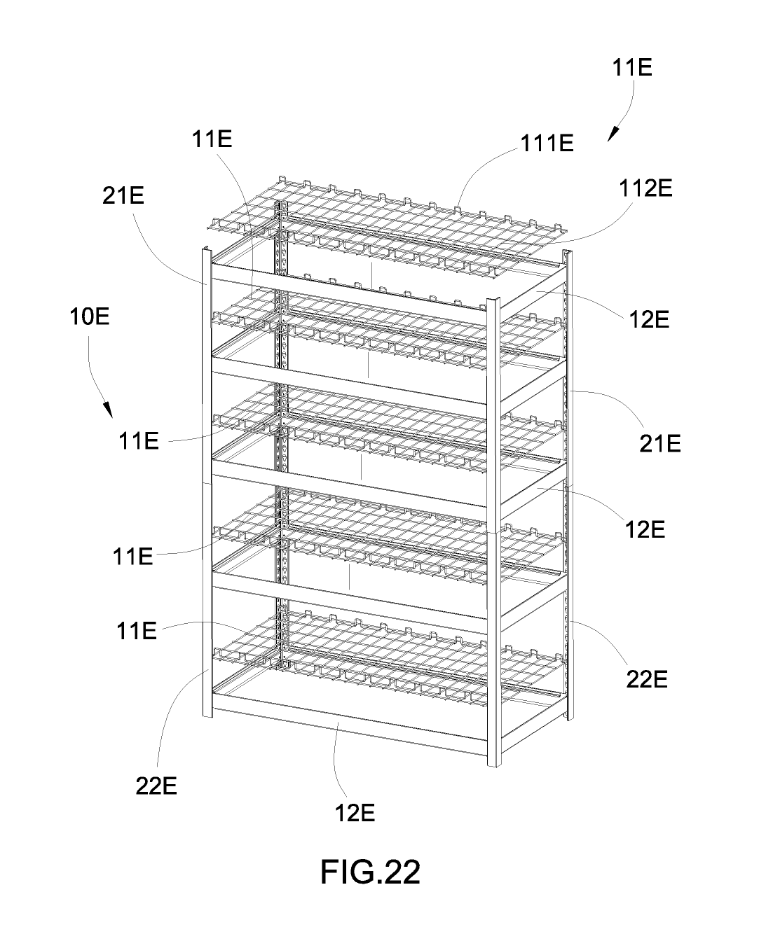

The shelf platform 11E is able to be selectively supported by the shelf supporting arrangement 13E of the respective shelf supporting beam configuration with the surrounding edge 111E located below the base panel 112E and the cavity facing downward, as shown in FIG. 21, or the surrounding edge 111E located above the base panel 112E and the cavity facing upward as shown in FIG. 22. Accordingly, when the cavity of the shelf platform 11E faces downward, the boundary loops 1111E are downwardly extended from the base panel 112E. When the cavity of the shelf platform 11E faces upwardly, the boundary loops 1111E are upwardly extended from the base panel 112E.

It is worth mentioning that when the boundary loops 1111E are downwardly extended from the base panel 112E, the boundary loops 1111E are extended to the lower level of the shelving space. Accordingly, the objects can be placed on and supported by the base panel 112E at the lower level. Therefore, the upper space of the base panel 112E at the lower level will not be occupied. Via the boundary loops 1111E, a hanging element 110E, such as a hanging pocket or a hanging hook, can be hung at the boundary loops 1111E of the base panel 112E at the upper level to fully utility the upper space of the base panel 112E at the lower level, as shown in FIG. 21A. Therefore, the upper space and the lower space of each of the shelving space will be fully occupied.

The shelf supporting arrangement 13E comprises a top beam wall 131E integrally and horizontally extended from the upper edge of the vertical beam wall 124E to define a supporting surface 132E on the top beam wall 131E close to the first longitudinal edge 121E of the shelf retaining member 12E. The supporting surface 132E is an elongated flat surface to support the shelf platform 11E. Furthermore, a free edge of the top beam wall 131E is also a folded edge that the free edge of the top beam wall 131E is downwardly folded on a bottom side of the top beam wall 131E. Accordingly, the free edge of the top beam wall 131E has a circular cross sectional configuration, as shown in FIG. 18.

The shelf supporting arrangement 13E further has a longitudinal reinforcing rib 133E integrally extended between the first longitudinal edge 121E of the shelf retaining member 12E and the top beam wall 131E. Accordingly, the longitudinal reinforcing rib 133E has a curved or arc-shaped cross sectional configuration that the longitudinal reinforcing rib 133E is extended between the upper edge of the vertical beam wall 124E and the top beam wall 131E. It is worth mentioning that the second longitudinal edge 122E of the shelf retaining member 12E, the free end of the top beam wall 131E, and the longitudinal reinforcing rib 133E is formed in curved cross sectional configuration to reinforce the structure of the shelf retaining member 12E to prevent any twisting movement or torque created thereat. In other words, when the downward loading force is applied on the supporting surface 132E of the top beam wall 131E, the longitudinal reinforcing rib 133E will prevent any twisting movement of the top beam wall 131E and will evenly transfer the downward loading force to the vertical beam wall 124E. Since the vertical beam wall 124E is coupled between two posts 20E, the downward loading force will then transfer to the posts 20E via the vertical beam wall 124E so as to prevent any twisting movement of the vertical beam wall 124E.

Furthermore, the shelf retaining member 12E is coupled between two of the posts 20E in a revisable manner to selectively adjust the horizontal level of the supporting surface 132E. In one embodiment, the shelf retaining member 12E is coupled between two of the posts 20E at a position that the first longitudinal edge 121E is above the second longitudinal edge 122E, such that the supporting surface 132E is elevated toward the first longitudinal edge 121E. In another embodiment, the shelf retaining member 12E is coupled between two of the posts 20E at a position that the first longitudinal edge 121E is below the second longitudinal edge 122E, such that the supporting surface 132E is dropped toward the first longitudinal edge 121E. In other words, by selectively configuring the shelf retaining member 12E in a revisable manner and the shelf platform 11E in a revisable manner, different combinations of the shelf retaining member 12E and the shelf platform 11E are provided to selectively adjust the shelving space within the shelf retaining members 12E and above the shelf platform 11E.

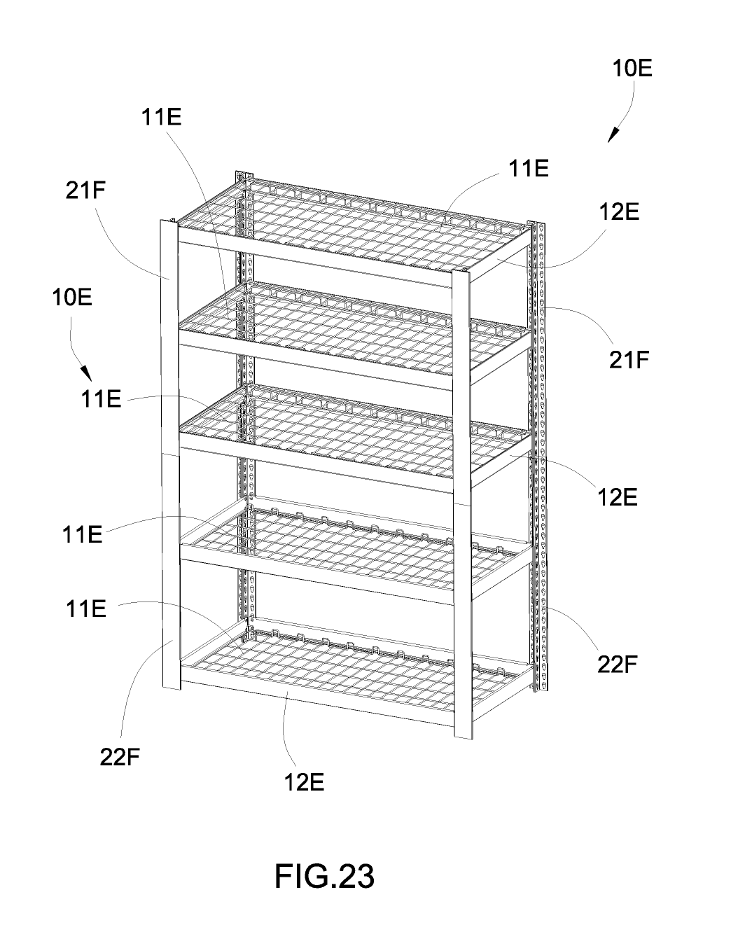

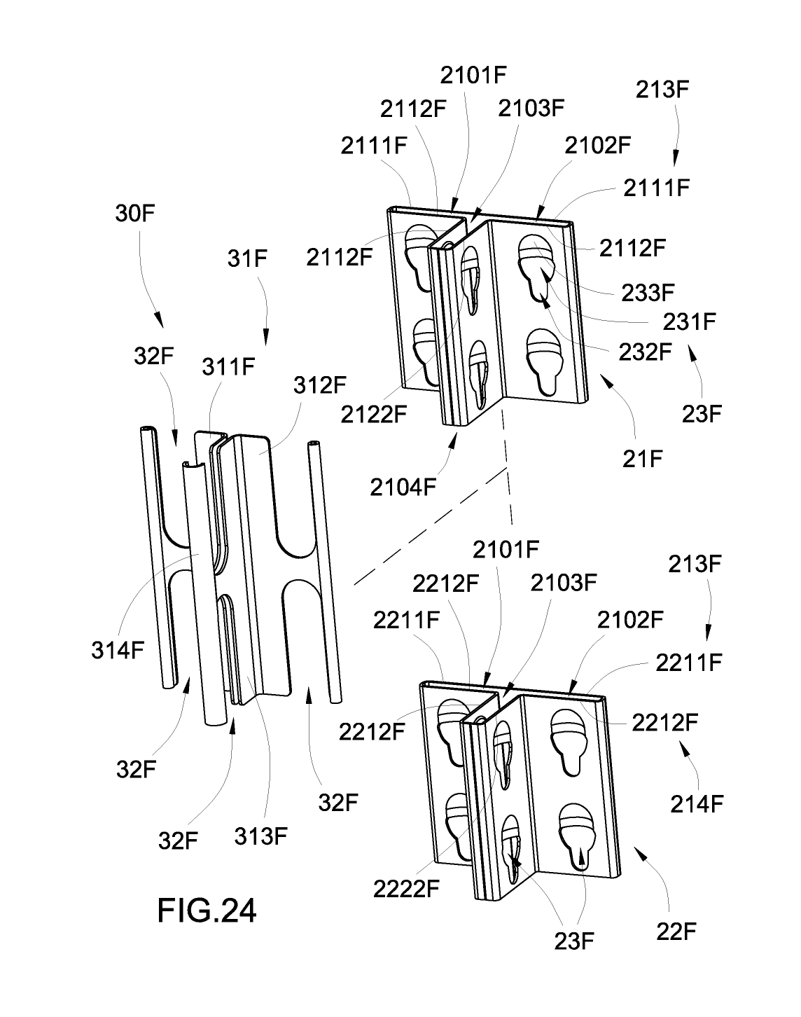

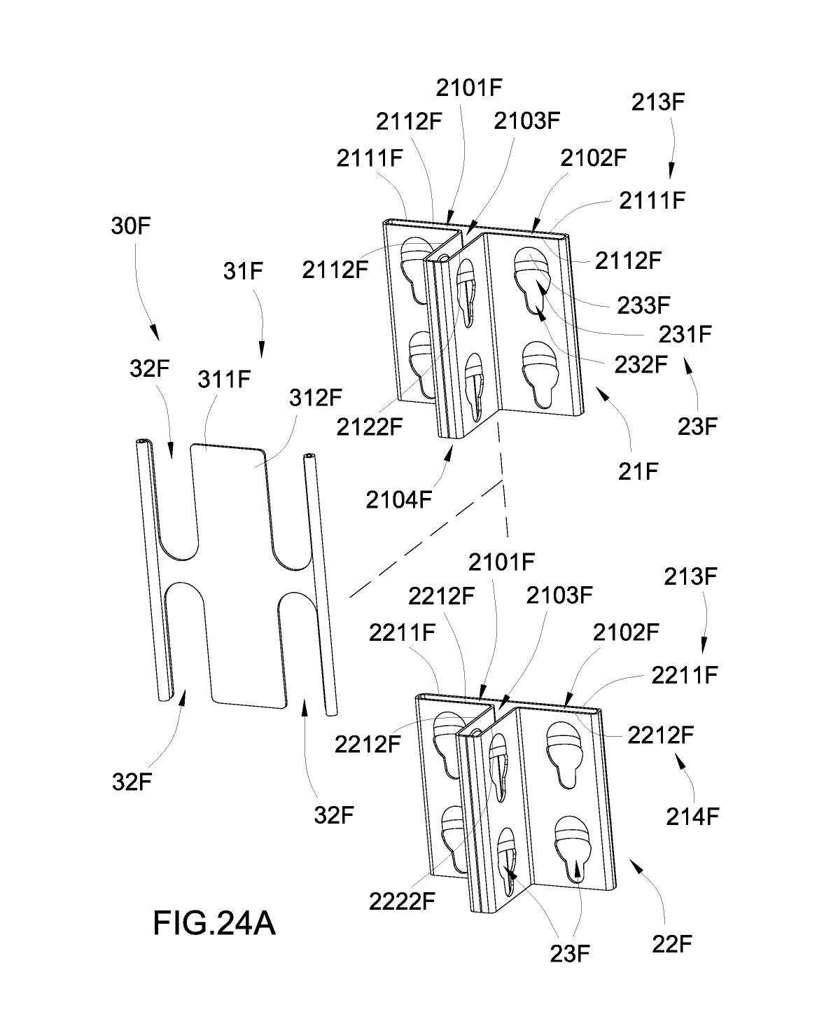

As shown in FIGS. 23 and 24, the post 20F according to the fourth embodiment illustrates a modification of the third embodiment, wherein the post 20F which has a T-shaped configuration. Accordingly, each of the posts 20F comprises at least an upper post member 21F, at least a lower post member 22F, and at least a post joint 30F connecting the upper and lower post members 21F, 22F to form the respective post such that the upper and lower post members 21F, 22F are capable of being coupled and extended rigidly in an end-to-end and vertically oriented manner and being detached with each other.

Each of the upper and lower post members 21F, 22F has a first post wall 211F, 221F and a second post wall 212F, 222F extended from the first post wall 211F, 221F at an angle. Preferably, the second post wall 212F, 222F is perpendicularly extended from the first post wall 211F, 221F. In particular, each of the upper and lower post members 21F, 22F comprises an outer wall shell 213F and an inner wall shell 214F spacedly overlapped on the outer wall shell 213F to define a post cavity 210F between the outer wall shell 213F and the inner wall shell 214F.

Therefore, the first post wall 211F, 221F forms a double wall structure to have an outer first post wall 2111F, 2211F and two inner first post walls 2112F, 2212F. The second post wall 212F, 222F also forms a double wall structure to have two inner second post walls 2121F, 2221F, 2122F, 2222F. It is worth mentioning that the post cavity 210F is divided into a first post cavity 2101F, a second post cavity 2102F, and a third post cavity 2103F, wherein the first, second, and third post cavities 2101F, 2012F, 2013F are communicated with each other.

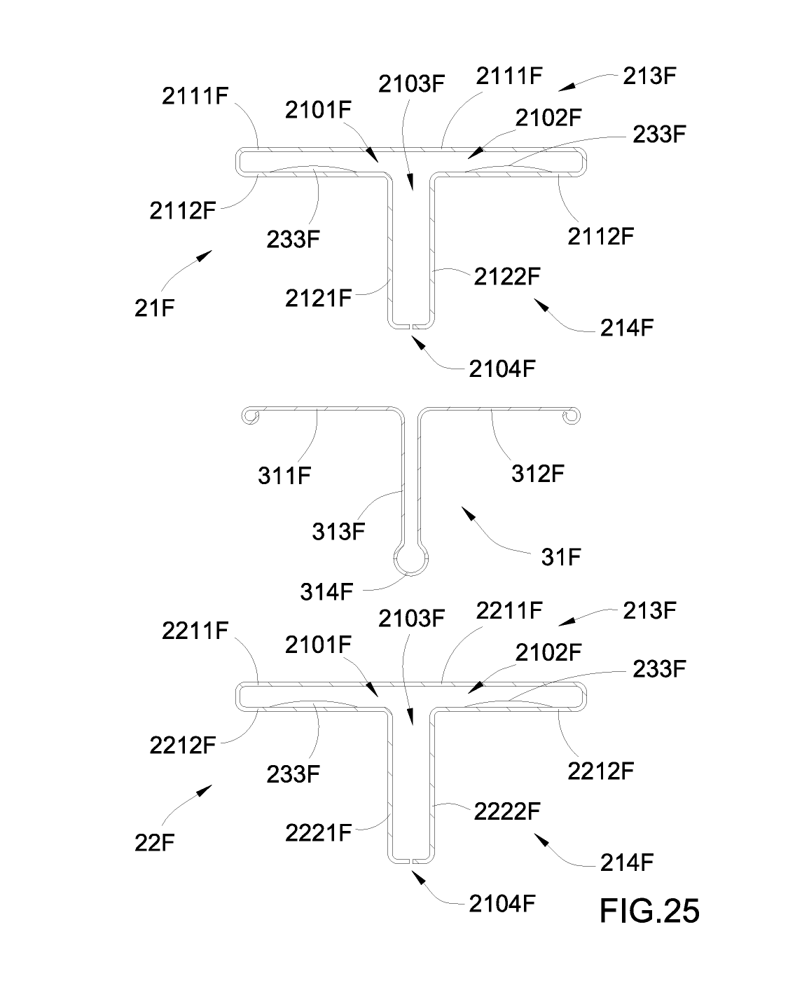

As shown in FIGS. 24 and 25, the outer wall shell 213F of the upper post member 21E is constructed to have the outer first post wall 2111F. The inner wall shell 214F of the upper post member 21E is constructed to have two inner first post walls 2112F and two inner second post walls 2121F, 2122F. Two outer edges of the outer first post wall 2111F are integrally extended from two outer edges of the inner first post walls 2112F. Two inner edges of the inner first post wall 2112F are integrally extended from two inner edges of the inner second post walls 2121F, 2122F. At the upper post member 21F, the first post cavity 2101F is formed between the outer first post wall 2111F and one of the inner first post walls 2112F, the second post cavity 2102F is formed between the outer first post wall 2111F and another inner first post wall 2112F, and the third post cavity 2103F is formed between the inner second post walls 2121F, 2122F.

As shown in FIGS. 24 and 25, the outer wall shell 213F of the lower post member 22E is constructed to have the outer first post wall 2211F. The inner wall shell 214F of the lower post member 22E is constructed to have two inner first post wall 2212F and two inner second post wall 2221F, 2222F. Two outer edges of the outer first post wall 2211F are integrally extended from two outer edges of the inner first post wall 2212F. Two inner edges of the inner first post wall 2212F are integrally extended from two inner edges of the inner second post wall 2221F, 2222F. At the lower post member 22F, the first post cavity 2101F is formed between the outer first post wall 2211F and one of the inner first post walls 2212F, the second post cavity 2102F is formed between the outer first post wall 2211F and another inner first post wall 2212F, and the third post cavity 2103F is formed between the inner second post walls 2221F, 2222F.

Each of the upper and lower post members 21F, 22F is made of metal sheet, wherein the metal sheet is divided into five transverse portions, i.e. two outer transverse portions, two intermediate transverse portions and a mid-transverse portion. The intermediate transverse portions are defined between the mid-transverse portion and the outer transverse portions. The two intermediate transverse portions of the metal sheet are inwardly folded on the mid-transverse portion, and the outer transverse portions are bent at the intermediate transverse portions at an angle, preferably right angle.

At the upper post member 21F, the mid-transverse portion of the metal sheet forms the outer first post wall 2111F, the two intermediate transverse portions form the inner first post walls 2112F respectively, and the outer transverse portions forms the inner second post walls 2121F, 2122F. It is worth mentioning that two outer edges of the metal sheet are outwardly folded to form two folding edges thereof, wherein a longitudinal gap 2104F is formed between the two folding edges of the metal sheet. In other words, the longitudinal gap 2104F is formed between two outer edges of the inner second post walls 2121F, 2122F to communicate with the post cavity 201F, especially the third post cavity 2013F, of the upper post member 21F.

At the lower post member 22F, the mid-transverse portion of the metal sheet forms the outer first post wall 2211F, the two intermediate transverse portions form the inner first post walls 2212F respectively, and the outer transverse portions forms the inner second post walls 2221F, 2222F. It is worth mentioning that two outer edges of the metal sheet are also outwardly folded to form two folding edges thereof, wherein the longitudinal gap 2104F is formed between the two folding edges of the metal sheet. In other words, the longitudinal gap 2104F is also formed between two outer edges of the inner second post walls 2221F, 2222F to communicate with the post cavity 201F, especially the third post cavity 2013F, of the lower post member 22F. Accordingly, the folding edges of the metal sheet forms the reinforcing ribs to reinforce the structure of the upper and lower post members 21F, 22F to prevent any twisting movement of torque created thereat.

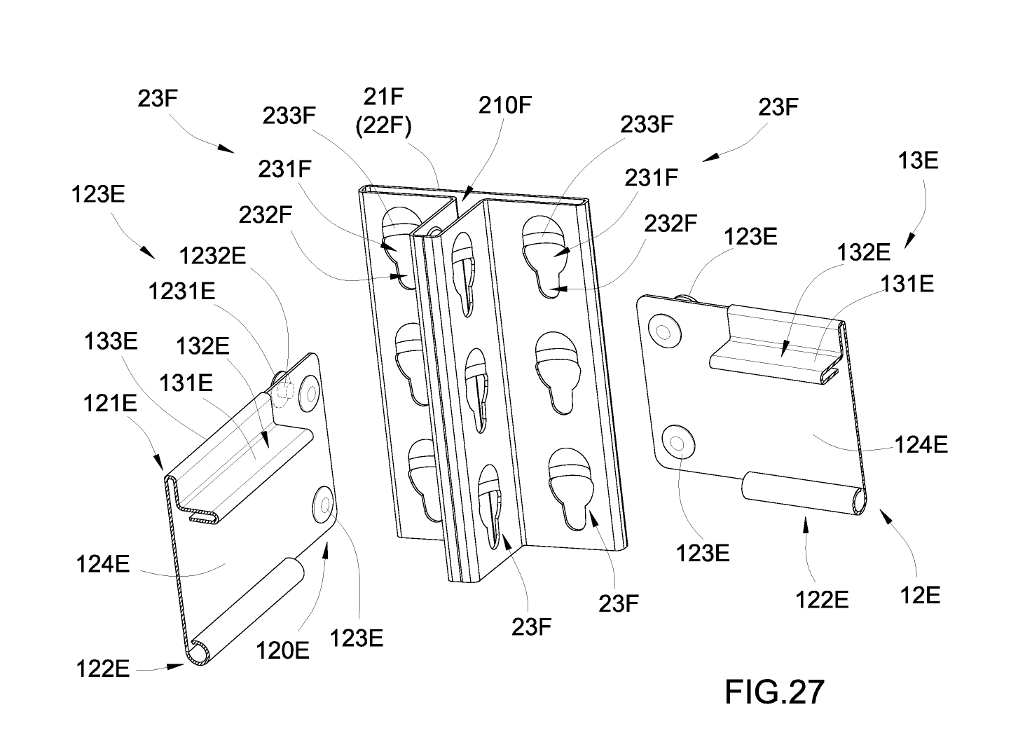

As shown in FIG. 27, a plurality of keyholes 23F are alignedly formed on the first post wall 211F, 221F and the second post wall 212F, 222F of each of the upper and lower post members 21F, 22F. Each of the keyholes 23F has an upper hole portion 231F and a lower hole portion 232F, wherein a size of the upper hole portion 231F is larger than a size of the lower hole portion 232F.

In particular, the keyholes 23F are alignedly formed on the inner first post walls 2112F and the inner second post walls 2121F, 2122F of the upper member 21F and on the inner first post walls 2212F and the inner second post walls 2221F, 2222F of the lower member 22F, wherein each of the keyholes 23F is a through hole that communicates with the post cavity 210F. It is worth mentioning that the outer first post walls 2111F, 2211F of the upper and lower post members 21F, 22F are flat and smooth surfaces, wherein no hole is formed thereon. Therefore, the keyholes 23F are protected and hidden by outer first post walls 2111F, 2211F of the upper and lower post members 21F, 22F.

Likewise, each of the upper and lower post members 21F, 22F further comprises a plurality of keyhole guiders 233F integrally and inwardly protruded from the upper hole portions 231F of the keyholes 23F respectively. In particular, each of the keyhole guiders 233F has two side ends integrally extended from two side edges of the upper hole portion 231F of the keyhole 23F to partially cover the upper hole portion 231F of each of the keyholes 23F at the post members 21F, 22F while the lower hole portion 232E of each of the keyholes 23F is uncovered. In order to form the keyhole guider 233E, each of the upper and lower post members 21F, 22F is punched at the inner side thereof via a punching machine to bend the keyhole guiders 233F into the post cavity 210F of each of the upper and the lower post members 21F, 22F.

Accordingly, the shelf retaining members 12E of the supporting frame 10E can be detachably coupled at the posts 20F by inserting the fasteners 123E of the shelf retaining members 12E into the keyholes 23F. Therefore, the keyhole guider 233F will guide the head 1231E of the fastener 123E to prevent the head 1231E of the fastener 123E not to over insert into post cavity 210F, so as to ensure the head 1231E of the fastener 123E to slide into the lower hole portion 232F of the corresponding keyhole 23F from the upper hole portion 231F.

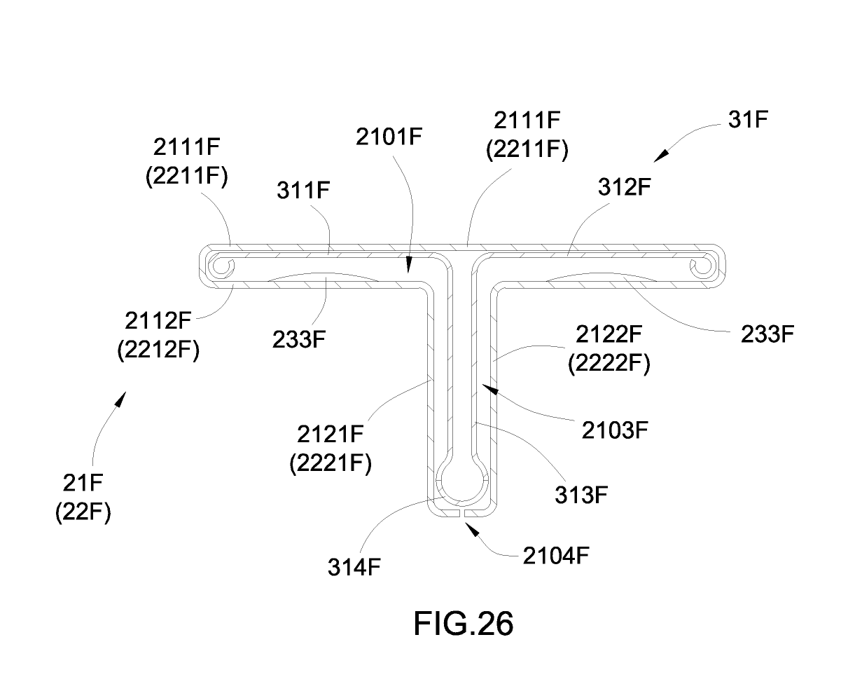

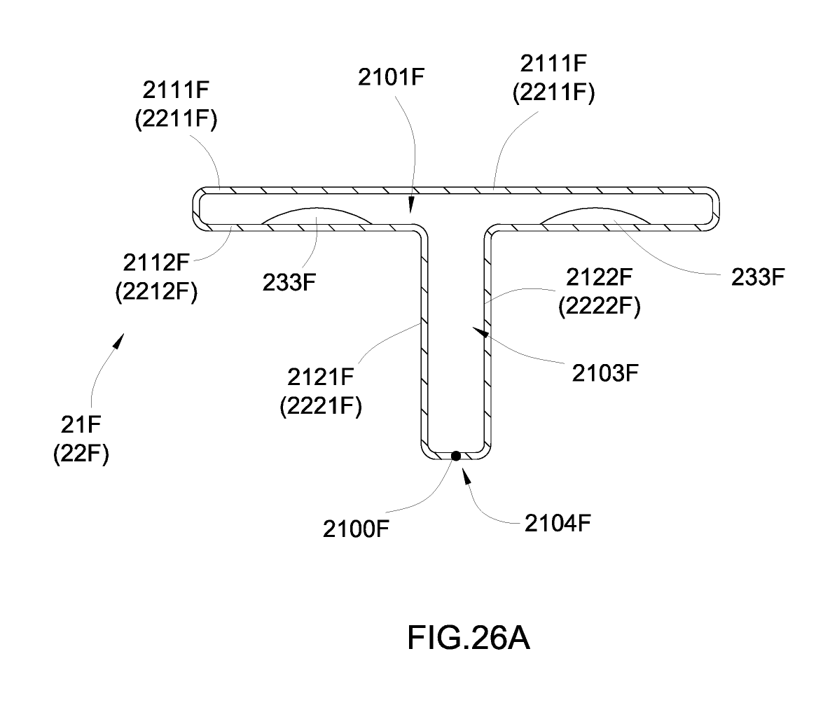

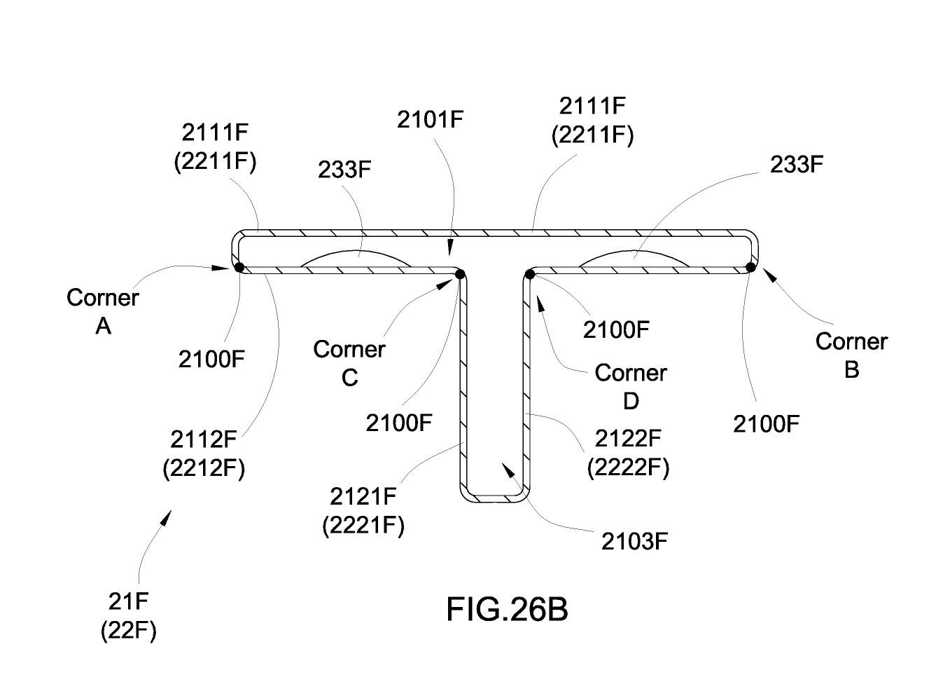

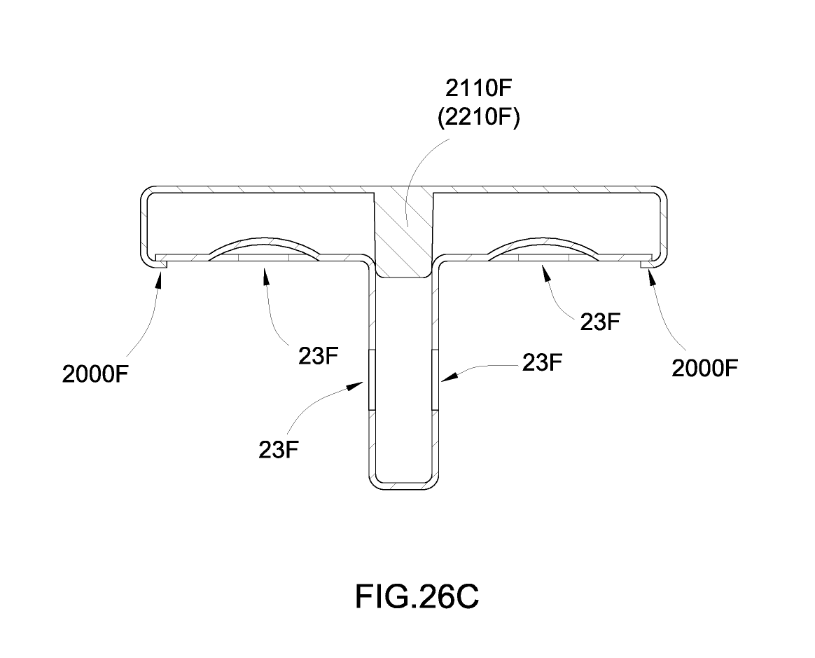

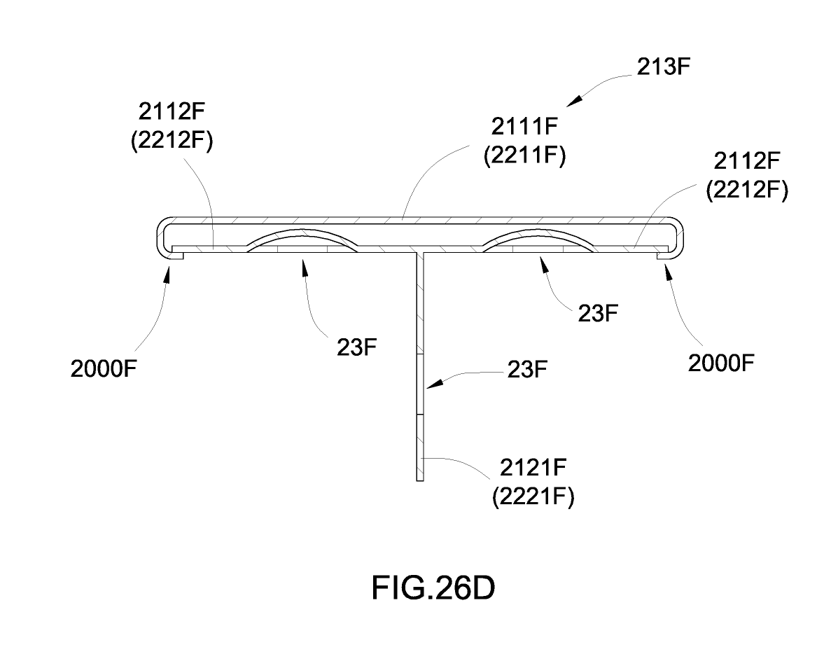

As shown in FIGS. 24 and 26, the post joint 30F comprises an engaging tongue 31F slidably extended into the post cavities 210F of the upper and lower post members 21F, 22F to interlock and couple the upper and lower members 21F, 22F with each other end-to-end. An upper portion of the engaging tongue 31F is slidably inserted into the post cavity 210F of the upper post member 21F and a lower portion of the engaging tongue 31F is slidably inserted into the post cavity 210F of the lower post member 22F.

In particular, the engaging tongue 31F comprises a first tongue member 311F, a second tongue member 312F extended from the first tongue member 311F, and a third tongue member 313F extended between the first and second tongue members 311F, 312F at an angle. A cross section of the engaging tongue 31F matches with a cross section of the post 20F. Accordingly, the engaging tongue 31F has a T-shaped configuration matching with the upper and lower post members 21F, 22F. Therefore, the first tongue member 311F and the second tongue member 312F are extended at the same planar direction, and the third tongue member 313F is perpendicularly extended between the first tongue member 311F and the second tongue member 312F.

As shown in FIG. 26, the engaging tongue 31F is made by a metal sheet defining four transverse portions, i.e. two outer transverse portions and two inner transverse portions. The inner transverse portions of the metal sheets are overlappedly folded and the outer transverse portions of the metal sheets are bent from the inner transverse portions at an angle, preferably right angle. In other words, the outer transverse portions of the metal sheet form the first and second tongue members 311F, 312F respectively, and the overlapped inner transverse portions of the metal sheet form the third tongue member 313F.

The first tongue member 311F is slidably inserted into the first post cavities 2101F of the upper and lower post members 21F, 22F, the second tongue member 312F is sldiably inserted into the second post cavities 2102F of the upper and lower post members 21F, 22F, the third tongue member 313F is sldiably inserted into the third post cavities 2103F of the upper and lower post members 21F, 22F. In other words, the upper portions of the first, second, and third tongue members 311F, 312F, 313F are slidably inserted into the first, second, and third post cavities 2101F, 2102F, 2013F of the upper post member 21F respectively. The lower portions of the first, second, and third tongue members 311F, 312F, 213F are slidably inserted into the first, second, and third post cavities 2101F, 2102F, 2013F of the lower post member 22F respectively. Two outer edges of the first and second tongue members 311F, 312F of the engaging tongue 31F are two folding edges that form the reinforcing ribs to reinforce the structure of the engaging tongue 31F to prevent any twisting movement of torque created thereat. An outer edge of the third tongue member 313F of the engaging tongue 31F is also a folding edge to reinforce the structure of the engaging tongue 31F. In particular, the outer edge of the third tongue member 313F is folded to serve as a reinforcing edge 314F which preferably has a curved configuration. It is worth mentioning that the longitudinal gap 2104F enables the slightly expansion of the post cavity 210F. When the engaging tongue 31F slidably extended into the post cavity 210F, the reinforcing edge 314F is extended into the third post cavity 2103F at a position close to the longitudinal gap 2104F so as to reinforce the connection between the upper and lower post members 21F, 22F by the reinforcing edge 314F.

In addition, the folding edges of the engaging tongue 31F will increase the thickness of the post joint 30F to match with the post cavity 210F. Preferably, the thickness of the folding edge of the engaging tongue 31F is smaller than a width of the post cavity 210F. Since the keyhole guiders 233F into the post cavity 210F, the folding edges of the engaging tongue 31F will ensure the engaging tongue 31F not being blocked by the keyhole guiders 233F when the engaging tongue 31F is inserted into the post cavity 210F.

The post joint 30F further has a plurality of guiding slots 32F formed at the engaging tongue 31F to align with the keyholes 23F. In one embodiment, six guiding slots 32F are formed at the engaging tongue 31E, as shown in FIG. 27. Two of the guiding slots 32F are formed at the first tongue member 311F, two of the guiding slots 32F are formed at the second tongue member 312F, and two of the guiding slots 32F are formed at the third tongue member 313F.

One of the guiding slots 32F is extended from an upper edge of the first tongue member 311F and the other guiding slot 32F is extended from a bottom edge of the first tongue member 311F. Likewise, one of the guiding slots 32F is extended from an upper edge of the second tongue member 312F and the other guiding slot 32F is extended from a bottom edge of the second tongue member 312F. One of the guiding slots 32F is extended from an upper edge of the third tongue member 313F and the other guiding slot 32F is extended from a bottom edge of the third tongue member 313F. It is worth mentioning that a width of each of the guiding slots 32F is equal to or larger than a diameter size of the upper hole portion 231F of the keyhole 23F.

When the upper portions of the first, second, and third tongue members 311F, 312F, 313F are slidably inserted into the first, second, and third post cavities 2101F, 2102F, 2013F of the upper post member 21F respectively, the guiding slots 32F at the first, second, and third tongue members 311F, 312F, 313F will align with the keyholes 23F at the bottommost position of the upper post member 21F respectively.

When the lower portions of the first, second, and third tongue members 311F, 312F, 313F are slidably inserted into the first, second, and third post cavities 2101F, 2102F, 2103F of the lower post member 22F respectively, the guiding slots 32F at the lower portions of the first, second, and third tongue members 311F, 312F, 313F will align with the keyholes 23F at the uppermost position of the lower post member 21F respectively.

It is worth mentioning when the first, second, and third tongue members 311F, 312F, 313F are slidably inserted into the upper post member 21F and the lower post member 22F, the guiding slots 32F at the first, second, and third tongue members 311F, 312F, 313F can align with two or more keyholes 23F at each of the upper post member 21F and the lower post member 22F. When the lower portions of the first, second, and third tongue members 311F, 312F, 313F are slidably inserted into the first, second, and third post cavities 2101F, 2102F, 2103F of the lower post member 22F respectively, the guiding slots 32F at the lower portions of the first, second, and third tongue members 311F, 312F, 313F will align with two of the keyholes 23F at the uppermost position of the lower post member 21F respectively. In particular, the top edge of the guiding slot 32F will rest on the keyhole guider 233F at the uppermost position of the lower post member 21F. Likewise, when the upper portions of the first, second, and third tongue members 311F, 312F, 313F are slidably inserted into the first, second, and third post cavities 2101F, 2102F, 2103F of the upper post member 21F respectively, the keyhole guiders 233F at the bottommost position of the upper post member 21F respectively will rest on the bottom edges of the guiding slots 32F at the upper portions of the first, second, and third tongue members 311F, 312F, 313F.

It is worth mentioning that when the engaging tongue 31F is inserted into the upper and lower post members 21F, 22F to couple the upper and lower post members 21F, 22F end-to-end, the fastener 123E is inserted into the post cavity 210F through the keyhole 23F and is also inserted through the guiding slot 32F of the post joint 30F. In addition, three post members are detachably coupled with each other end-to-end via two post joints 30F. In other words, the height of post 20F the shelving apparatus can be selectively adjusted by adding an additional post member on the upper post member 21F via the post joint 30F to increase the height of the shelving apparatus or by detaching the additional post member from the upper post member 21F to reduce the height of the shelving apparatus.

FIG. 24A illustrates an alternative mode of the post joint 30F, wherein the engaging tongue 31F slidably extended into the post cavities 210F of the upper and lower post members 21F, 22F to interlock and couple the upper and lower members 21F, 22F with each other end-to-end. Accordingly, the engaging tongue 31F is constructed to have the first tongue member 311F and the second tongue member 312F extended from the first tongue member 311F, wherein the third tongue member 313F is omitted in this alternative mode. In other words, the first and second tongue members 311F, 312F are extended with each other in a planar manner. As shown in FIG. 24A, the engaging tongue 31F is made by a metal sheet, wherein the first tongue member 311F is slidably inserted into the first post cavities 2101F of the upper and lower post members 21F, 22F, and the second tongue member 312F is sldiably inserted into the second post cavities 2102F of the upper and lower post members 21F, 22F. In this alternative mode, four guiding slots 32F are formed at the engaging tongue 31E, wherein two of the guiding slots 32F are formed at the first tongue member 311F and two of the guiding slots 32F are formed at the second tongue member 312F.

It is worth mentioning when the first and second tongue members 311F, 312F are slidably inserted into the upper post member 21F and the lower post member 22F, the guiding slots 32F at the first and second tongue members 311F, 312F can align with two or more keyholes 23F at each of the upper post member 21F and the lower post member 22F. When the lower portions of the first and second tongue members 311F, 312F are slidably inserted into the first and second post cavities 2101F, 2102F of the lower post member 22F respectively, the guiding slots 32F at the lower portions of the first and second tongue members 311F, 312F will align with two of the keyholes 23F at the uppermost position of the lower post member 21F respectively. In particular, the top edge of the guiding slot 32F will rest on the keyhole guider 233F at the uppermost position of the lower post member 21F. Likewise, when the upper portions of the first and second tongue members 311F, 312F are slidably inserted into the first and second post cavities 2101F, 2102F of the upper post member 21F respectively, the keyhole guiders 233F at the bottommost position of the upper post member 21F respectively will rest on the bottom edges of the guiding slots 32F at the upper portions of the first and second tongue members 311F, 312F.

FIG. 26A illustrates an alternative mode of each of the first and second post members 21F, 22F. As it is mentioned above, the longitudinal gap 2104F is also formed between two outer edges of the inner second post walls 2221F, 2222F to communicate with the post cavity 201F, especially the third post cavity 2013F, of the lower post member 22F. It is appreciated that the longitudinal gaps 2104F of the upper and lower post members 21F, 22F can be sealed and closed. As shown in FIG. 26A, the longitudinal gaps 2104F of the upper and lower post members 21F, 22F are sealed and closed by welding, such that a welding line 2100F is formed between two outer edges of the inner second post walls 2221F, 2222F.

It is appreciated that the longitudinal gap 2104F can be selectively formed at any corner of the upper and lower post members 21F, 22F depending the folding process of the upper and lower post members 21F, 22F, such that the welding line 2100F can be formed to seal and close the longitudinal gap 2104F. In one embodiment, the welding line 2100F can be formed at any one of the corner A, corner B, corner C, and/or corner D as shown in FIG. 26B.

For example, when two welding lines 2100F are formed at the corner A and corner B respectively, the outer first post wall 2111F, 2211F will coupled to the inner first post walls 2112F, 2212F. Likewise, when two welding lines 2100F are formed at the corner C and corner D respectively, the inner first post walls 2112F, 2212F will also coupled to the inner second post walls 2121F, 2122F, 2221F, 2222F respectively.

FIG. 26C illustrates another alternative mode of each of the first and second post members 21F, 22F, wherein the outer wall shell 213F are detachably coupled to the inner wall shell 214F. In particular, the outer wall shell 213F serves as a post cover to cover the inner wall shell 214F. For example, the outer first post wall 2111F, 2211F has two edge connectors 2000F to engage with two outer edges of the inner first post walls 2112F, 2212F respectively. In addition, a coupling protrusion 2110F, 2210F is extended from the outer first post wall 2111F, 2211F to slidably insert into the third post cavity 2103F between the inner second post walls 2121F, 2122F, 2221F, 2222F. It is worth mentioning that the coupling protrusion 2110F, 2210F is slidably inserted into third post cavity 2103F without blocking the keyholes 23F formed at the inner second post walls 2121F, 2122F, 2221F, 2222F, as shown in FIG. 26C. It is worth mentioning that the outer wall shell 213F can be made of different materials from the inner wall shell 214F. For example the outer wall shell 213F can be made of plastic and inner wall shell 214F can be made of metal.

FIG. 26D further illustrates another alternative mode of each of the first and second post members 21F, 22F, wherein the outer wall shell 213F serves as a post cover to cover the inner wall shell 214F. The outer wall shell 213F is constructed to have the outer first post wall 2111F, 2211F. The inner wall shell 214F is constructed to have two inner first post walls 2112F, 2212F and one inner second post wall 2121F, 2221F, such that the inner wall shell 214F has a T-shape cross section. Accordingly, the keyholes 23F are formed at the inner first post walls 2112F, 2212F and the inner second post wall 2121F, 2221F. The outer first post wall 2111F, 2211F has two edge connectors 2000F to engage with two outer edges of the inner first post walls 2112F, 2212F respectively. In other words, in this alternative mode, there is no third post cavity 2103F in each of the first and second post members 21F, 22F.

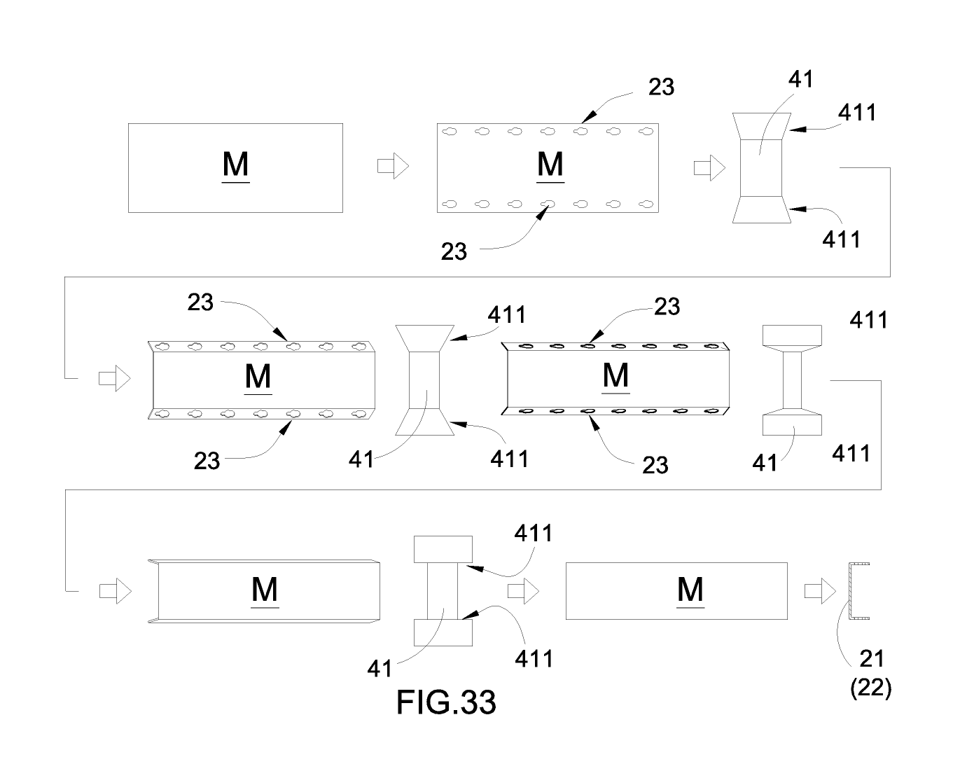

It is worth mentioning that each of the upper and lower post members 21, 22 is made of metal sheet M according to the above embodiments and their alternatives. In order to form the upper and lower post members 21, 22 by the metal sheet M, the metal sheet M is preferably fed into the punching machine to form the keyholes 23 at the predetermined locations of the metal sheet M, such as two edge portions of the metal sheet M. Then, the metal sheet M can be folded to form each of the upper and lower post members 21, 22 by a folding machine, as shown in FIG. 33. Accordingly, the folding machine comprises a plurality of folding rollers 41 to bend and fold the metal sheet consecutively. Each of the folding rollers 41 has two slanted folding faces 411 to bend and fold the metal sheet. In particular, the inclination angles of the folding faces 411 of the first folding roller 41 is gradually increased to the inclination angles of the folding faces 411 of the last folding roller 41. For example, the inclination angles of the folding faces 411 of the first folding roller 41 can be configured at 10° with respect to a horizontal level. The inclination angles of the folding faces 411 of the first folding roller 41 can be configured at 90° with respect to a horizontal level. Therefore, when the metal sheet is fed from the first folding roller 41 to the last folding roller 41, the two side portions of the metal sheet are folded and bent at 90°. Different portions of the metal sheet can be folded and bent by the folding machine to form each of the upper and lower post members 21, 22.

According to the preferred, the shelving apparatus is constructed to include both the post 20E and the post 20F of the third embodiment and its alternative to selectively expand the longitudinal size of the shelving apparatus. Accordingly, two shelf retaining members 12E can be detachably coupled at the upper or lower post member 21F, 22F side-by-side to selectively expand the longitudinal size of the shelving structure by coupling two shelf retaining members 12E to two sides of one single post 20F respectively. In other words, the T-shaped post 20F allows two shelf retaining members 12E to couple at two sides thereof at opposite directions.

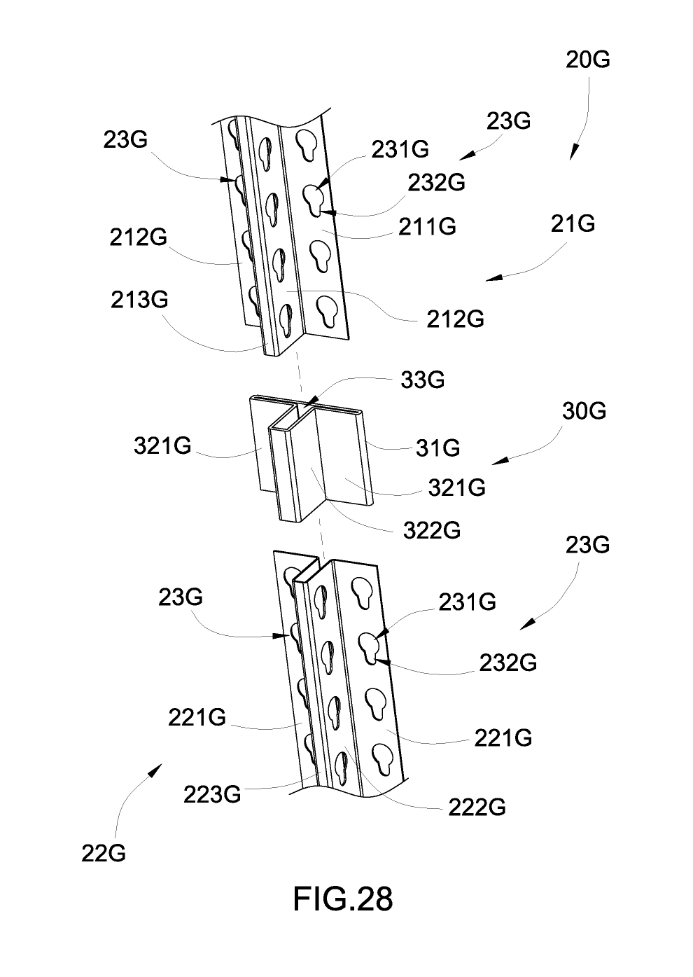

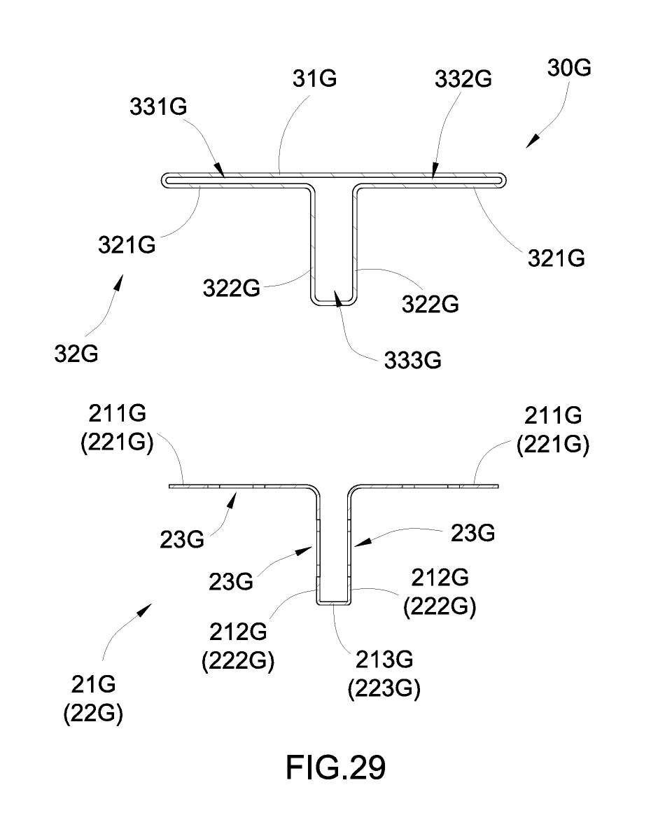

As shown in FIG. 28, a shelving apparatus according to a fifth embodiment illustrates a modification of the fourth embodiment, wherein the post 20G of the fifth embodiment is an alternative mode of the fourth embodiment. As shown in FIGS. 28 and 29, each of the posts 20G, which generally has a T-shaped configuration, comprises at least an upper post member 21G, at least a lower post member 22G, and at least a post joint 30G connecting the upper and lower post members 21G, 22G to form the respective post such that the upper and lower post members 21G, 22G are capable of being coupled and extended rigidly in an end-to-end and vertically oriented manner and being detached with each other.

Each of the upper and lower post members 21G, 22G has two first post walls 211G, 221G and two second post walls 212G, 222G extended from the first post walls 211G, 221G at an angle. Preferably, the second post walls 212G, 222G are perpendicularly and integrally extended from the first post walls 211G, 221G, such that the first post walls 211G, 221G and the second post walls 212G, 222G form a L-shaped configuration. Each of the upper and lower post members 21G, 22G further has a third post wall 213G, 223G perpendicularly and integrally extended from two front edges of the second post walls 212G, 222G. It is worth mentioning that the first post walls 211G, 221G are integrally extended from two rear edges of the second post walls 212G, 222G respectively. In other words, the third post wall 213C, 223G is extended parallelly to each of the first post walls 211G, 221G.

The post joint 30G has a post cavity 33G, wherein the bottom portion of the upper post member 21G and the upper end portion of the lower post member 22G are slidably inserted into the post cavity 33C of the post joint 30G to connect the upper and lower post members 21G, 22G end-to-end.

As shown in FIG. 28, a plurality of keyholes 23G are alignedly formed on the first post walls 211G, 221G and the second post walls 212G, 222G of each of the upper and lower post members 21G, 22G. Each of the keyholes 23G has an upper hole portion 231G and a lower hole portion 232G, wherein a size of the upper hole portion 231G is larger than a size of the lower hole portion 232G.

As shown in FIG. 29, the post joint 30G comprises an outer joint wall 31G and an inner joint wall 32G overlapped with the outer joint wall 31G. Accordingly, the inner joint wall 32G comprises two first inner walls 321G overlappedly and integrally extended from the outer joint wall 31G, and two second inner walls 322G perpendicularly and integrally extended from the first inner walls 321G respectively. The post cavity 33G is formed within the outer joint wall 31G and the inner joint wall 32G. In particular, the post cavity 33G is divided into a first post cavity 331G, a second post cavity 332G, and a third post cavity 333G, wherein the first, second, and third post cavities 331G, 332G, 333G are communicated with each other. The first post cavity 331G is defined between the outer joint wall 31G and one of the first inner walls 321G. The second post cavity 332G is defined between the outer joint wall 31G and another first inner wall 321G. The third post cavity 333G is defined between the two second inner walls 322G.

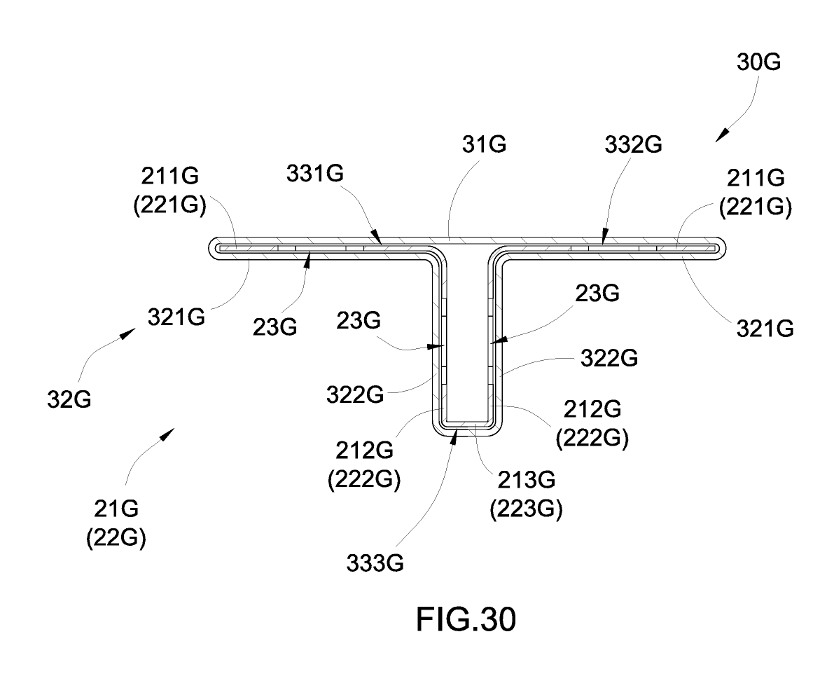

When each of the upper and lower post members 21G, 22G is slidably inserted into the post cavity 33G of the post joint 30G, the first post walls 211G, 221G are slid within the first and second post cavities 331G, 332G respectively. The second post walls 212G, 222G and the third post wall 213G, 223G are slid within the third post cavity 333G, as shown in FIG. 30.

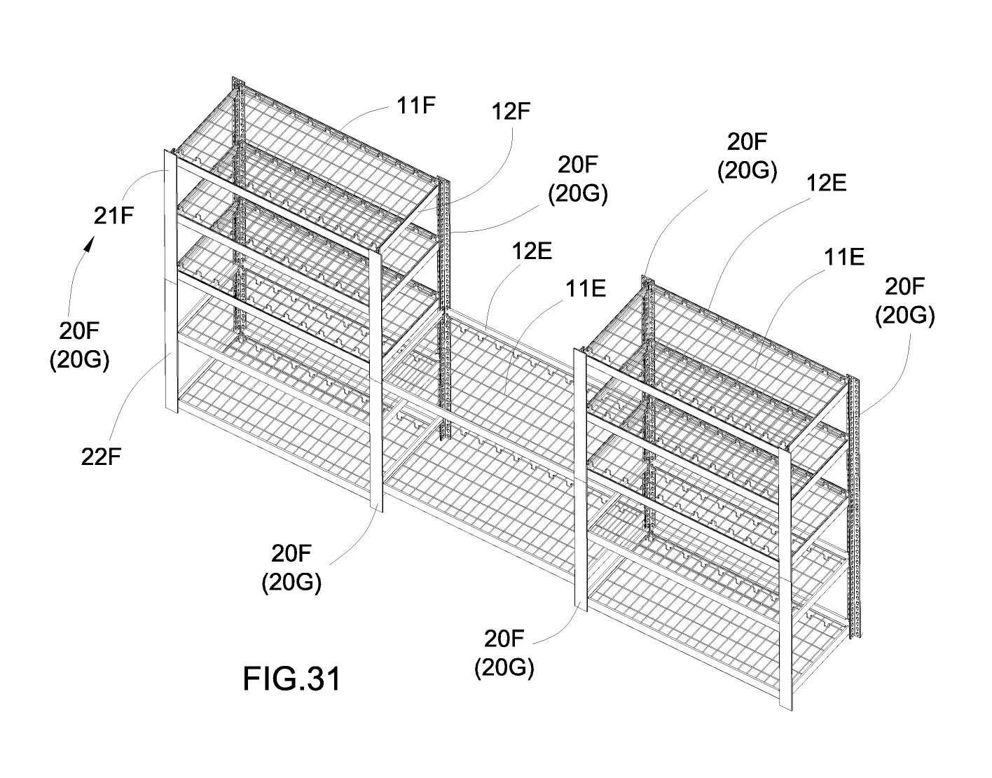

As shown in FIG. 31, two shelf retaining members 12E are coupled to the post 20F which serves as a common post, wherein one of the shelf members 12E is coupled at one of the inner first post wall 2112F, 2212F while another shelf member 12E is coupled at the other inner first post wall 2112F, 2212F. Therefore, the longitudinal size of the shelving structure can be expanded via the posts 20F. It is worth mentioning that the two shelf retaining members 12E can be coupled at the post 20F at the same elevation level or different elevation levels via the locations of the keyholes 23F.

It is appreciated that two shelf retaining members 12E are coupled to the post 20G which serves as a common post, wherein one of the shelf members 12E is coupled at one of the first post walls 211G, 221G while another shelf member 12E is coupled at the second post walls 212G, 222G to expand the longitudinal size of the shelving structure via the posts 20G.

In other words, two or more shelving apparatus are interconnected side-by-side via the common post 20F, 20G to form a multiple shelving apparatus. Therefore, the longitudinal expansion of the shelving apparatus could be unlimited and the object supported thereon will be evenly distributed to the entire structure of the shelving apparatus. It is worth mentioning that when the object is loaded at one of the shelving apparatus, the object can be supported by the multiple shelving apparatus through the common posts 20F, 20G. In addition, the multiple shelving apparatus will also provide a stable and rigid support by interlocking the different shelving apparatus with each other via the common posts 20F, 20G.

As it is mentioned above, the posts 20E, 20F, 20G can be selectively combined in the multiple shelving apparatus. Conventionally, in order to form the multiple shelving apparatus, two or more conventional shelving apparatuses are placed side-by-side. However, a clearance will be formed between the side frames of the conventional shelving apparatuses, especially the ground surface is not leveled. The posts 20E, 20F, 20G of the present invention will not form any clearance for the multiple shelving apparatus.

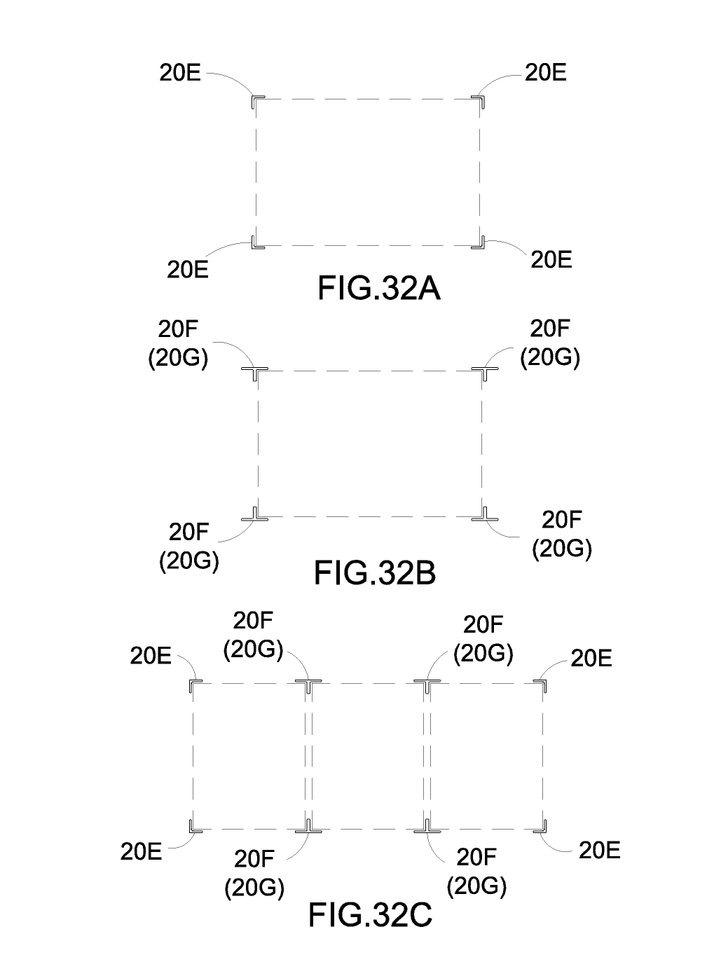

When only the posts 20E are used for the shelving apparatus, as shown in FIG. 32A, a single shelving apparatus will be formed to include four posts 20E at four corners of the shelving apparatus. When the posts 20F, 20G are used for the shelving apparatus, as shown in FIG. 32B, the shelving apparatus is setup for further size expansion to form the multiple shelving apparatus. The user is able to add another shelving apparatus to the existing shelving apparatus via the posts 20F, 20G. When both the posts 20E, 20F, 20G are used, as shown in FIG. 32C, the multiple shelving apparatus is formed that the posts 20E are located at the corners of the multiple shelving apparatus and the posts 20F, 20G are common posts to combine and connect two shelving apparatuses each other. It is worth mentioning that different configurations can be selectively set by the user through the multiple shelving apparatus. In one embodiment, a two-supporting-level shelving apparatus is coupled between two four-supporting-level shelving apparatuses as shown in FIG. 31.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A shelving apparatus, comprising:
a plurality of posts, each of said posts comprising at least an upper post member, at least a lower post member, and at least a post joint connecting said upper and lower post members to form said respective post such that said upper and lower post members are extended rigidly in an end-to-end and vertically oriented manner, wherein each of said upper and lower post members has a first post wall and a second post wall extended from said first post wall at an angle, wherein said post joint provides an engaging tongue extended into interiors of an end portion of said upper post member and an end portion of said lower post member, such that said upper and lower post members are interlocked and coupled with each other end-to-end; and
a supporting frame detachably coupling with said posts to form said shelving apparatus, wherein said supporting frame comprises one or more shelf supporting beam configurations, each of which comprises a shelf platform, a plurality of shelf retaining members and a shelf supporting arrangement, wherein said shelf retaining members are each detachably coupled with two of said posts to form a boundary frame to support said shelf platform therewithin, wherein each of said shelf retaining member has two coupling ends arranged detachably coupling with two of said posts, and first and second longitudinal edges extended between said two coupling ends, wherein said shelf supporting arrangement is integrally extended from each of said shelf retaining members between said first and second longitudinal edges to support said shelf platform within said boundary frame.

2. The shelving apparatus, as recited in claim 1, wherein each of said upper and lower post members has a post cavity that an upper portion of said engaging tongue is slidably inserted into said post cavity of said upper post member and a lower portion of said engaging tongue is slidably inserted into said post cavity of said lower post member.

3. The shelving apparatus, as recited in claim 2, wherein each of said upper and lower post members comprises an outer wall shell and an inner wall shell spacedly overlapped on said outer wall shell to define said post cavity between said outer wall shell and said inner wall shell.

4. The shelving apparatus, as recited in claim 3, wherein said outer wall shell of each of said upper and lower post members is constructed to have an outer first post wall and an outer second post wall, wherein said inner wall shell of each of said upper and lower post members is constructed to have an inner first post wall and said inner second post wall, wherein said outer first post wall and said inner first post wall form said first post wall of each of said upper and lower post members, wherein said outer second post wall and said inner second post wall form said second post wall of each of said upper and lower post members.

5. The shelving apparatus, as recited in claim 4, wherein said post cavity is divided into a first post cavity between said outer first post wall and said inner first post wall, and a second post cavity between said outer second post wall and said inner second post wall, wherein said first and second post cavities are communicated with each other.

6. The shelving apparatus, as recited in claim 4, wherein each of said upper and lower post members further has a longitudinal gap formed between two inner edges of said inner first post wall and said inner second post wall to communicate with said post cavity.

7. The shelving apparatus, as recited in claim 4, wherein each of said posts further has a plurality of keyholes alignedly formed on said inner first post wall and said inner second post wall of each of said upper and lower post members, wherein each of said keyholes is a through slot that communicates with said post cavity of each of said upper and lower post members, wherein each coupling end of each of said shelf retaining members provides at least a fastener adapted to detachably engage with said respective keyhole of said respective post.

8. The shelving apparatus, as recited in claim 1, wherein said engaging tongue comprises a first tongue member and a second tongue member extended from said first tongue member at an angle matching with the angle between said first post wall and said second post wall of each of said upper and lower post members, wherein said first and second tongue members are slidably inserted into said first and second post walls of each of said upper and lower post members.

9. The shelving apparatus, as recited in claim 5, wherein said engaging tongue comprises a first tongue member and a second tongue member extended from said first tongue member at an angle matching with the angle between said first post wall and to said second post wall of each of said upper and lower post members, wherein said first and second tongue members are slidably inserted into said first and second post walls of each of said upper and lower post members.

10. The shelving apparatus, as recited in claim 9, wherein said post joint further has a plurality of guiding slots formed at said engaging tongue to align with said keyholes when said engaging tongue is slidably inserted into said upper and lower post members.

11. The shelving apparatus, as recited in claim 9, wherein said first and second tongue members are slidably inserted into said first and second post cavities of each of said upper and lower post members respectively.

12. The shelving apparatus, as recited in claim 1, wherein each of said posts has a L-shaped configuration, and said post joint has a corresponding L-shaped configuration.

13. The shelving apparatus, as recited in claim 3, wherein said outer wall shell of each of said upper and lower post members is constructed to have an outer first post wall, wherein said inner wall shell of each of said upper and lower post members is constructed to have two inner first post walls and two inner second post walls, wherein said outer first post wall and said two inner first post walls form said first post wall of each of said upper and lower post members, wherein said two inner second post walls form said second post wall of each of said upper and lower post members.

14. The shelving apparatus, as recited in claim 13, wherein said post cavity is divided into a first post cavity between said outer first post wall and one of said inner first post walls, a second post cavity between said outer first post wall and another said inner first post wall, and a third post cavity between said inner second post walls, wherein said first, second, and third post cavities are communicated with each other.

15. The shelving apparatus, as recited in claim 14, wherein each of said upper and lower post members further has a longitudinal gap formed between two outer edges of said inner second post walls to communicate with said post cavity.

16. The shelving apparatus, as recited in claim 14, wherein each of said posts further has a plurality of keyholes alignedly formed on said inner first post walls and said inner second post walls of each of said upper and lower post members, wherein each of said keyholes is a through slot that communicates with said post cavity of each of said upper and lower post members, wherein each coupling end of each of said shelf retaining members provides at least a fastener adapted to detachably engage with said respective keyhole of said respective post.

17. The shelving apparatus, as recited in claim 1, wherein said engaging tongue comprises a first tongue member, a second tongue member extended from said first tongue member, and a third tongue member extended between said first and second tongue members at an angle, wherein a cross section of said engaging tongue matches with a cross section of said post.

18. The shelving apparatus, as recited in claim 14, wherein said engaging tongue comprises a first tongue member, a second tongue member extended from said first tongue member, and a third tongue member extended between said first and second tongue members at an angle, wherein a cross section of said engaging tongue matches with a cross section of said post.

19. The shelving apparatus, as recited in claim 18, wherein said post joint further has a plurality of guiding slots formed at said engaging tongue to align with said keyholes when said engaging tongue is slidably inserted into said upper and lower post members.

20. The shelving apparatus, as recited in claim 18, wherein said first, second, and third tongue members are slidably inserted into said first, second, and third post cavities of each of said upper and lower post members respectively.

21. The shelving apparatus, as recited in claim 1, wherein each of said posts has a T-shaped configuration, and said post joint has a corresponding T-shaped configuration.

22. The shelving apparatus, as recited in claim 1, wherein said shelf platform has a base panel and a surrounding edge defining a cavity within said surrounding edge and said base panel, wherein said shelf platform is able to be selectively supported by said shelf supporting arrangement of said respective shelf supporting beam configuration with said surrounding edge located below base panel and said cavity facing downward or said surrounding edge located above said base panel and said cavity facing upward.

23. The shelving apparatus, as recited in claim 11, wherein said shelf platform has a base panel and a surrounding edge defining a cavity within said surrounding edge and said base panel, wherein said shelf platform is able to be selectively supported by said shelf supporting arrangement of said respective shelf supporting beam configuration with said surrounding edge located below base panel and said cavity facing downward or said surrounding edge located above said base panel and said cavity facing upward.

24. The shelving apparatus, as recited in claim 20, wherein said shelf platform has a base panel and a surrounding edge defining a cavity within said surrounding edge and said base panel, wherein said shelf platform is able to be selectively supported by said shelf supporting arrangement of said respective shelf supporting beam configuration with said surrounding edge located below base panel and said cavity facing downward or said surrounding edge located above said base panel and said cavity facing upward.

25. The shelving apparatus, as recited in claim 1, wherein each of said shelf retaining members provides a supporting surface extended from an inner side thereof between said two longitudinal edges to support said respective shelf platform and at least one longitudinal edge portion of each of said shelf retaining members is inwardly folded on an inner side thereof to form said longitudinal edge to reinforce a planar configuration of said retaining member.

26. The shelving apparatus, as recited in claim 25, wherein each of said shelf retaining members has a plurality of supporting tabs horizontally aligned with each other and protruded from said inner side of each of said shelf retaining members between first and second longitudinal edges thereof and defines a plurality of discrete supporting surfaces on said supporting tabs to support said shelf platform thereon.

27. The shelving apparatus, as recited in claim 26, wherein each of said supporting tabs is integrally bent from said inner side of said shelf retaining member to define said supporting surface close to said first longitudinal edge of said shelf retaining member.

28. The shelving apparatus, as recited in claim 1, wherein each of said shelf retaining members has a plurality of first and second supporting tabs horizontally aligned with each other and protruded from an inner side of said shelf retaining member between said first and second longitudinal edges thereof and defines a plurality of discrete first and second supporting surfaces on said supporting tabs, wherein said first supporting tabs are alternated with said second supporting tabs, such that said shelf platform is selectively supported by said first supporting surfaces or said second supporting surfaces.

29. The shelving apparatus, as recited in claim 28, wherein a distance between said first longitudinal edge and said first supporting surfaces is smaller than a distance between said second longitudinal edge and said second supporting surfaces.

30. The shelving apparatus, as recited in claim 1, wherein each of said shelf retaining members comprises a vertical beam wall defining said first and second longitudinal edges at an upper and bottom edges thereof, a top beam wall integrally and horizontally extended from said upper edge of said vertical beam wall to define said supporting surface on said top beam wall close to said first longitudinal edge of said shelf retaining member, and a longitudinal reinforcing rib integrally extended between said first longitudinal edge of said shelf retaining member and said top beam wall, wherein said supporting surface is an elongated flat surface to support said shelf platform and said longitudinal reinforcing rib is extended between said upper edge of said vertical beam wall and said top beam wall to reinforce the structure of said shelf retaining member.

31. The shelving apparatus, as recited in claim 30, wherein said second longitudinal edge of each of said shelf retaining members is a folded edge that said bottom edge of said vertical beam wall is inwardly folded on an inner side of said vertical beam wall, wherein a free edge of said top beam wall of each of said shelf retaining members is a folded edge that said free edge of said top beam wall is downwardly folded on a bottom side of said top beam wall, wherein said longitudinal reinforcing rib of each of said shelf retaining members is formed in curved cross sectional configuration.
